(19) United States
(12) Patent Application Publication
(10) Pub. No.: US 2015/0156075 A1
(43) Pub. Date: Jun. 4, 2015

(54) Mobile Information Management System And Methods Of Use And Doing Business

(71) Applicant: JBA 360 LLC, Las Vegas, NV (US)

(72) Inventors: James R. Gist, Draper, UT (US); Matthew L. Sandvold, Brandon, SD (US); Terry F. Poot, Las Vegas, NV (US)

(21) Appl. No.: 14/522,308

(22) Filed: Oct. 23, 2014

Related U.S. Application Data
(60) Provisional application No. 61/894,565, filed on Oct. 23, 2013.
(60) Provisional application No. 62/020,951, filed on Jul. 3, 2014.

(51) Int. Cl. H04L 12/24; H04L 29/08; G01C 21/00

(52) U.S. Cl. CPC H04L 41/22; G01C 21/00; H04L 67/06

(57) ABSTRACT

A mobile information management system supporting the association of information items, such as, for example, one or more among files or portions of files (such as images), documents, videos, notes, location registrations, document markups, or the like with a particular location on a context-specific reference map, such as a floor plan. In some embodiments, uploaded files can be designated as reference maps, which, if desired, can then be assigned a coordinate system for display of one or more among registration pins, information pins, and current mobile device locations. Some applications provide for location-based notification and propagation of the associated information items to mobile devices on request, automatically, or both. At least a portion of the system is operable on and accessible from a mobile device, and can facilitate the real time, on-site association of one or more information items with a location on a map.

### CROSS-REFERENCE TO RELATED APPLICATIONS

The present application claims priority through the applicants' provisional patent application of same title, filed Oct. 23, 2013, Ser. No. 61/894,565, and through applicants' provisional application of same title, filed Jul. 3, 2014, Ser. No. 62,020,951, which provisional applications are both hereby incorporated by reference in their entirety. In the event of any inconsistency between any such application and this specification, however, this specification shall govern.

### COPYRIGHT NOTICE

This patent document contains material subject to copyright protection. The copyright owner has no objection to the photocopy reproduction of the patent document or the patent disclosure in exactly the form it appears in the Patent and Trademark Office patent file or records, but otherwise reserves all copyright rights.

### FIELD OF TECHNOLOGY

The present application relates to mobile information management systems and more particularly mobile information management systems of the type in which information is associated with one or more buildings, locations, building conditions, and the like.

### ASPECTS OF THE PRIOR ART

The use of maps has become a standard feature of many business solutions. In addition to maps that are designed for general navigation purposes, association of information with locations or areas on a map has become common. For instance, some map services used by travellers identify the location of sites of interest, along with images of the location provided by users. Similarly, customer relationship management services have integrated mapping technologies for the mapping of contact data, sales lead data, and the like.

In the field of construction and site management generally, systems have been developed that associate building or site information with a particular location on a map, such as a floor plan, an AutoCAD drawing, or the like. These systems associate different types of data, such as images or text, to a particular location. Information has typically included, for example, current conditions of a site, repair needs, and build progress. Some of these systems operate on a mobile device, such as tablet or a smart phone.

Generally, existing systems select between two different approaches, both of which lack valuable features. The first approach has been to use standard maps and their associated location tracking interfaces, such as Google Maps®, as the reference map for location based association of information. One problem with this approach is that the reference map has little, if any, relevance to the subject matter of interest. For example, if the context of the information is specific to features of a building, then a satellite map will not display the features of relevance, such as walls, hallways, infrastructure, and the like. So while information may be associated with a geospatial location, it generally cannot be associated with a visual depiction of the building features, particularly features internal to the building and inaccessible to satellite image capture. As a result, the value and purpose of associating information can be dramatically reduced, or lost entirely, due to the absence of a relevant reference map. Similarly, tracking the location of the mobile device against a low-relevance reference maps generally fails to provide the detailed internal building context information of interest to the user.

The second approach typically involves loading a reference map into the system, such as, for example, a floor plan, drawing, picture, map, or aerial image. While this approach allows for context-relevant referencing of features of a location, these maps are generally only maps with respect to their appearance, lacking mapping features such as location based tracking of the mobile device scaled to the designated map. These systems typically allow the placement of pins on the reference map in combination with associating text, images, and annotations with the pin. One shortcoming with this approach is a lack of alignment of the reference map with a mechanism for: (i) tracking the mobile device as it moves among the locations referenced by the map; and (ii) thus displaying the location of the device on the reference map. When current location information is lacking on a reference map, the user is often left with the burden of ascertaining their location, moving the map to the location of interest, acquiring an appropriate zoom level, attempting to determine what pinned information is available, and investigating this information. Such reliance on the user to perform this function can be time consuming, costly, and error prone.

A further challenge relating to quickly and efficiently accessing relevant information arises in the context of large documents. For example, a multi-page punch list with numerous drawings could be referenced by a pin annotation, but the information of relevance to a particular room could be buried somewhere in the document. The user may have to retrieve the document and spend significant time navigating the document trying to find the page of interest to the current location. Lacking a system that provides support for adding context-specific reference maps with location intelligence and tracking, as an example, for complex building projects, the user visiting the site may have to ascertain where they are at the site, download the appropriate reference map, figure out the user's location on the map, review which pins have information associated with the user's assumed location at the site, find the relevant document associated with the pin, download the document, and find the page or pages of interest in the document. The process is inefficient and, in some instances at least, impractical, particularly on a large-scale project that may have various lifecycle phases extended over many years.

Another shortcoming of both these approaches involves an absence of document management features, in particular, versioning, change management, and change notification. These systems typically lack capabilities for tracking local copies of files, tracking modification of pins and files, and subsequently propagating or notifying relevant devices, users, or both. In those systems where a user temporarily or permanently stores associated documents locally on the mobile device, there is typically no way to know a change was made to the document previously stored locally, and that the earlier-stored local copy should be replaced with a later version. In addition, even in systems in which a pin annotation might have been made indicating a change was made to a file, ascertaining which documents have changed in situations where there are large numbers of pins or documents associated the current location of interest, can be a burdensome task for a user. Failure by a user to obtain the correct documents in a timely fashion can result in work not being done, work being done improperly, and an increase in the number of visits to the site due to mistakes.

Yet another problem that generally arises in systems that lack document management functionality is making, tracking, and surfacing document annotations as part of an overall workflow. For example, shift workers may be working in sequence in a particular area where the most efficient way to communicate across shifts about completed tasks, issues faced, and outstanding items is by annotation of documents. In the absence of integrated document annotation capabilities, the workers may have difficulty annotating the document and returning the document to the system. Further, even if annotated documents are reintroduced into the system, there may be no history of the changes, or any way to automatically notify the next shift worker of the change, either by a notification message or an automatic update to the local copy of the document. As a result, the workers can be required to use cumbersome and inefficient methods of communicating rather than effectively engaging in ad hoc workflow using technologies such as email and proliferating notes directly on the map creating distracting clutter.

Still another problem that arises with these systems is an inability to automatically detect changed documents due to the absence of combined document management features and context-specific reference map location tracking. This results in users potentially being at a location where there are nearby pins associated with documents having critical updates and the user having no idea that these updates are present. The burden on the user to identify, access, and determine the relevance of such changes can be inefficient and even unworkable, especially in the context of complex projects such as construction projects.

In addition to location specific data associations, these systems have generally failed to provide intuitive organizational schemes for simultaneously managing multiple properties, multiple projects, multiple buildings, and multiple floor plans. These systems typically lack full-text and meta-data search capability for files and file edits, including file markups and file notes. This lack of a multi-dimensional organizational model, particularly when combined with limited search capabilities, can reduce the timeliness of file access and make document identification and access cumbersome.

### BRIEF SUMMARY OF SOME ASPECTS OF THE PRESENT SYSTEM AND METHODS

The applicants believe that they have discovered at least one or more of the problems and issues with prior art systems noted above as well as one or more advantages provided by differing embodiments of the systems or system features disclosed in this specification.

Briefly and in general terms, the present disclosure provides for a mobile information management system supporting the association of information items, such as, for example, one or more among files or portions of files (e.g., images), documents, videos, notes, location registrations, document markups, or the like with a particular location on a context-specific reference map, such as a floor plan.

In some embodiments, uploaded files can be designated as reference maps, which, if desired, can then be assigned a coordinate system for display of one or more among registration pins, information pins, and current mobile device locations. Some applications provide for location-based notification and propagation of the associated information items to mobile devices on request, automatically, or both. At least a portion of the system is operable on and accessible from a mobile device, and can facilitate the real time, on-site association of one or more information items with a location on a map.

In some instances, a pin (or other indicia if desired) represents the association of one or more information items with a location. Some applications provide one more pins as a digital indicator of a location on a map, such as, in some systems, a coordinate location within the boundaries of a coordinate system assigned to a floor plan document. Pins can relate information from various sources and of various types to one or more locations. In some implementations, pins are created when a selection event is detected for a specific location on a map displayed by the mobile information management application. The detection of this selection event at a location on the displayed map can be correlated with a map coordinate location, and the map coordinate location can be associated with the pin.

In some instances, registration pins can be used to convert a mobile device geospatial coordinate location to a map coordinate location. In some instances, this capability allows any uploaded document to be designated as a reference map file where mobile device locations can be tracked. The ability to detect mobile device location on any map-designated document may also allow for the map-associated pinning of information and automated location based notification and retrieval of changed information. In some systems, this capability can apply to any document that may be of use

In certain instances, the system establishes a “project” in which a group of users are involved. Project data can be tied to a pin. For example, in some embodiments a pin can reference a floor plan. Some applications of a pin may also reference any number of files, such as PDF documents. Pin references may include references to one or more specific page of a file. Similarly, multiple pins may reference the same file. Users authorized for access to a given project also may attach notes to a pin. Pins may have other attachments as well, for pictures taken at the project site, or other forms of data to be determined.

In some implementations, one or more users can be granted access to a particular project. As more users are added to the system, system security procedures can exclude, for example, competitors from seeing each other's operations. Each project can include a hierarchical arrangement of one or more among locations or properties, buildings at each location or property, and floors of each building or property. In some systems, once a user registers a device for a certain project, the user is associated with that project to prevent other users not associated with the project from accessing information about the project.

In some embodiments, pin and associated pin data updates are communicated to all other project users. One or more among newly-created pins, updated pins, and updates to associated pin data can be automatically sent to one or more of the users or mobile devices implementing the system associated with the same project. If the mobile device, in which pin and pin associated data creation or updating occurs, lacks network access, creation and update content can be automatically sent to system servers when connectivity to a network service is restored. In some instances, if mobile devices registered with the project do not have network service when the pin and pin associated data is created or updated, the creation or update content can be queued for delivery to appropriate devices for later distribution upon restoration of a network connection.

There are other novel features and aspects of the present disclosure. They will become apparent as the specification proceeds. In this regard, the scope of the invention should be determined by reference to the claims as issued and not by whether they address any issue(s) or feature(s) identified in the “Aspects of the Prior Art” section or this “Brief Summary.”

### BRIEF DESCRIPTION OF THE DRAWINGS

The applicants' preferred and other embodiments are disclosed in association with the accompanying Figures in which:

FIG. 1 is a computer network or similar digital processing environment in which a mobile information management system can be implemented according to an exemplary embodiment;

FIG. 2 is a block diagram of the internal structure of a computer used in the computer network of FIG. 1;

FIG. 3 is a service oriented architecture diagram of the mobile information management system in the embodiment of FIG. 1;

FIG. 4A through FIG. 4V are diagrams of various tables of the persistence layer of FIG. 3;

FIG. 5 is a block diagram of one example of an application layer architecture of the native mobile app of FIG. 3;

FIG. 6 is a screen capture of a customers page for a system administration service for the browser-based interface of FIG. 3;

FIG. 7A is a screen capture of a portion of a new customer page for a system administration service for the browser-based interface of FIG. 3;

FIG. 7B is a screen capture of another portion of a new customer page for a system administration service for the browser-based interface of FIG. 3;

FIG. 8A is a screen capture of a portion of an edit customer page for a system administration service for the browser-based interface of FIG. 3;

FIG. 8B is a screen capture of another portion of a new customer page for a system administration service for the browser-based interface of FIG. 3;

FIG. 9 is a screen capture of an advisors page for a system administration service for the browser-based interface of FIG. 3;

FIG. 10 is a screen capture of a new advisor page for a system administration service for the browser-based interface of FIG. 3;

FIG. 11 is a screen capture of an edit advisor page for a system administration service for the browser-based interface of FIG. 3;

FIG. 12 is a screen capture of a login screen for a customer administration service for the browser-based interface of FIG. 3;

FIG. 13 is a screen capture of an administrative home page for a customer administration service for the browser-based interface of FIG. 3;

FIG. 14 is a screen capture of a manage users page for a customer administration service for the browser-based interface of FIG. 3;

FIG. 15 is a screen capture of a new user page for a customer administration service for the browser-based interface of FIG. 3;

FIG. 16 is a screen capture of a manage devices page for a customer administration service for the browser-based interface of FIG. 3;

FIG. 17 is a screen capture of a manage projects page for a customer administration service for the browser-based interface of FIG. 3;

FIG. 18 is a screen capture of a new project page for a customer administration service for the browser-based interface of FIG. 3;

FIG. 19 is a screen capture of a project selection page for a customer administration service for the browser-based interface of FIG. 3;

FIG. 20 is a screen capture of an upload document page for a customer administration service for the browser-based interface of FIG. 3;

FIG. 21 is a screen capture of an upload floor plan page for a customer administration service for the browser-based interface of FIG. 3;

FIG. 22 is a screen capture of a manage documents page for a customer administration service for the browser-based interface of FIG. 3;

FIG. 23 is a screen capture of an edit document page for a customer administration service for the browser-based interface of FIG. 3;

FIG. 24 is a screen capture of a manage floor plans page for a customer administration service for the browser-based interface of FIG. 3;

FIG. 25 is a screen capture of an edit floor plans page for a customer administration service for the browser-based interface of FIG. 3;

FIG. 26 is a screen capture of a login screen for the native mobile app of FIG. 3;

FIG. 27 is a screen capture of a terms and conditions acceptance view for the native mobile app of FIG. 3;

FIG. 28 is a screen capture of a project selection menu for the native mobile app of FIG. 3;

FIG. 29 is a screen capture of a current location access confirmation prompt for the native mobile app of FIG. 3;

FIG. 30 is a screen capture of an unfiltered main view for the native mobile app of FIG. 3;

FIG. 31 is a screen capture of a project selection menu for the native mobile app of FIG. 3;

FIG. 32 is a screen capture of a filter property selection menu for the native mobile app of FIG. 3;

FIG. 33 is a screen capture of a filter building selection menu for the native mobile app of FIG. 3;

FIG. 34 is a screen capture of a filter floor selection menu for the native mobile app of FIG. 3;

FIG. 35 is a screen capture of a sort selection menu for the native mobile app of FIG. 3;

FIG. 36 is a screen capture of a nearby floor plans view for the native mobile app of FIG. 3;

FIG. 37A is a screen capture of an email queue view for the native mobile app of FIG. 3;

FIG. 37B is a screen capture of another email queue view for the native mobile app of FIG. 3;

FIG. 37C is a screen capture of a messages view for the native mobile app of FIG. 3;

FIG. 38 is a screen capture of a compose message view for the native mobile app of FIG. 3;

FIG. 39 is a screen capture of another compose message view for the native mobile app of FIG. 3;

FIG. 40 is a screen capture of another messages view for the native mobile app of FIG. 3;

FIG. 41 is a screen capture of a messages advisor view for the native mobile app of FIG. 3;

FIG. 42 is a screen capture of a create reminder view for the native mobile app of FIG. 3;

FIG. 43 is a screen capture of a download confirmation prompt for the native mobile app of FIG. 3;

FIG. 44 is a screen capture of a requested download indicator view for the native mobile app of FIG. 3;\

FIG. 45 is a screen capture of a local storage indicator view for the native mobile app of FIG. 3;

FIG. 46 is a screen capture of a filtered view for the native mobile app of FIG. 3;

FIG. 47 is a screen capture of a floor plan display view for the native mobile app of FIG. 3;

FIG. 48 is a screen capture of a filters selection menu floor plan display view for the native mobile app of FIG. 3;

FIG. 49 is a screen capture of a pin selection menu floor plan display view for the native mobile app of FIG. 3;

FIG. 50 is a screen capture of a registration pin floor plan display view for the native mobile app of FIG. 3;

FIG. 51 is a screen capture of a registration pin information view for the native mobile app of FIG. 3;

FIG. 52 is a screen capture of an edit pin view for the native mobile app of FIG. 3;

FIG. 53 is a screen capture of a multi-pin floor plan and current location display view for the native mobile app of FIG. 3;

FIG. 54 is a screen capture of an all floor plan pins information view for the native mobile app of FIG. 3;

FIG. 55 is a screen capture of multi-page document view for the native mobile app of FIG. 3;

FIG. 56 is a screen capture of a text annotation of a document for the native mobile app of FIG. 3;

FIG. 57 is a screen capture of a note annotation of a document for the native mobile app of FIG. 3;

FIG. 58 is a screen capture of a free draw markup of a document for the native mobile app of FIG. 3;

FIG. 59 is a screen capture of a shape markup of a document for the native mobile app of FIG. 3;

FIG. 60 is a screen capture of an add photo menu markup selection for the native mobile app of FIG. 3;

FIG. 61 is a screen capture of select photo menu markup selection for the native mobile app of FIG. 3;

FIG. 62 is a screen capture of markup photo resolution selection menu for the native mobile app of FIG. 3;

FIG. 63 is a screen capture of an stamp annotation menu of a document for the native mobile app of FIG. 3;

FIG. 64 is a screen capture of an erase annotation control of a document for the native mobile app of FIG. 3;

FIG. 65A is a screen capture of a context sensitive markup menu of a document for the native mobile app of FIG. 3;

FIG. 65B is another screen capture of a context sensitive markup menu of a document for the native mobile app of FIG. 3;

FIG. 65C is another screen capture of a context sensitive markup menu of a document for the native mobile app of FIG. 3;

FIG. 66 is a screen capture of a send options selections drop list of a document for the native mobile app of FIG. 3;

FIG. 67 is a screen capture of a send document view for the native mobile app of FIG. 3;

FIG. 68 is a screen capture of an email queue confirmation prompt for the native mobile app of FIG. 3;

FIG. 69 is a screen capture of a print options selections drop list of a document for the native mobile app of FIG. 3;

FIG. 70 is a screen capture of a save pin view for the native mobile app of FIG. 3;

FIG. 71 is a screen capture of an edit pin view for the native mobile app of FIG. 3;

FIG. 72 is a screen capture of another save pin view for the native mobile app of FIG. 3;

FIG. 73 is a screen capture of a take photo view for the native mobile app of FIG. 3;

FIG. 74 is a screen capture of another edit pin view for the native mobile app of FIG. 3;

FIG. 75 is a screen capture of an allow access to photos confirmation prompt for the native mobile app of FIG. 3;

FIG. 76 is a screen capture of a photo library selection menu for the native mobile app of FIG. 3;

FIG. 77 is a screen capture of another edit pin view for the native mobile app of FIG. 3;

FIG. 78 is a screen capture of an email pin view for the native mobile app of FIG. 3;

FIG. 79 is a screen capture of a group watch pin view for the native mobile app of FIG. 3;

FIG. 80 is a screen capture of another filtered main view for the native mobile app of FIG. 3;

FIG. 81 is a screen capture of requested pin download indication view for the native mobile app of FIG. 3;

FIG. 82 is a screen capture of a logout confirmation prompt for the native mobile app of FIG. 3;

FIG. 83 is a flow diagram of a method of managing pin associated information on the mobile devices of FIG. 1;

FIG. 84 is a flow diagram of a method of associating a portion of a document with a pin on the mobile devices of FIG. 1;

FIG. 85 is a flow diagram of a method of requesting the latest version of information associated with a pin on the mobile devices of FIG. 1;

FIG. 86 is a flow diagram of a method of providing change notification on the mobile devices of FIG. 1;

FIG. 87 is a flow diagram of a method of requesting information on the mobile devices of FIG. 1 in response to receiving a change notification;

FIG. 88 is a flow diagram of a method for retrieving pin-associated information based on the location of the mobile devices of FIG. 1;

FIG. 89 is a flow diagram of a method for providing change notifications based on the location of the mobile devices of FIG. 1; and

FIG. 90 is a flow diagram of a method for determining the location on a map of the mobile devices of FIG. 1.

In the Figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF SOME EMBODIMENTS

Certain embodiments of the mobile information management system and methods are described with reference to methods, apparatus (systems), and computer program products that can be implemented by computer program instructions. These computer program instructions can be provided to a processor of a general purpose computer, special purpose computer, mobile computing device, or other programmable data processing apparatus to produce a machine, such that the instructions, which execute via the processor of the computer or other programmable data processing apparatus, create means for implementing the acts specified herein to transform data from a first state to a second state.

These computer program instructions can be stored in a computer-readable memory that can direct a computer or other programmable data processing apparatus to operate in a particular manner, such that the instructions stored in the computer-readable memory produce an article of manufacture including instruction means which implement the acts specified herein. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified herein.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices such as, for example, a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a computer terminal. In the alternative, the processor and the storage medium can reside as discrete components in a computer terminal.

Depending on the embodiment, certain acts, events, or functions of any of the methods described herein can be performed in a different sequence, can be added, merged, or left out altogether (e.g., not all described acts or events are necessary for the practice of the method). Moreover, in certain embodiments, acts or events can be performed concurrently such as, for example, through multi-threaded processing, interrupt processing, or multiple processors or processor cores, rather than sequentially. Moreover, in certain embodiments, acts or events can be performed on alternate tiers within the architecture.

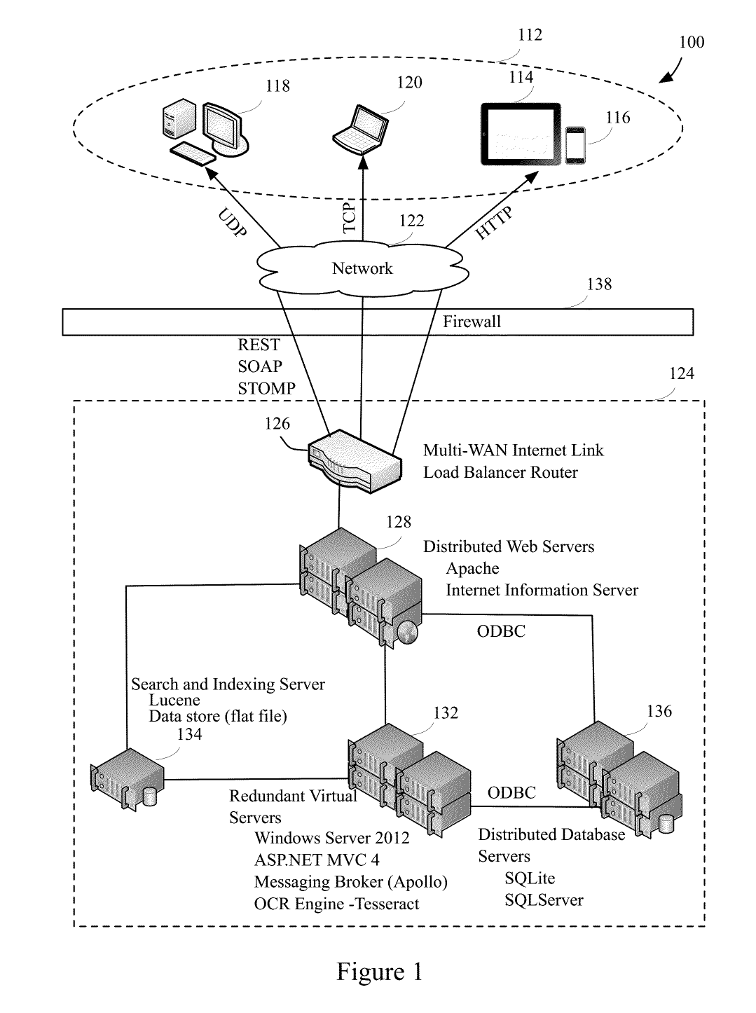

Referring now to FIG. 1, a computer network or similar digital processing environment 100 in which the system and method disclosed can be implemented. The present systems and methods can also run on different architectures that may include a LAN, WAN, stand-alone PC, stand-alone mobile device, a stand-alone, clustered, or networked mini or mainframe computers, etc. The mobile information management system and method of use can be distributed on multiple computers and devices 112, 124.

FIG. 1 is representative of many specific computing arrangements that can support the system and method disclosed. In one embodiment, the software implementing the mobile information management system runs in the Windows® environment. In another embodiment, the software is implemented to run in other environments, such as Linux®, UNIX®, and may run on any hardware having enough power to support timely operation of software such as that identified in FIG. 1. In some implementations of the mobile information management system, Windows Server 2012® is deployed on one or more server computers 124. In certain instances, computers are deployed as virtual instances 132 rather than physical computers.

A load balancing router 126, such as for example, the Peplink® Multi Wan Router can distribute traffic inside a firewall 138 to and from web server computers 128. In some deployments, these webservers 3528 are distributed instances of Windows Internet Information Server®. In some deployments, redundant virtual servers 132 run instances of Windows Server 2012® with ASP.NET MVC 4 hosting one or more Windows services. The redundant virtual servers 132 are communicatively coupled to computers 134, 136 hosting one or more persistent data stores. This data stores can be distributed databases such as, for example, Microsoft SQLServer®, MySQL®, SQLLite and/or high-performance key/value index store used to store derivative data generated by, for example, the Lucene search service.

Client computing devices of various types 112 can connect to a remote server infrastructure 124 via a network 122 over a communication protocol. All computing devices can pass information as unstructured data, structured files, structured data streams such as, for example, XML, structured data objects, and/or structured messages. Client computing devices 118, 120, 114, 116 may communicate over various protocols such as, for example, UDP, TCP/IP and/or HTTP.

Client computing devices 118, 120, 114, 116 and server computers 124 provide processing, storage, and input/output devices executing application programs. Client computers 112 can also be linked through communications network 122 to other computing devices, including other client devices/processes 112 and server computers 124. In some embodiments, server computers 136 run software to implement centralized persistent data storage and retrieval. The network 122 can be a local area network and/or a wide area network that is part of a remote access network, a global network (e.g., the Internet), a worldwide collection of computers, and/or gateways that currently use respective protocols (TCP/IP, UDP, etc.) to communicate with one another. Multiple client computer devices 112 may each execute and operate instances of the applications accessing the mobile information management system servers.

On reading this disclosure, those of skill in the art will recognize that many of the components discussed as separate units may be combined into one unit and an individual unit may be split into several different units. Further, the various functions could be contained in one computer or spread over several networked computers and/or devices. The identified components may be upgraded and replaced as associated technology improves and advances are made in computing technology.

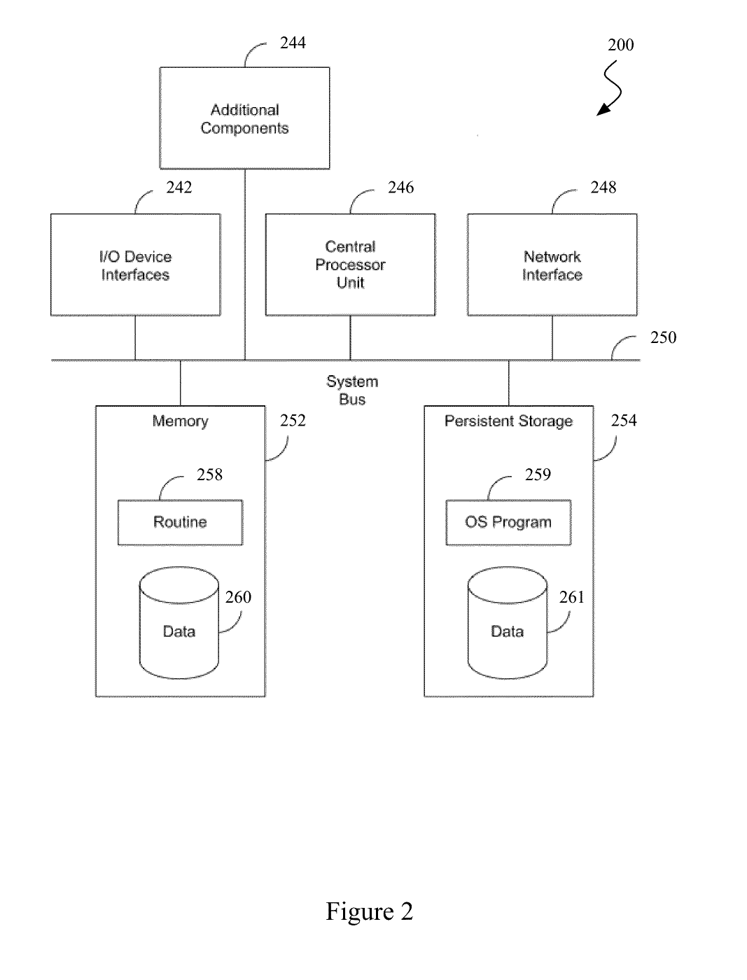

Referring now to FIG. 2, each component of the system 200 is connected to a system bus 250, providing a set of hardware lines used for data transfer among the components of a computer or processing system. Also connected to the bus 250 are additional components 244 of the mobile information management system, such as additional memory storage, digital processors, network adapters, and I/O devices. The bus 250 is essentially a shared conduit connecting different elements of a computer system (e.g., processor, disk storage, memory, input/output ports, network ports, etc.) and enabling transfer of information between the elements. An I/O device interface 242 is attached to system bus 250 in order to connect various input and output devices (e.g., keyboard, mouse, touch-screens, displays, printers, speakers, etc.) to the mobile information management system. A network interface 248 allows the computer to connect to various other devices attached to a network (e.g., network 122 of FIG. 1). A memory 252 provides volatile storage for computer software instructions 258 and data 260 used to implement methods employed by the system disclosed herein. Disk storage 254 provides non-volatile storage for computer software instructions 259 and data 261 used to implement an embodiment of the present disclosure. A central processor unit 246 is also attached to system bus 250 and provides for the execution of computer instructions.

In one embodiment, the processor routines 258 and data 260 are a computer program product, including a computer readable medium (e.g., a removable storage medium such as one or more DVDROM's, CD-ROM's, diskettes, tapes, etc.) that provides at least a portion of the software instructions for the system. A computer program product that combines routines 258 and data 260 may be installed by any suitable software installation procedure, as is well known in the art. In another embodiment, at least a portion of the software instructions may also be downloaded over a cable, communication, and/or wireless connection.

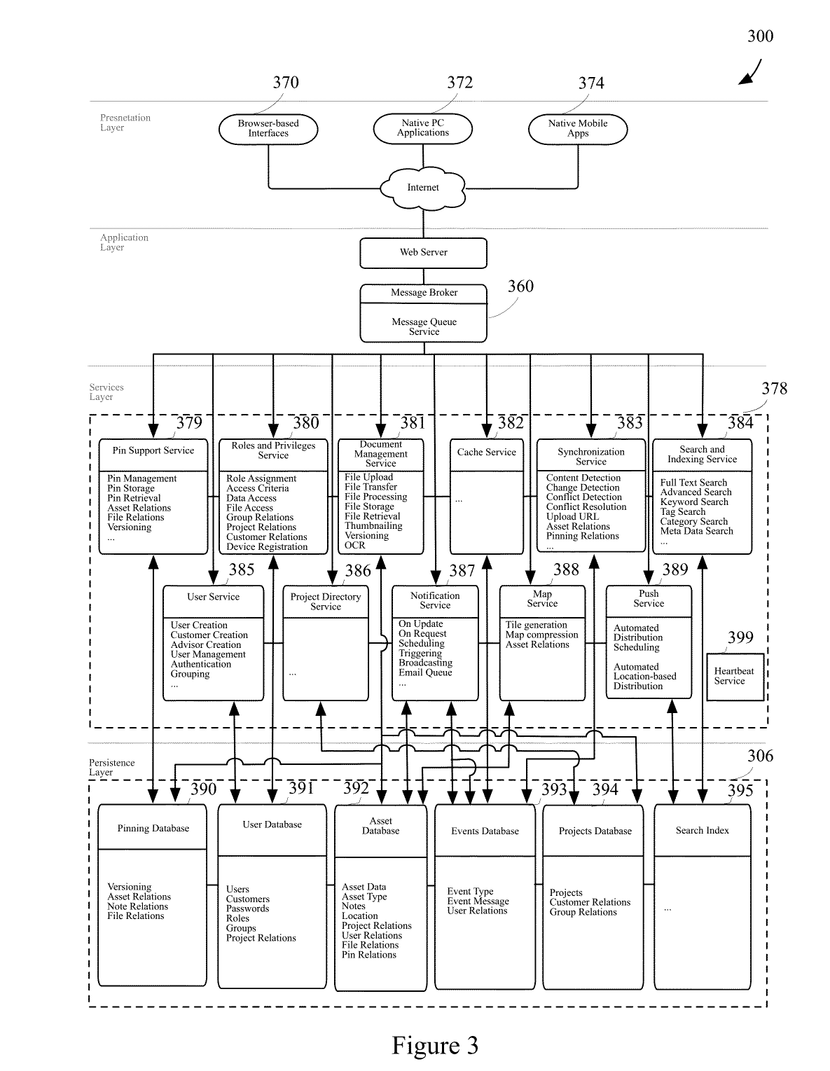

Referring now to FIG. 3, client devices can provide user interfaces to one or more of the functions of the mobile information management system services 378. Such interfaces can be browser-based, application-based, or both. In some embodiments, these applications can include application containers such as html clients 370, native computer applications 372, and/or native mobile apps 374.

The mobile information management system architecture 300 can include a services layer 378 that exposes a variety of discreet services accessible to authorized clients 370, 372, 374 and/or services. It is through these services that information can be added to, and retrieved from, the databases found in the persistence layer 306. The services layer 378, together with the persistence layer 306, can, in part, consist of a collection of distributed classes and data stores providing the mobile information management system functionality.

In some embodiments, the pin support service 379 provides classes and/or associated methods and data structures for mobile information management system pin management, storage, retrieval, asset relations, file relations, and versioning functions. These classes and/or methods are supported by data and data relations stored in a persistence layer 306 that can include a pinning database 390.

The roles and privileges service 380 can provide classes and/or associated methods and data structures for role assignment, access criteria configuration, data access, file access, group relations, project relations, and customer relations functions. These classes and/or methods are supported by data and data relations stored in a persistence layer 306 that can include a user database 391.

In certain implementations, the document management service 381 provides classes and/or associated methods and data structures for file upload, file transfer, post-upload processing, file storage, file retrieval, thumbnailing, versioning, and OCR functions. These classes and/or methods are supported by data and data relations stored in a persistence layer 306 that can include a pinning database 390 and an asset database 392. In some implementations the Tesseract optical character recognition supports the OCR functionality of this service.

A cache service 382 is communicatively coupled to a message broker 360. The cache service 382 can send messages to the message broker, 360, which may then queue messages in a runtime database and/or a persistent events database 393 for eventual distribution to one or more services in the services layer 378. In some instances, the cache service records which devices are storing which files locally and supports the synchronization service in queuing change detection communications for delivery to the appropriate devices.

In some instances, the synchronization service 383 provides classes and/or associated methods and data structures for new content detection, changed content detection, content conflict detection, content conflict resolution, upload URL generation, asset relations, and pinning relations functions. These classes and/or methods are supported by data and data relations stored in a persistence layer 306 that can include an events database 393.

A search and indexing service 384 provide search-related functionality for the mobile information management system. One or more search indices stored in a search index data store 395 can provide support for the search and indexing service 384. In some instances, the search index data store 395 can be one or more flat files stored within an operating system file structure.

The user service 385 provides classes and/or associated methods and data structures for user creation, customer creation, user management, authentication, and grouping functions. These classes and/or methods are supported by data and data relations stored in a persistence layer 306 that can include a user database 391.

In some embodiments, the project directory service 386 provides classes and/or associated methods and data structures for creating and managing project, asset relations, and user relations functions. These classes and/or methods are supported by data and data relations stored in a persistence layer 306 that can include a projects database 394.

The notification service 387 provides classes and/or associated methods and data structures for update-triggered notification, request-driven notification, notification scheduling, broadcasting, and email queuing functions. These classes and/or methods are supported by data and data relations stored in a persistence layer 306 that can include an asset database 392 and an events database 393.

In certain implementations, the push service 389 provides classes and/or associated methods and data structures for scheduling automated distribution of asset-related files and data, and for location-based automatic distribution functions. These classes and/or methods are supported by data and data relations stored in a persistence layer 306 that can include an events database 393.

The map service 388 provides classes and/or associated methods and data structures for tile generation, map compression, and asset relations functions. These classes and/or methods are supported by data and data relations stored in a persistence layer 306 that can include an asset database 393.

The heartbeat service 399 provides status monitoring support for the other server services in the services layer 378.

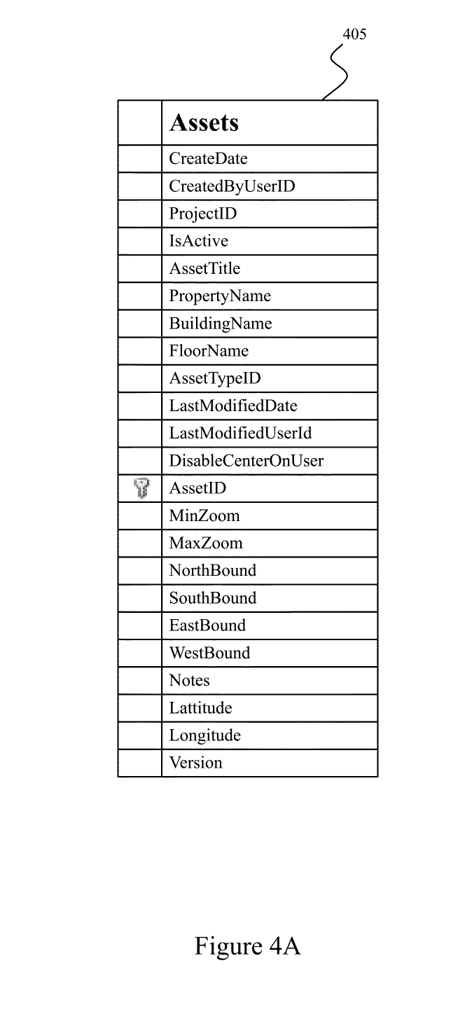

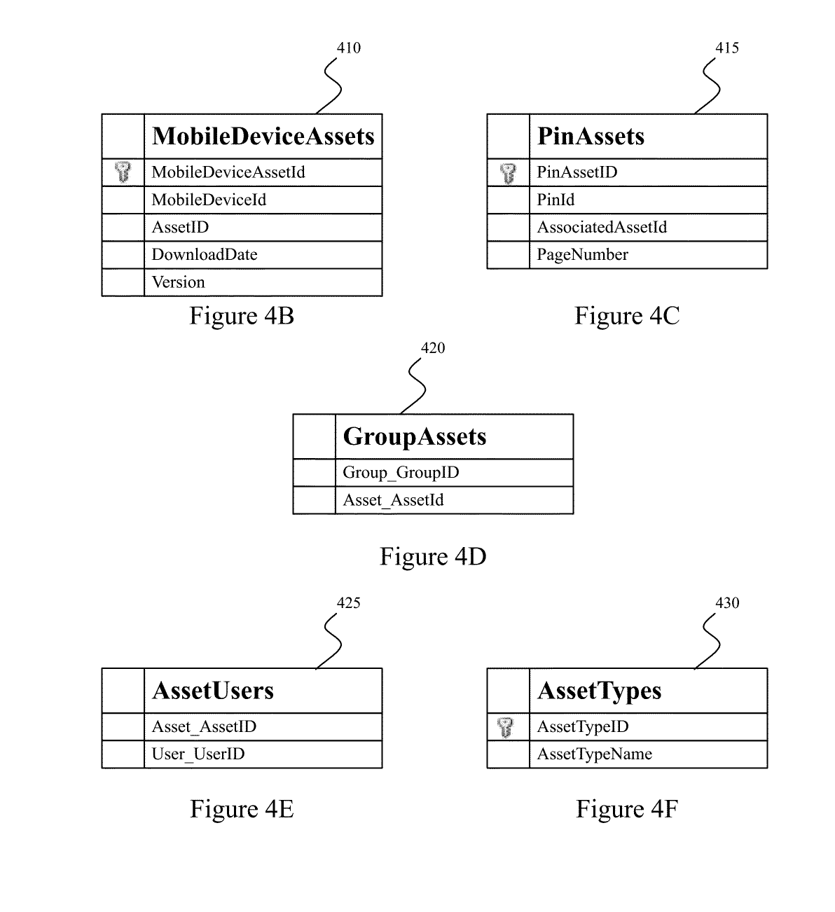

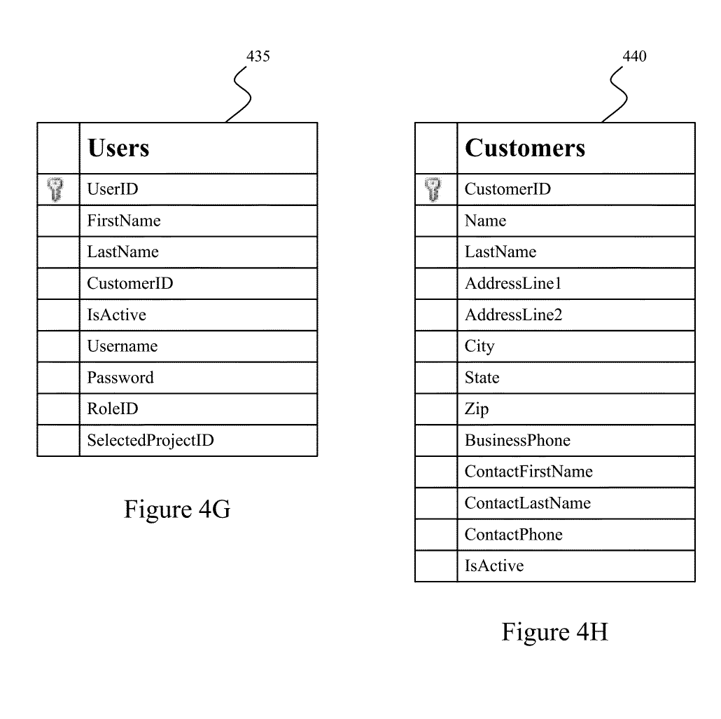

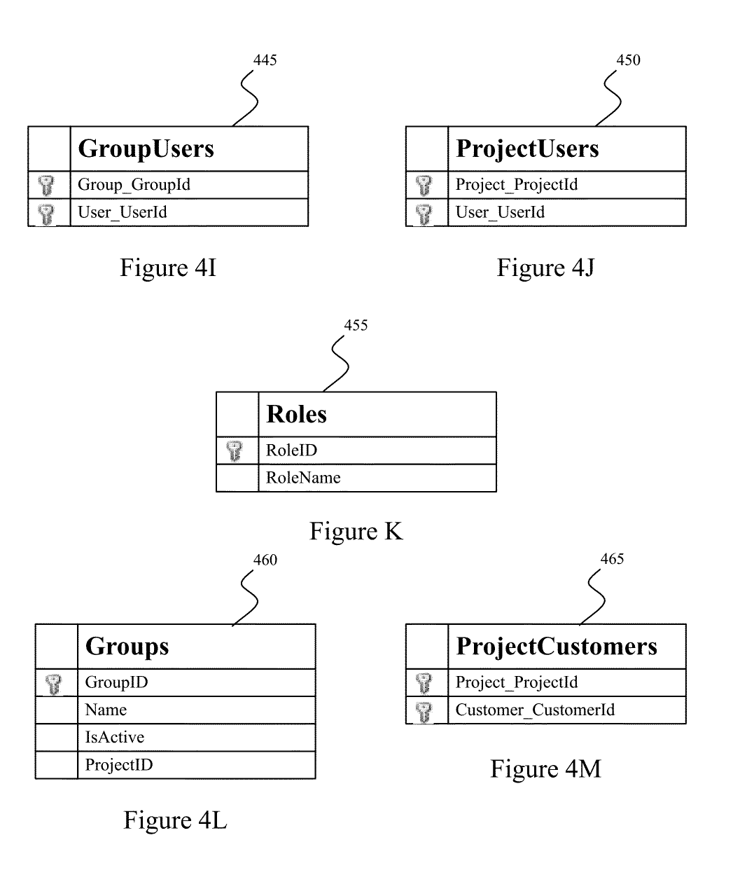

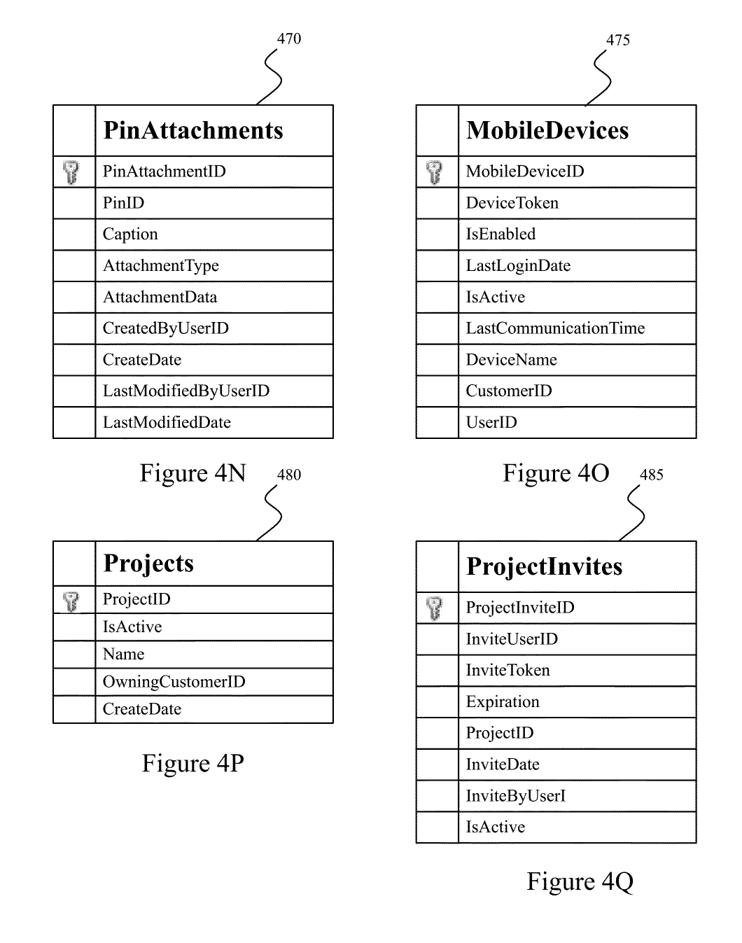

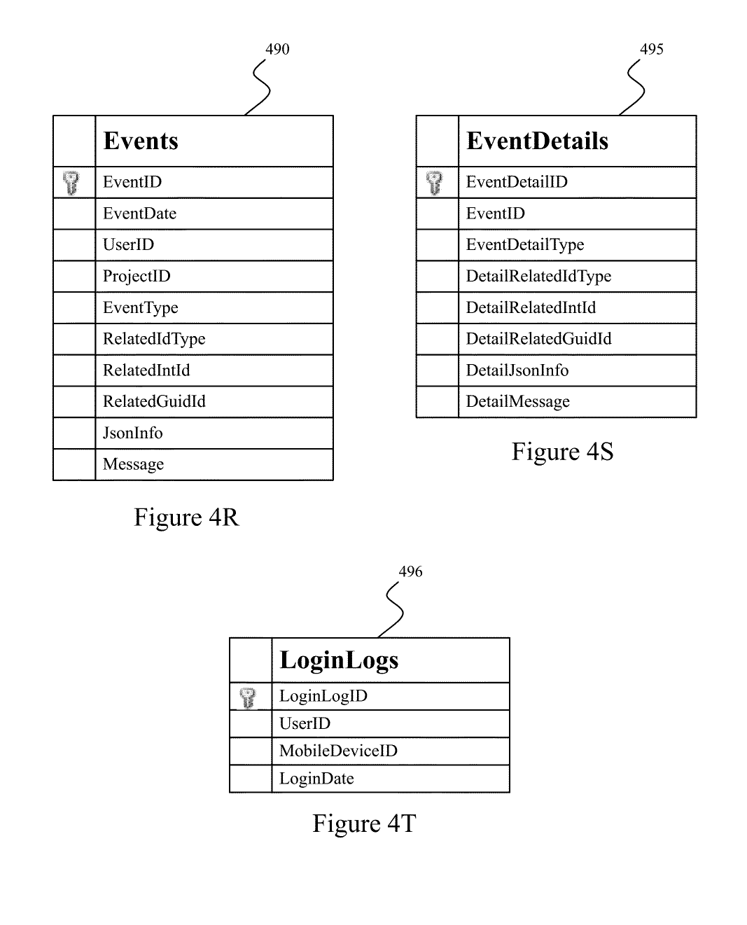

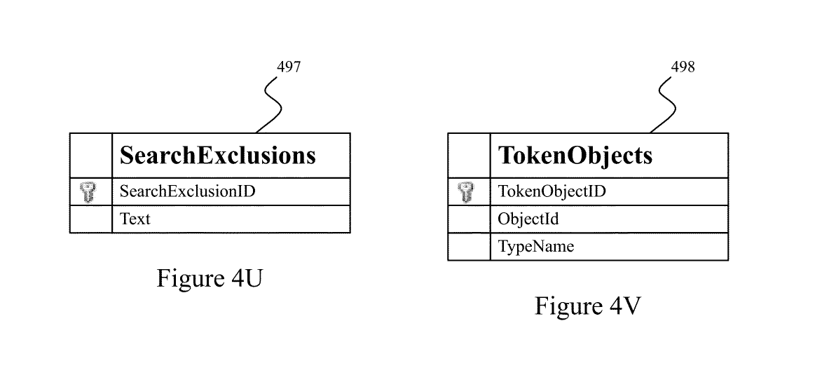

Referring now to FIG. 4A through FIG. 4V, an example set of database tables as part of a relational database schema supporting the persistence layer 306 and the services layer 378 of the mobile information management system 3500 is shown according to an exemplary embodiment (e.g., see FIG. 1 and FIG. 3).

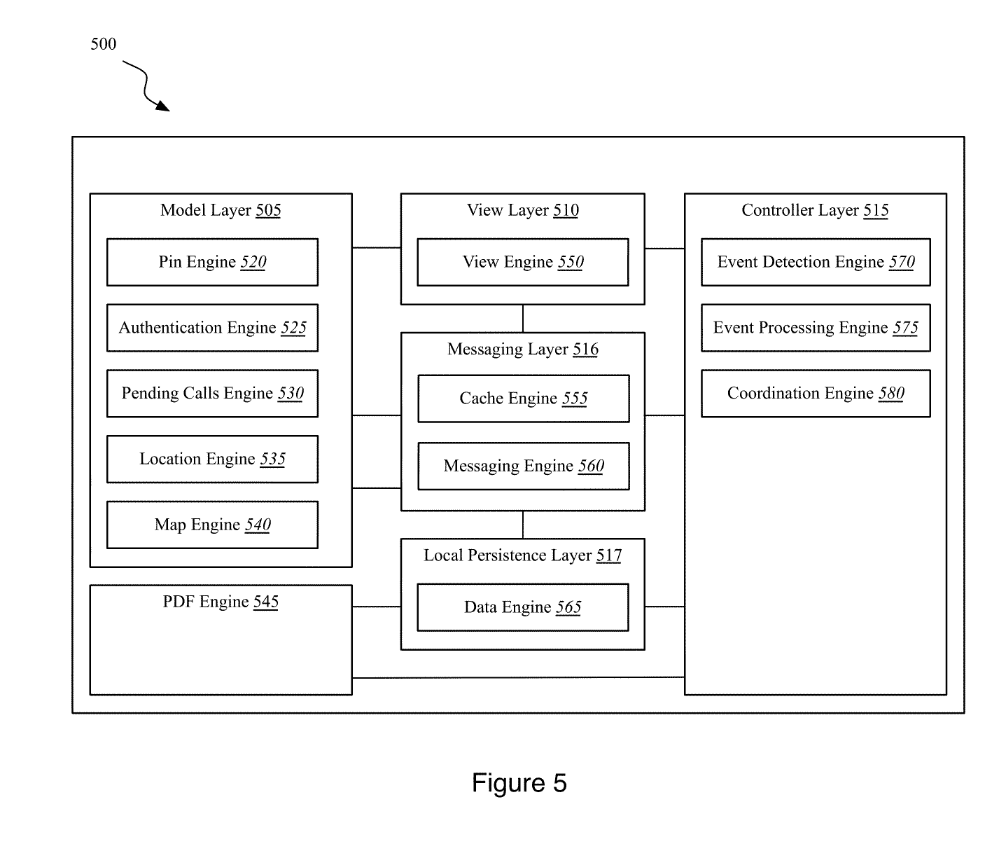

Referring now to FIG. 5, in some embodiments, native mobile app 374 (e.g. see FIG. 3) can be implemented according to application layer architecture 500. Native mobile app 374 is one example of a client interface depicted in FIG. 3. Native mobile app 374 can include a model layer 505, a view layer 510, a controller layer 515, a messaging layer 516, a local persistence layer 517, and a PDF engine 545. The model layer 205 can include a pin engine 520, an authentication engine 525, a pending calls engine 530, a location engine 535, and a local search engine 540. The view layer 510 can include a view engine 550. The controller layer 515 can include an event detection engine 570, an event processing engine 575, and a coordination engine 580. The messaging layer 516 can include a cache engine 555 and a messaging engine 560. The local persistence layer 517 can include a data engine 565. These engines can be implemented as objects, modules, routines, services, distributed services, web services, or any other programming model capable of implementing the systems and methods described herein.

In some embodiments, the pin engine 520 supports the placement of pins on a visual display of a map. It 250 also provides functionality relating pins to location information, floor plans, documents, document pages, notes, file attachments, and the like.

An authentication engine 525 obtains login credentials for validation with credentials stored locally in a local persistent data store 517 and/or credentials stored remotely in a remote persistent data store 306 (e.g., see FIG. 3). The authentication engine 525 then validates those credentials, and determines at least initial application and asset access based on that validation.

In certain instances, a pending calls engine 530 monitors pending calls made to one or more services in the services layer 378 (e.g., see FIG. 3). This can allow the coordination engine 580 to direct the view engine 550 to display a view indicating the status of one or more pending calls.

In some implementations, a location engine 535 performs various functions related to obtaining, converting, storing, and monitoring location and/or location data. The location engine 535 can associate a set of x,y (or other) coordinates with one or more local maps, such as a floor plan map. The localization engine 535 may then associate location information with, e.g., x,y coordinates by, for example, transforming world coordinates to x,y floor plan coordinates. In some implementations, a registration pin can be dropped at one or more locations on the local map that corresponds with the current location of the mobile computing device. As the number of registered locations increases, the localization engine 535 can then automatically determine the x,y (or other) coordinates that correspond to the current location of the mobile computing device 114, 116 by performing triangulations functions, smoothing algorithms, multiple linear regression, conversions, and the like. Location information can be derived from access point distance calculations, received from access points such as base stations, derived from global positions system data, access point location data triangulation, and the like.

A local search engine 540 can be configured to query local data and/or search against a local project directory across multiple documents. For example, the local search engine can query for a particular key word across all accessible floor plans, documents, and pins stored locally on a mobile computing device 114, 116.

In certain instances, the PDF engine 545 can be configured to display, edit, save, annotate, and/or flag PDF files. The PDF engine can detect that a PDF has been saved with annotations, and can pass a message to the cache engine 555 for queuing with the messaging engine 560. The messaging engine can then generate a STOMP message and send the message to the synchronization service 383 registering an upload (e.g., see FIG. 3).

The synchronization service 383 can generate an upload URL, which can be sent to the device registering the upload. When a connection is available, the application can upload the PDF document to the document management service 381 over HTTP using the provided URL.

The document management service 381 can use a key value included in the URL to identify the appropriate document stored in the persistence layer 306 such that the document can be updated accordingly. In certain instances, PDF annotations may be merged using a dynamic PDF generation library such as, for example, ABCpdf™. A GUID token that expires after a defined period of time has passed, such as ten minutes, can be passed as an http request.

In some implementations communications can be implemented, in part, using web sockets. A web socket interface, for example, can define a full-duplex single socket connection over HTTP, on which messages can be sent between client computing devices and server computers. This can reduce complexity around bi-directional web communication, connection management, or both.

A data engine 565 can be configured to interface with, and perform data transactions against, a local device file structure, a local persistent data store such as, for example, a SQLlite instance, or both. The data engine functions can be encapsulated in higher level functions available to one or more engines, application methods, or both.

An event detection engine 570 and event processing engine 575 can recognize user interface events and initiate methods associated with those events. For example, when a save button press event is detected after editing a PDF file, the event detection engine 570 can detect the button press event and call the event processing engine 575 to initiate the appropriate processing activities, such as directing the coordination engine 580 to pass information to the data engine 565 for persistent storage, directing the view engine 550 to generate the appropriate presentation view according to the success or failure of the save function, or both.

In some embodiments, a system administration interfaces, such as html pages, are provided to one or more computing devices 112 (see, e.g., FIG. 1) by the mobile information management system servers 124. In certain implementations, information, assets, users, groups, and projects are siloed by a customer or user.

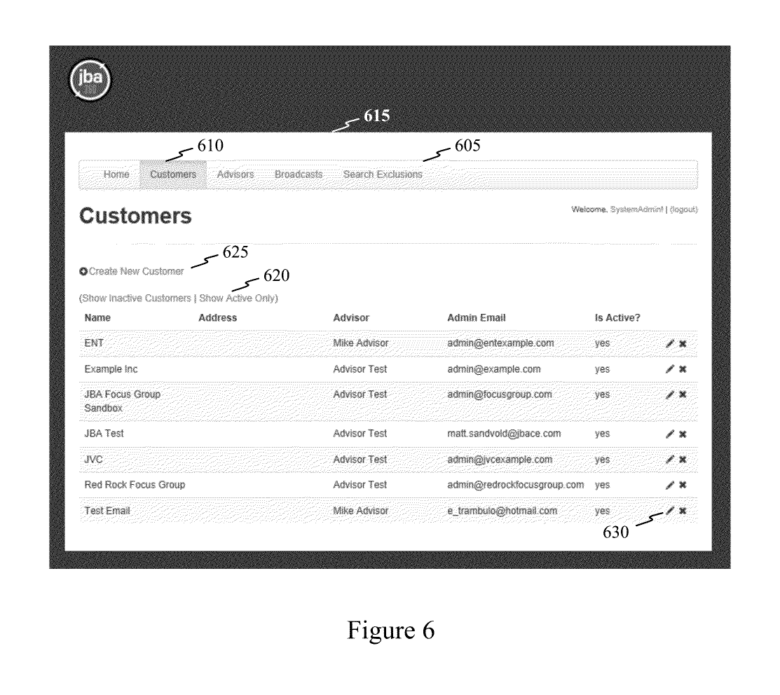

Referring now to FIG. 6, detection of a system administrator login authentication event displays a system administration tabbed html interface 605. Detection of the selection event associated with the customers tab 610 displays the customers page 615 listing active customers, inactive customers, or both. The display of active and inactive customers can be toggled by one or more display controls 620. Information displayed on the customers page can be retrieved by requests to the user service 385 (e.g., see FIG. 3), which can access the user database 391. The user service 385 can also provide creation and edit services for customer records.

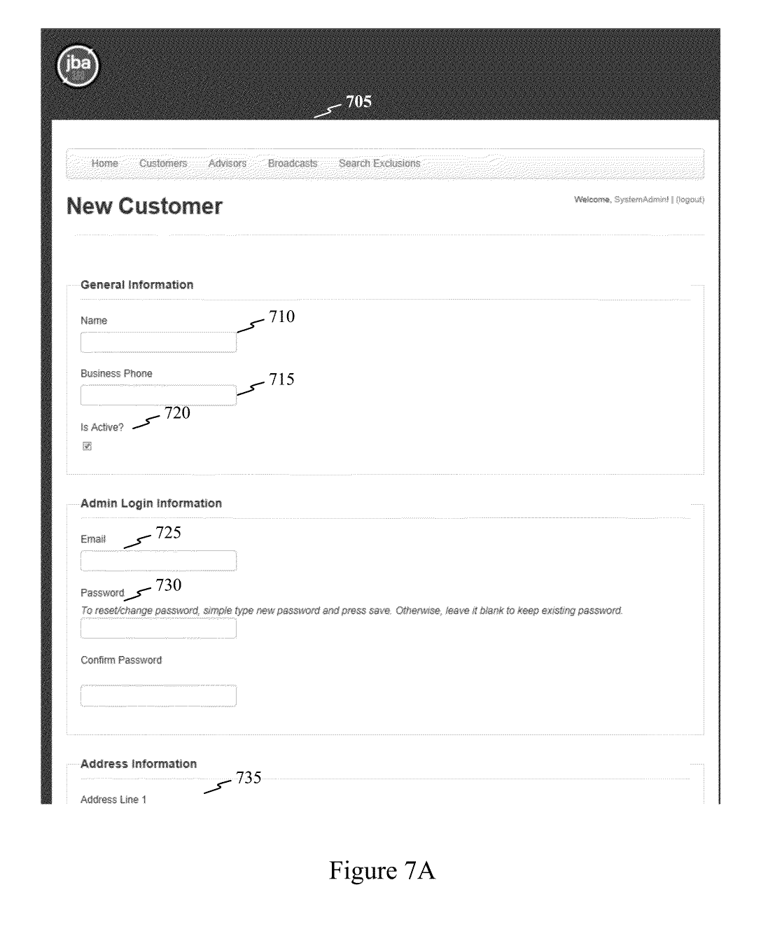

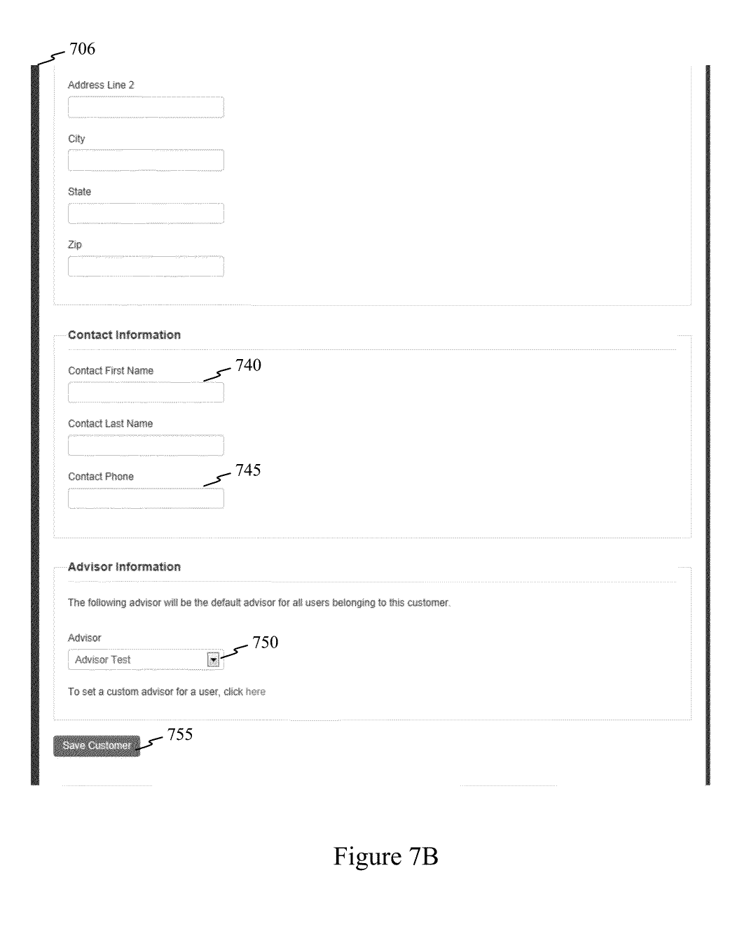

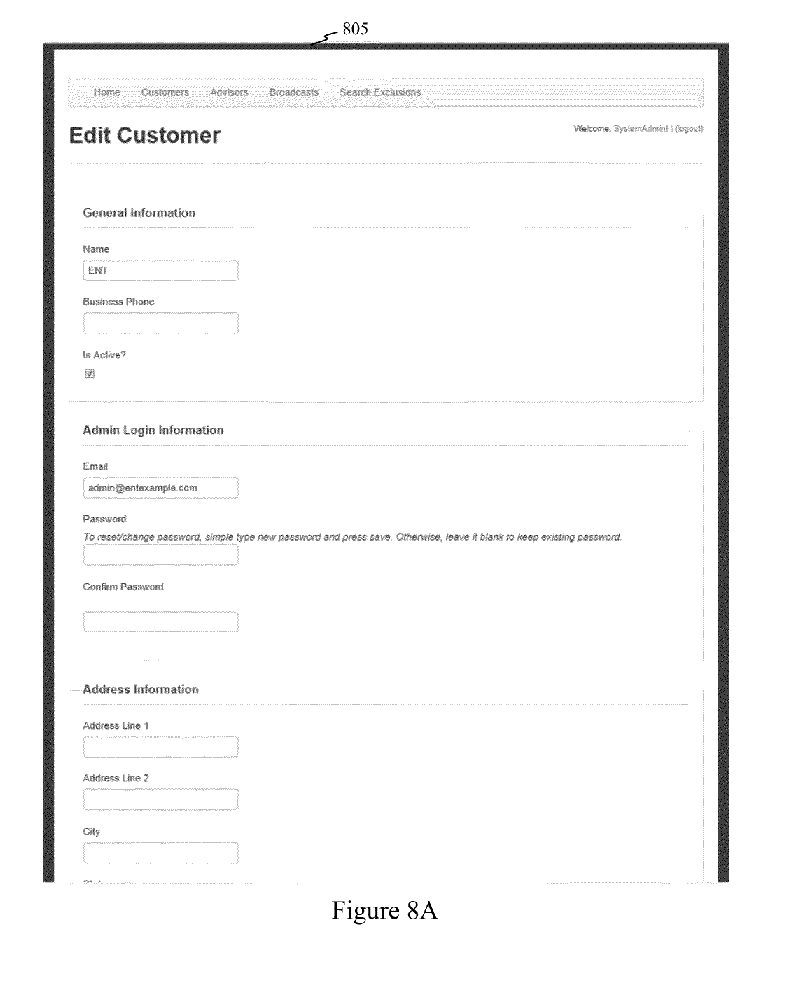

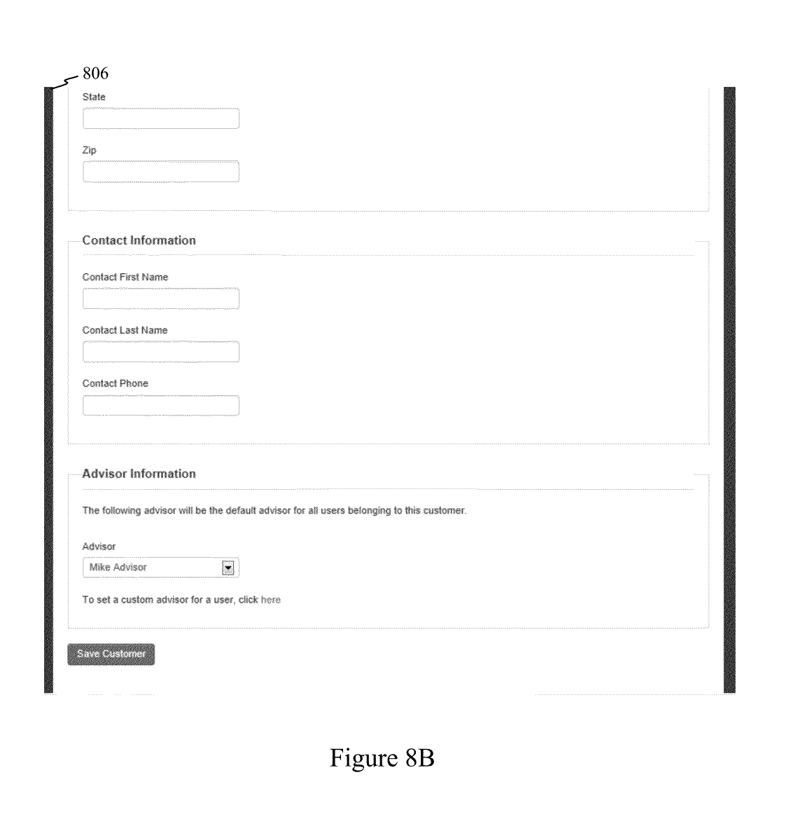

Referring now to FIGS. 7A through 8B, a substantially similar interface can be used for the creation of customer records and for the editing of customer records. Detection of the selection event associated with the Create New Customer link 625 (e.g., see FIG. 6) results in display of the new customer page 705, 706. The new customer page can receive new customer information, such as, for example, the customer name 710, business phone 715, active status 720, email address 725, password 730, address 735, contact name 740, contact phone 745, and assigned advisor 750. Upon detection of the click event associated with the save customer button 755, the received customer information is marshaled and a customer record creation request is sent to the user service 385 (see, e.g., FIG. 3). The user service 385 can request the addition of records and field values to the appropriate databases, including the user database. Upon detection of the selection event associated with the customer edit control 630, the edit customer page is displayed 805, 806, which appears and operates in substantially the same manner as described for the new customer page 705, 706.

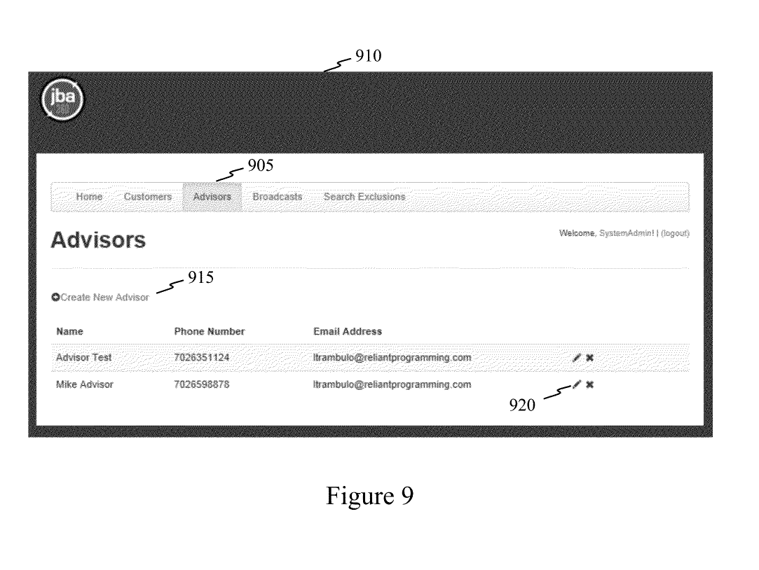

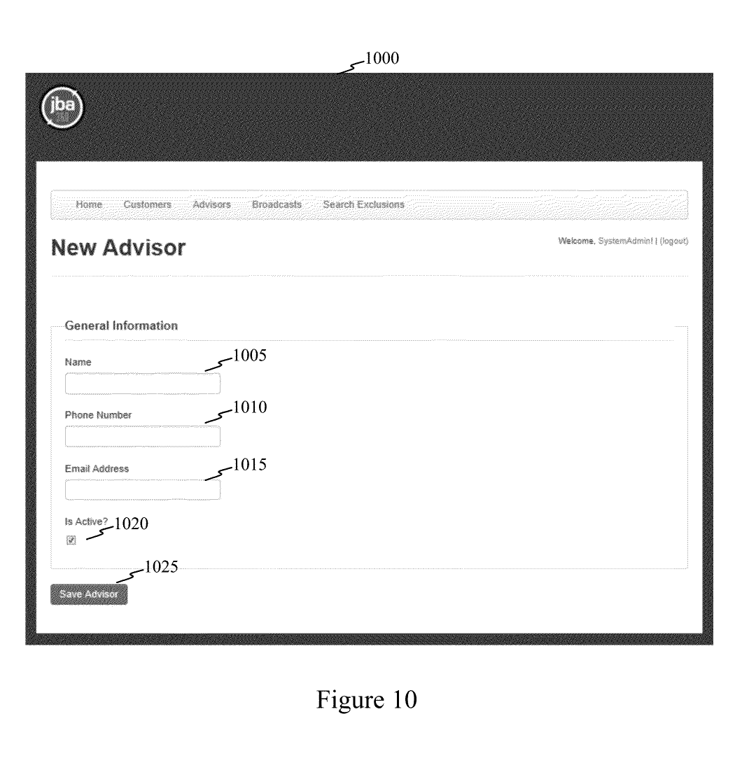

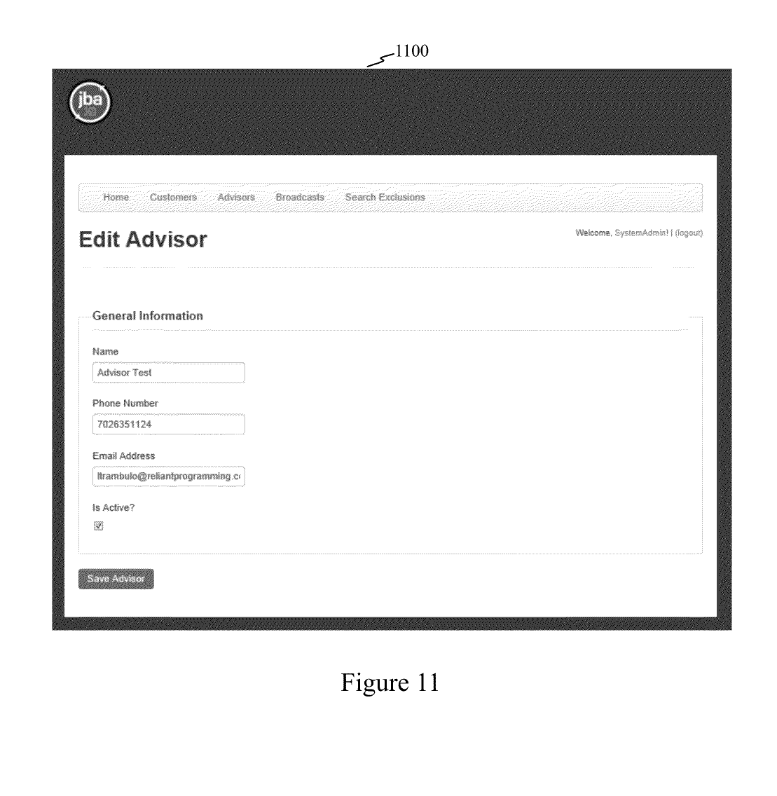

In some instances, advisors can be assigned to customers. Advisors can be individuals available to provide assistance, additional services, and the like to customers or users. Referring now to FIG. 9 through FIG. 11, a substantially similar interface can be used for the creation of advisor records and for the editing of advisor records. Detection of the selection event associated with the advisors tab 905 displays the advisors page 910 listing the advisor records stored in the user database 391 (e.g., see FIG. 3). Detection of the selection event associated with the Create New Advisor link 915 causes display of the new advisor page 1000. The new advisor page can receive new advisor information, such as, for example, the advisor name 1005, advisor phone number 1010, email address 1015, and active status 1020. Upon detection of the click event associated with the save advisor button 1025, the received advisor information is marshaled and an advisor record creation request is sent to the user service 385. The user service 385 can request the addition of records and field values to the appropriate databases, including the user database. Upon detection of the selection event associated with the advisor edit control 920 (see, e.g., FIG. 9), the edit advisor page is displayed 1100 which appears and operates in substantially the same manner as described for the new advisor page 1000.

In some implementations, a search exclusion window (not shown) receives certain terms to be excluded from query requests made to the search and indexing service 384 (see, e.g., FIG. 3) by the search and indexing service 384, or both. This masks, for example, common words that might otherwise return a large number search results. The system administrator can, for example, exclude both common words and industry specific terminology, as well other particular terms that might prove problematic.

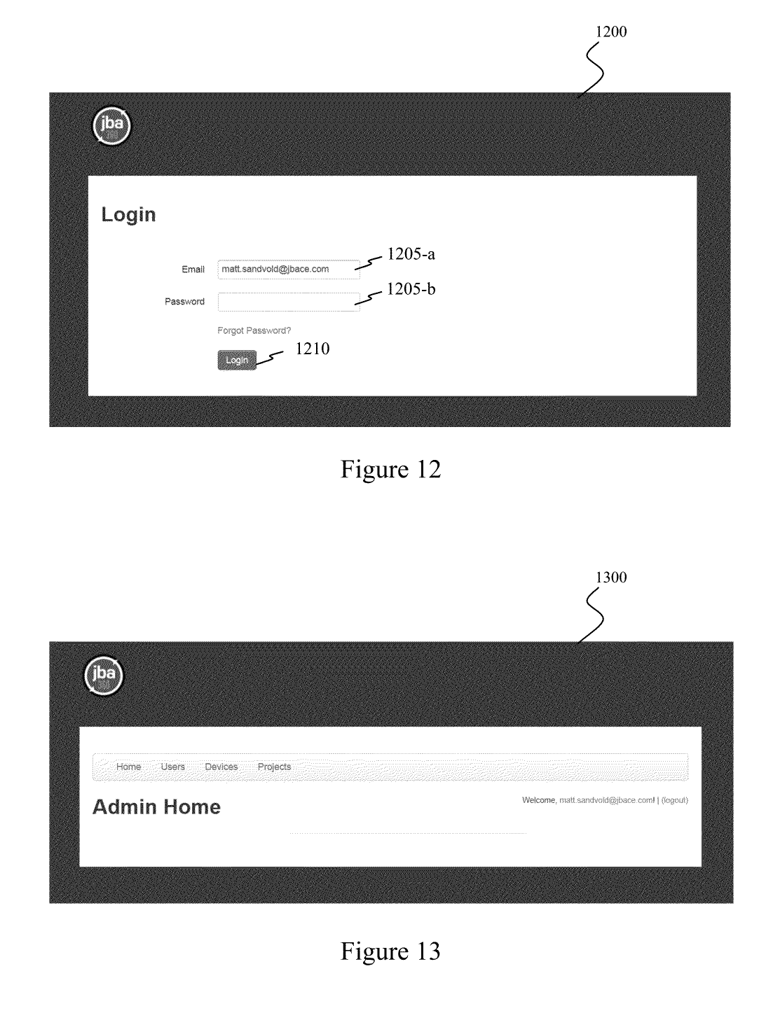

Once a customer record is created and a customer administrator is identified, the associated customer deployment configuration can occur. In some instances, a customer administration interfaces, such as html pages, are provided to one or more computing devices 112 (see, e.g., FIG. 1) by the mobile information management system servers 124. Referring now to FIGS. 12 and 13, a customer administrator is initially presented with an authentication page, such as the customer login page 1200, requesting authentication credentials 1205. Once the credentials are received and the login button 1210 selection event is detected, the authentication values are securely transmitted to the user service 385 (see, e.g., FIG. 3) for authentication. Upon successful authentication, the mobile information service web servers 128 (see, e.g., FIG. 1) send the customer administration home page 1300 to the computing device 112 requesting authentication.

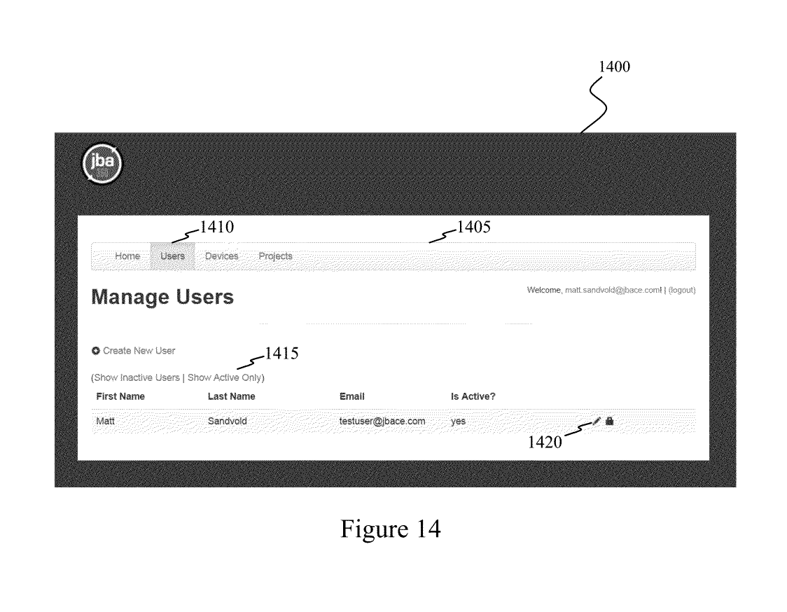

Referring now to FIG. 14, detection of the selection event associated with users tab 1410 displayed on the customer administration tab control 1405 displays the manage users page 1400 listing the active users, inactive users, or both, associated with the customer/user. The display of active and inactive users can be toggled by one or more display controls 1415. Information displayed on the mange users page 1400 can be retrieved by requests to the user service 385 (e.g., see FIG. 3), which can access the user database 391. The user service 385 can also provide creation and edit services for user records.

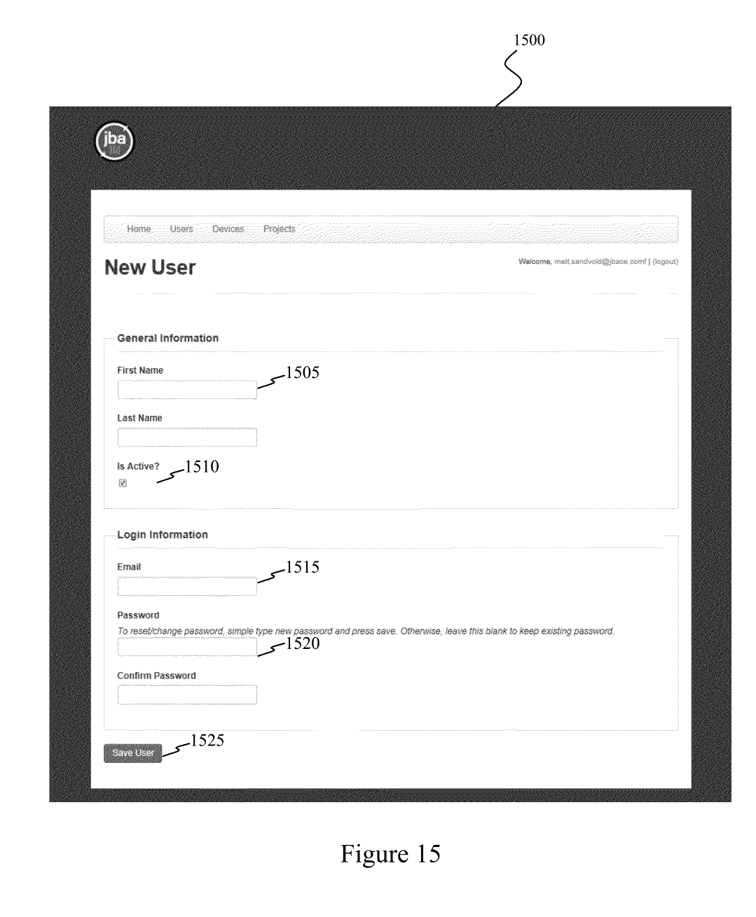

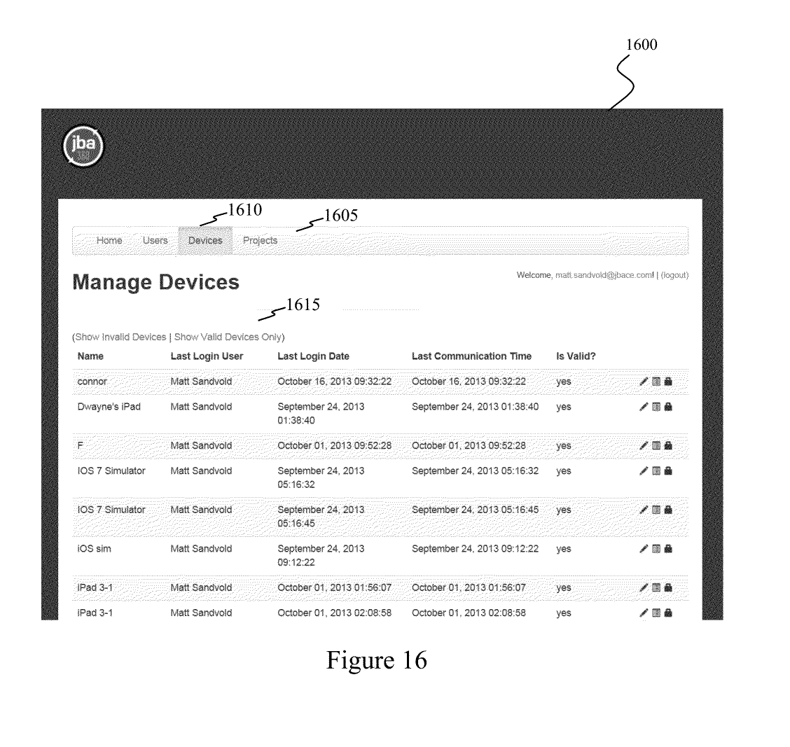

Referring now to FIG. 15, detection of the selection event associated with the Create New User link 1415 displays the new user page 1500. The new user page can receive new user information, such as, for example, the user name 1505, active status 1510, email address 1515, and password 1520. Upon detection of the click event associated with the save user button 1525, the received user information is marshaled and a user record creation request is sent to the user service 385. The user service 385 can request the addition of records and field values to the appropriate databases, including the user database. Upon detection of the selection event associated with the user edit control 1420 (see, e.g., FIG. 14), the edit user page (not shown) is displayed, The edit user page appears and operates in substantially the same manner as described for the new user page 1500.

Customer administrators can also view, monitor, and manage device registrations. Referring now to FIG. 16, detection of the selection event associated with devices tab 1610 displayed on the customer administration tab control 1605 displays the manage devices page 1600 listing the valid devices, invalid devices, or both, associated with the customer. The display of valid and invalid devices can be toggled by one or more display controls 1615. Information displayed on the mange devices page 1600 can be retrieved by requests to the roles and privileges service 380 (e.g., see FIG. 3), which can access the asset database 392.

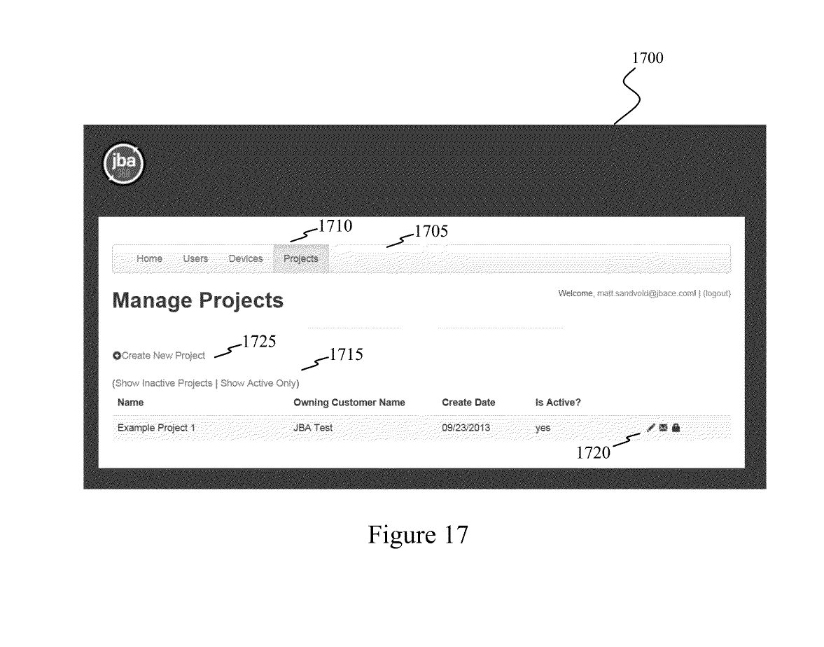

In some instances, project creation and management is made available through the customer administration interface. Referring now to FIG. 17, detection of the selection event associated with projects tab 1710 displayed on the customer administration tab control 1605 displays the manage projects page 1700 listing the active projects, inactive projects, or both, associated with the customer. The display of active and inactive projects can be toggled by one or more display controls 1715. Information displayed on the mange projects page 1700 can be retrieved by requests to the project directory service 386 (e.g., see FIG. 3), which can access the projects database 394.

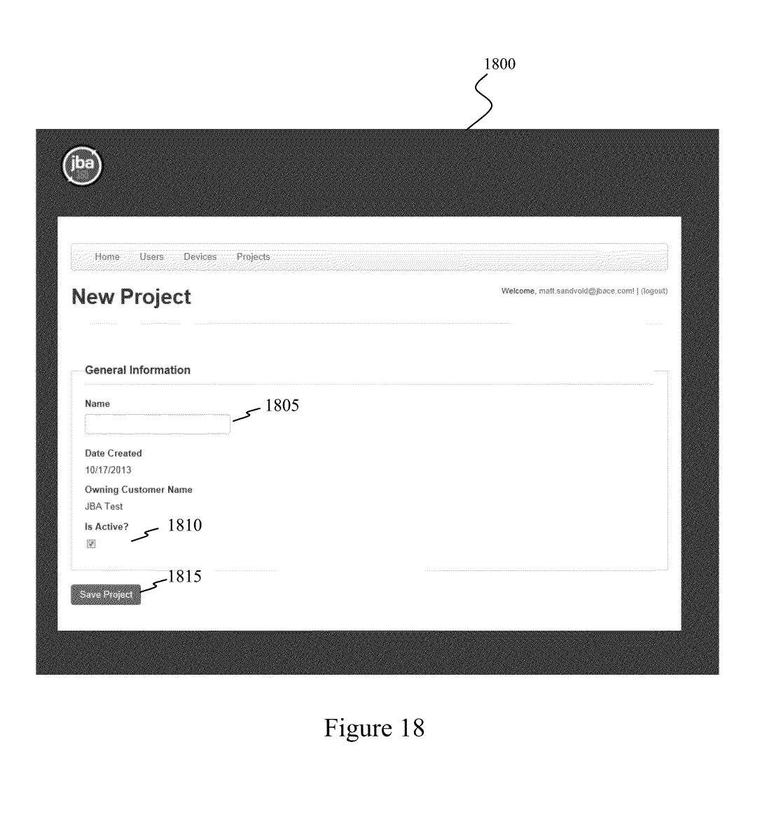

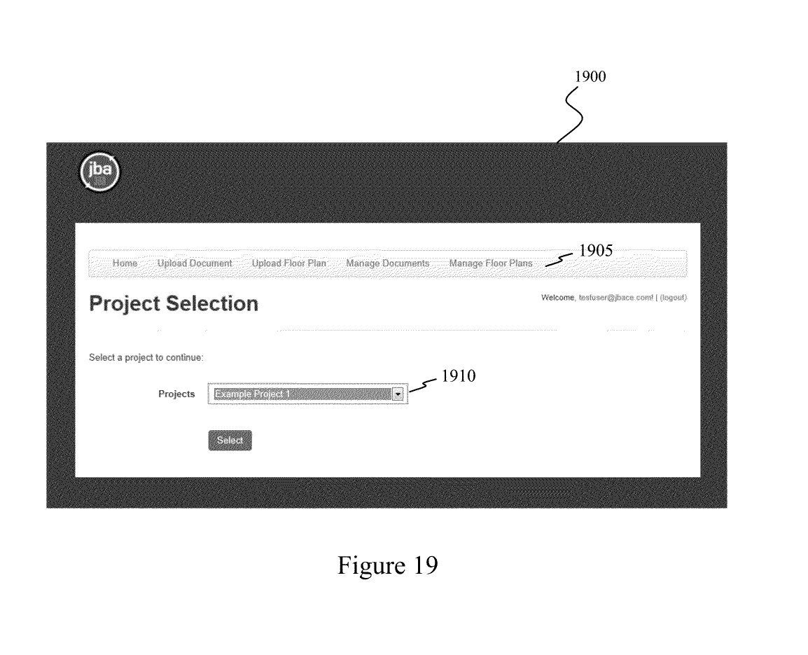

The project directory service 386 can also provide creation and edit services for project records. Referring now to FIG. 18, detection of the selection event associated with the create new project link 1725 displays the new project page 1800. The new project page can receive new project information, such as, for example, the project name 1805 and the active status 1810. Upon detection of the click event associated with the save project button 1815, the received project information is marshaled and a project record creation request is sent to the project directory service 386. The project directory service 386 can request the addition of records and field values to the appropriate databases, including the projects database 394. Upon detection of the selection event associated with the project edit control 1720 (see, e.g., FIG. 17), the edit project page is displayed (not shown) which appears and operates in substantially the same manner as described for the new project page 1800.

In addition to a customer administration interface, in some embodiments, a customer portal interface provides services to manage one or more types of assets. Upon successful authentication, the customer portal home page 1900 is displayed including a projects selection control 1910 for the selection of project assets. Upon detection of a project selection, one or more of the tabs on the tab control 1905 is enabled.

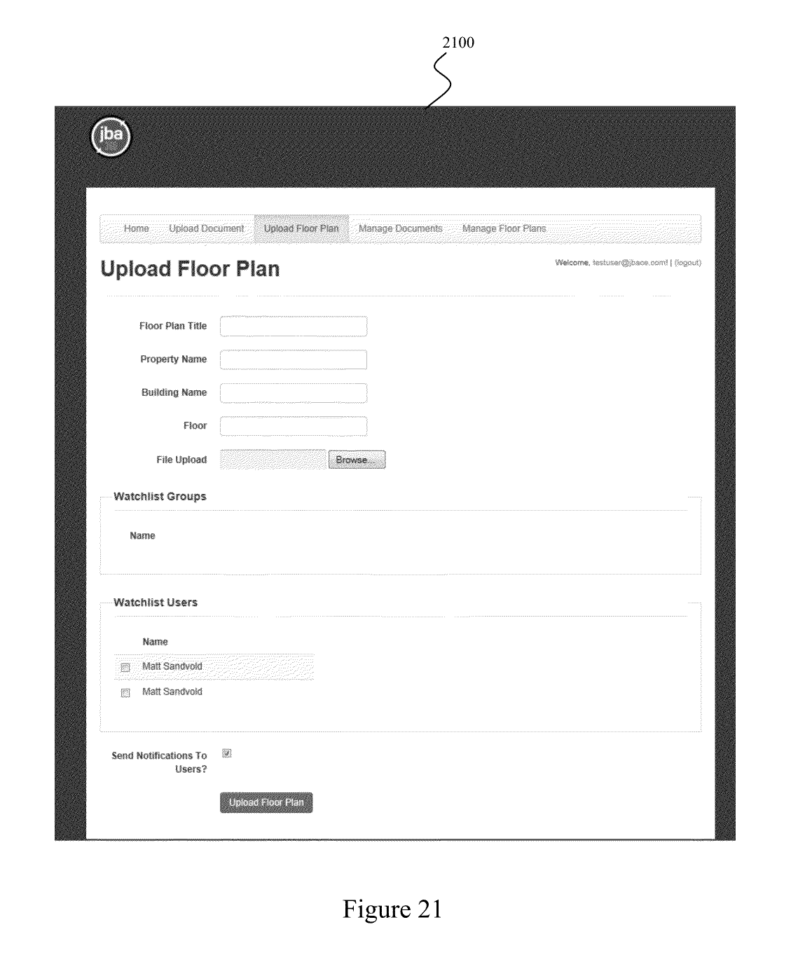

The upload document page 2000 is displayed upon detection of the selection event associated with the upload document tab 2005. This page can receive document information such as document title 2010, property name 2015, building name 2120, and floor 2025. Some or all of this information can be used by the search and indexing service 384 (e.g., see FIG. 3) for filtering search results. Detection of the selection event associated with a browse button 2030 initiates an interface for the selection of a file accessible by the local file directory browsing interface. Selection of watchlist users 2035, in conjunction with selection of the send notification to users check box 2045, directs the notification engine 387 to send notification messages to the selected users upon occurrence of the document upload. Upon detection of the selection event associated with the upload floor plan tab control 2045 the upload floor plan page is displayed 2100 (see FIG. 21) which appears and operates in substantially the same manner as described for the upload document page 2000.

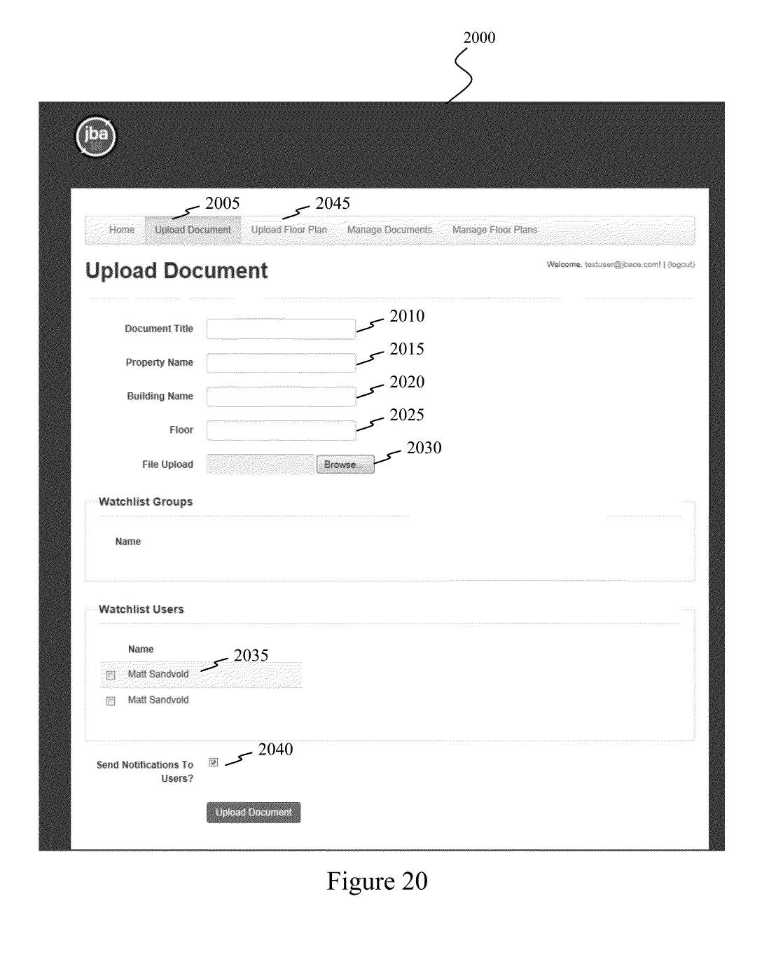

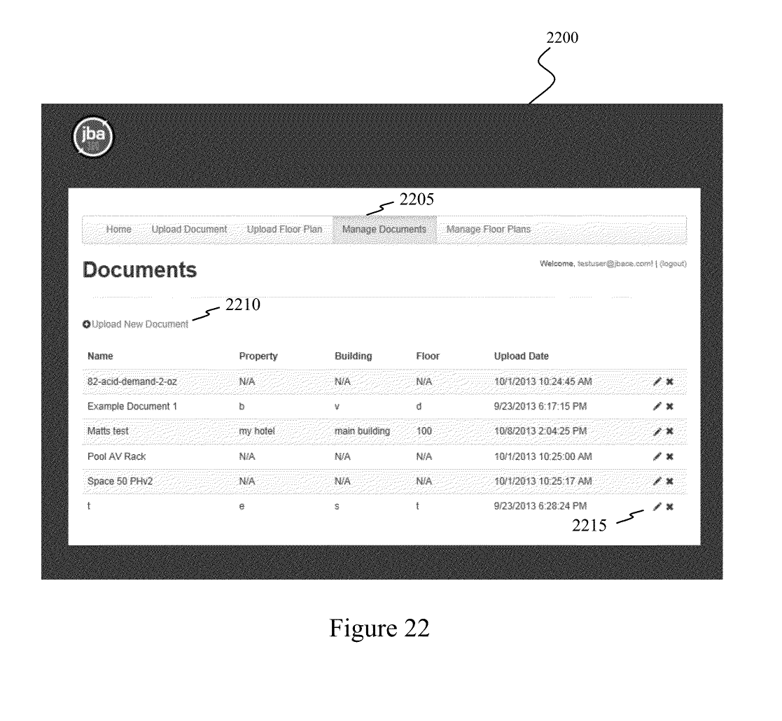

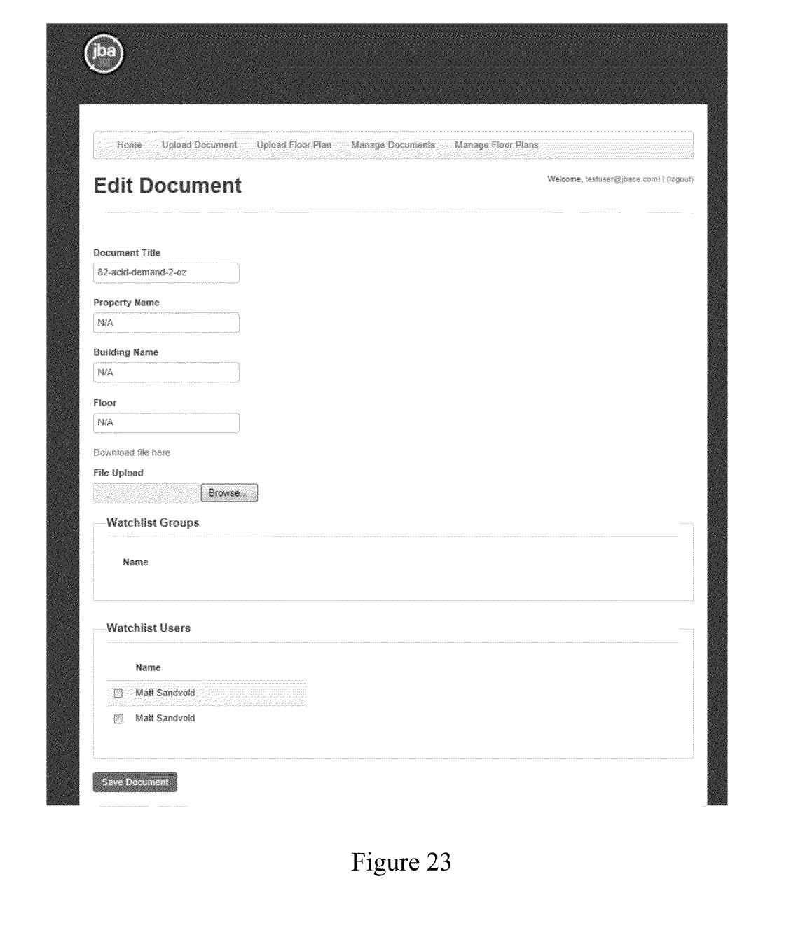

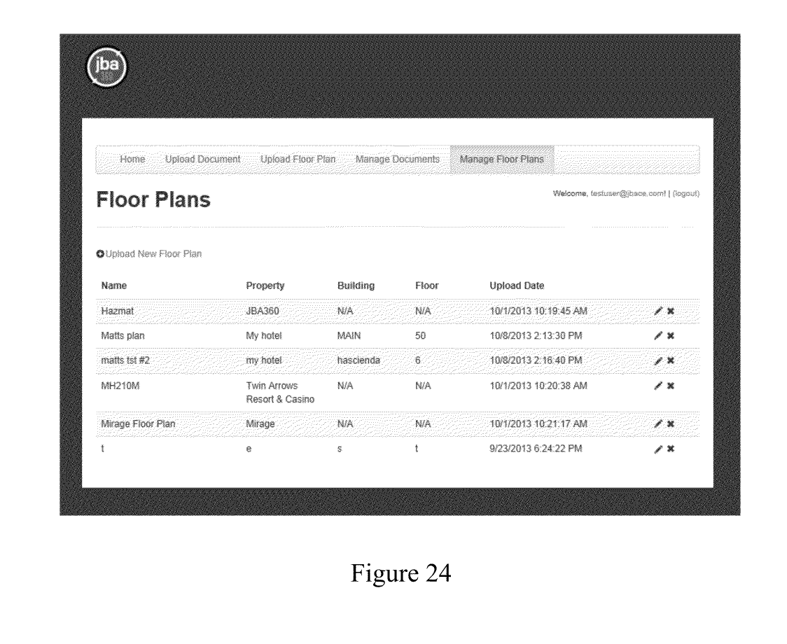

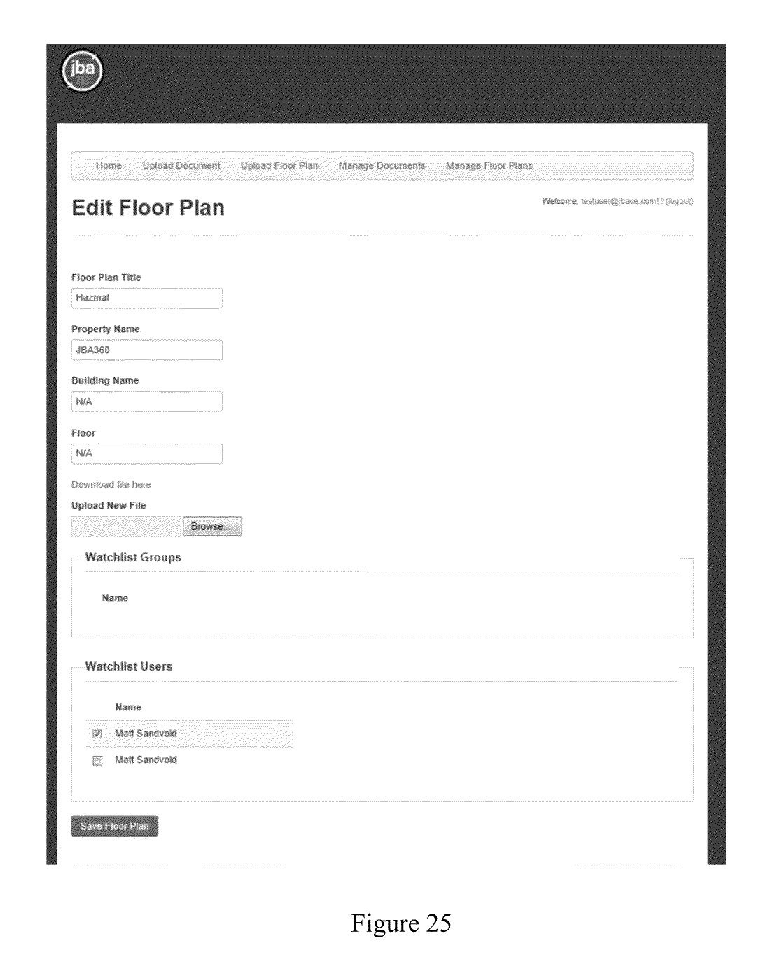

Referring now to FIG. 22, detection of the selection event associated with the manage documents tab 2205 displays the manage document page 2200 listing all documents associated with the project and displaying some of the information associated with the documents. The listing can be generated and transmitted by the document management service 381 (see, e.g., FIG. 3). Detection of the selection event associated with the upload new document 2210 displays the upload document page 2000 (e.g., see FIG. 20). Detection of the selection event associated with the document edit control 2215 displays the edit document page 2300 (see, e.g., FIG. 23), which appears and operates in substantially the same manner as described for the upload document page 2000. Referring now to FIG. 24 and FIG. 25, pages for managing and editing floor plans appear and operate in substantially the same manner as described for the manage documents 2200 and upload floor plan 2100 page 2000 (see, e.g., FIG. 22 and FIG. 21).

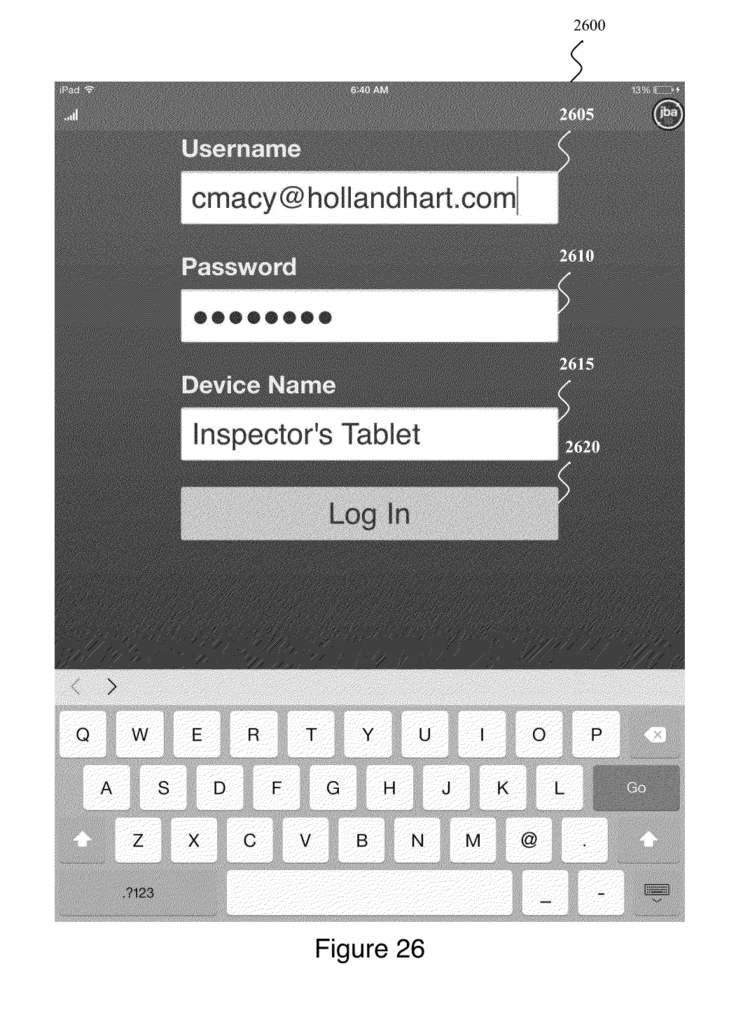

Referring now to FIG. 26, the view engine 550 of the native mobile app 374 displays an initial login view 260 that includes authentication and identification controls for receiving authentication, user identification, and device identifications. These controls can include edit controls for entering username 2605, password 2610, and device name 2615. Detection of a the press event associated with a login button 2620 by the event detection engine 570 initiates event processing. The event processing engine 575 engages the authentication engine to authenticate the user on the mobile device 114, 116 and with the mobile information management system services 378, in particular, the user service 385.

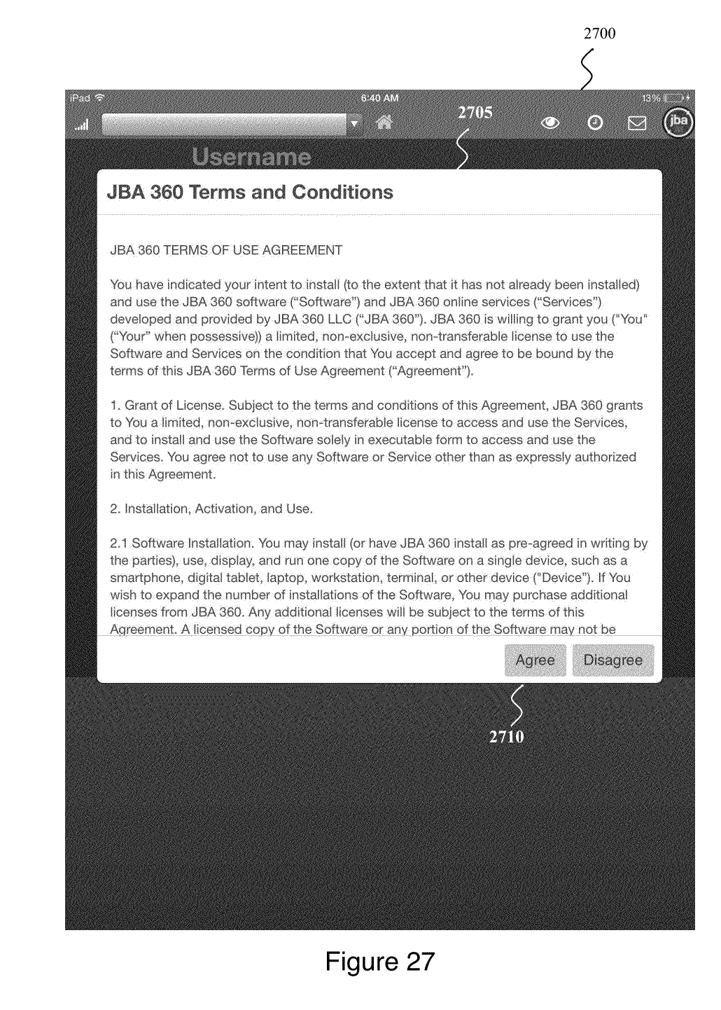

The system operator provides each user for a particular project with an initial username and password (e.g., see FIG. 9) for entry into the respective input controls 2605, 2610. Upon successful authentication on the mobile device 114, 116, referring now to FIG. 27, the view engine 550 presents terms and conditions acceptance view 2700. Upon detection of the click event associated with the acceptance button 2710, the terms and conditions 2705 may be treated as accepted for the mobile device session, or for all mobile device sessions with the same user.

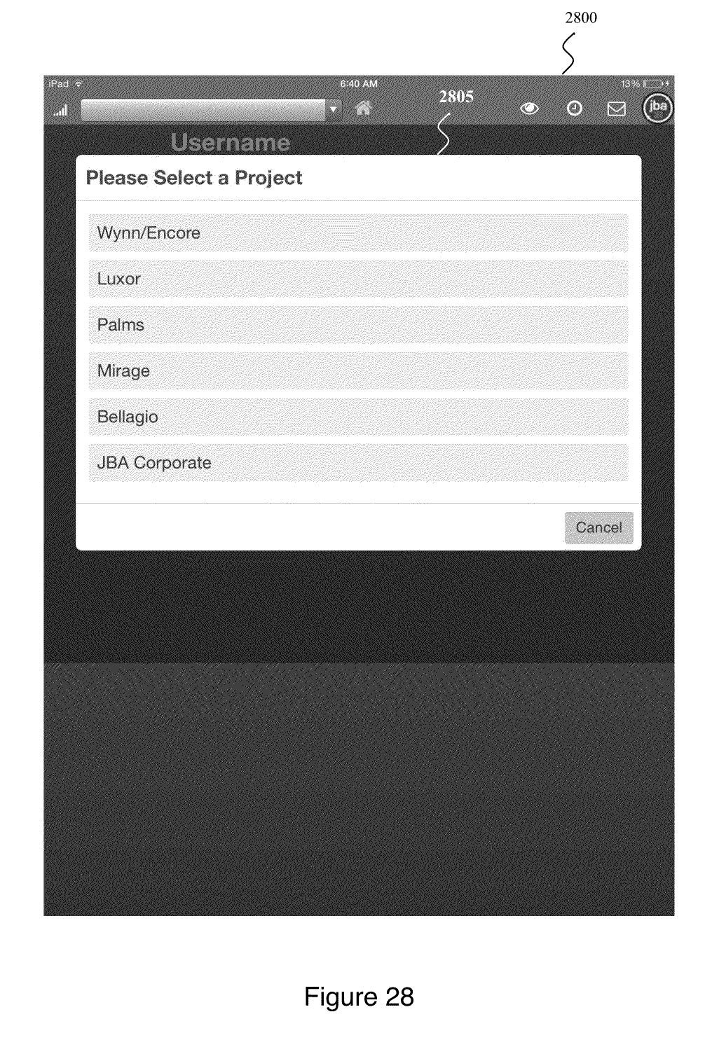

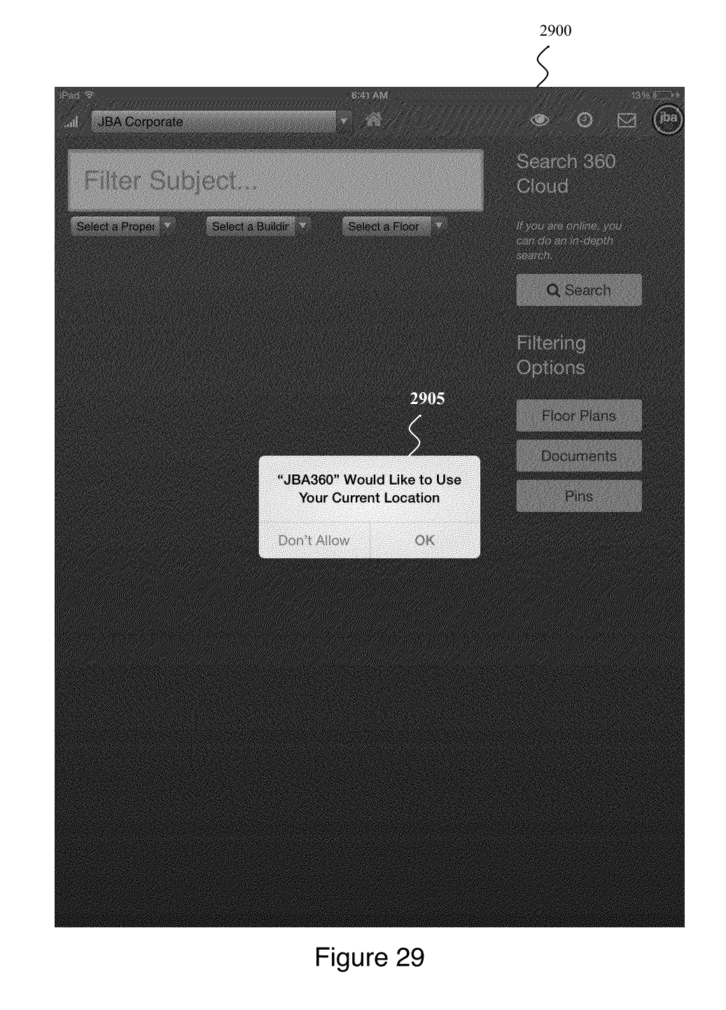

Referring now to FIG. 28, upon acceptance of the terms and conditions, the view engine 550 displays a project selection menu 2805 including one or more project selection items. Once a selection is detected, the location engine directs the view engine to display a location access confirmation prompt that, if confirmed, allows the native mobile app 374 access to and use of the mobile device 114, 116 location services. This access and use can facilitate obtaining the current and future locations of the device, and enhance the use of project-specific maps.

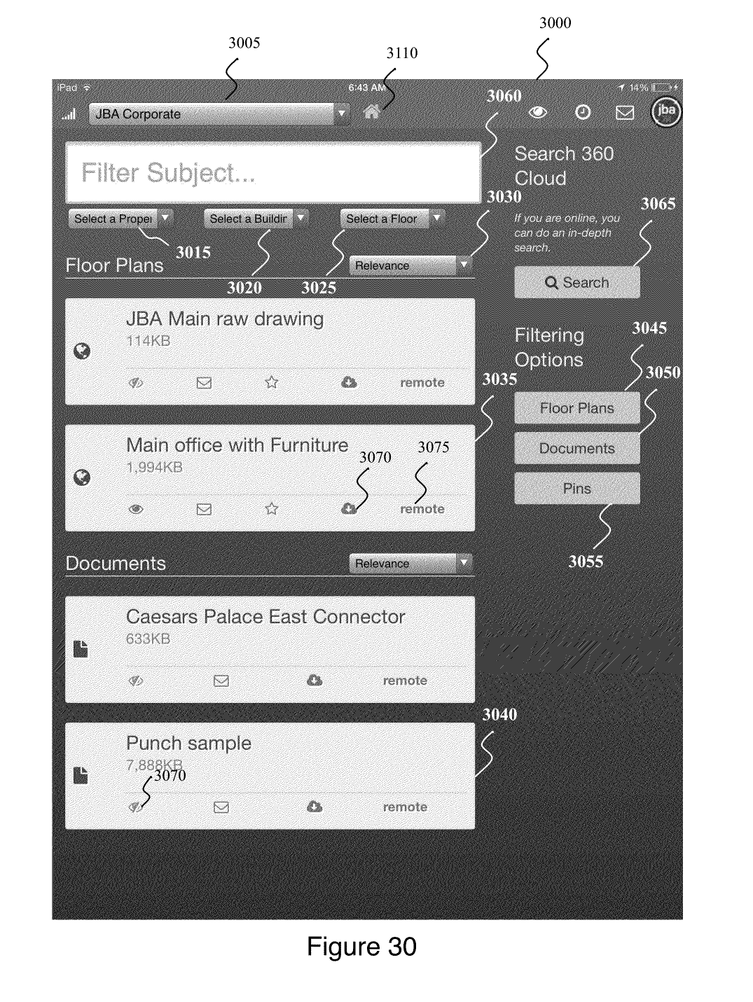

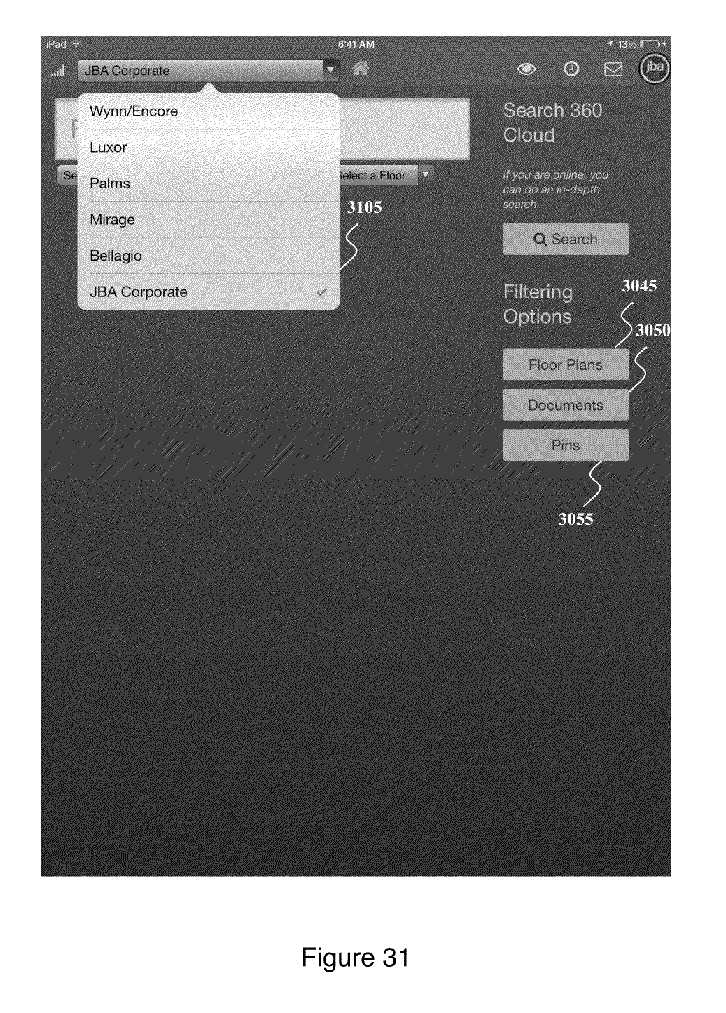

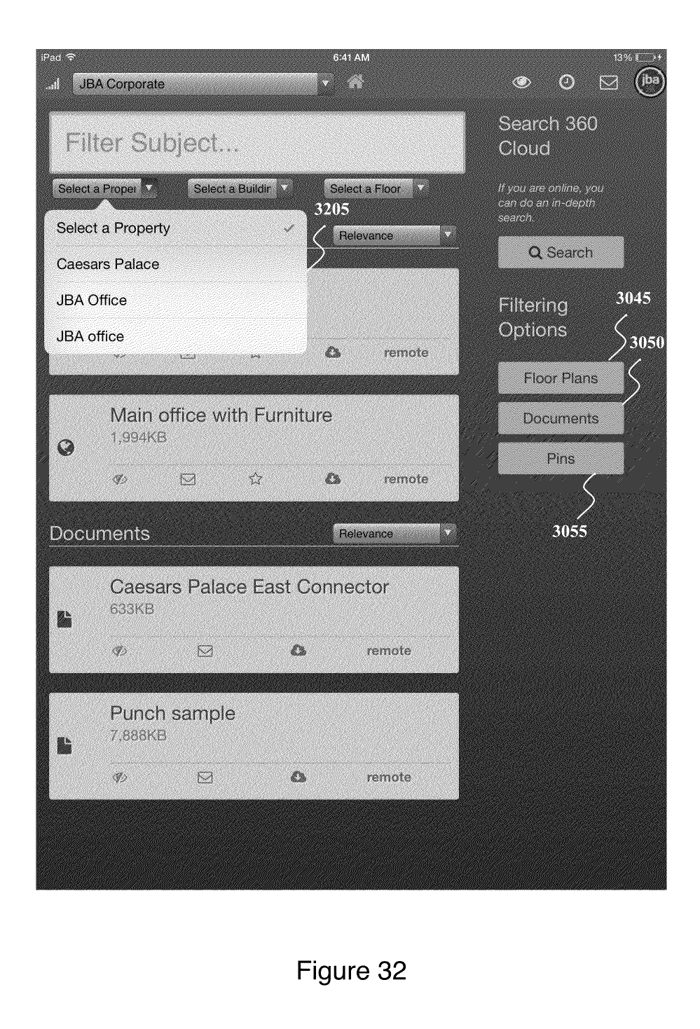

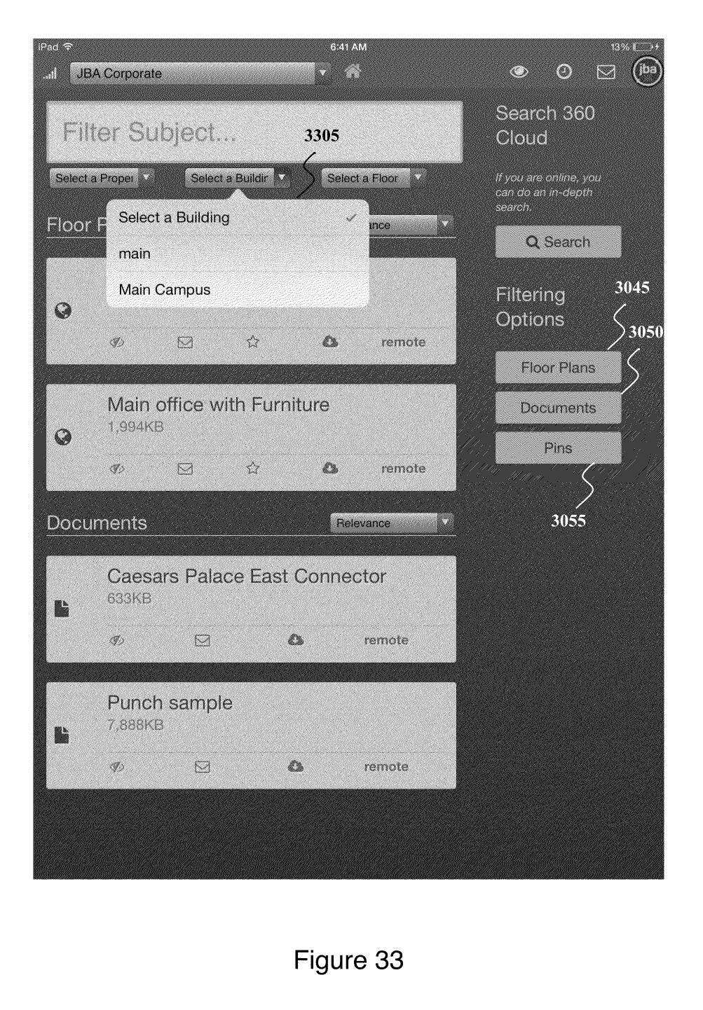

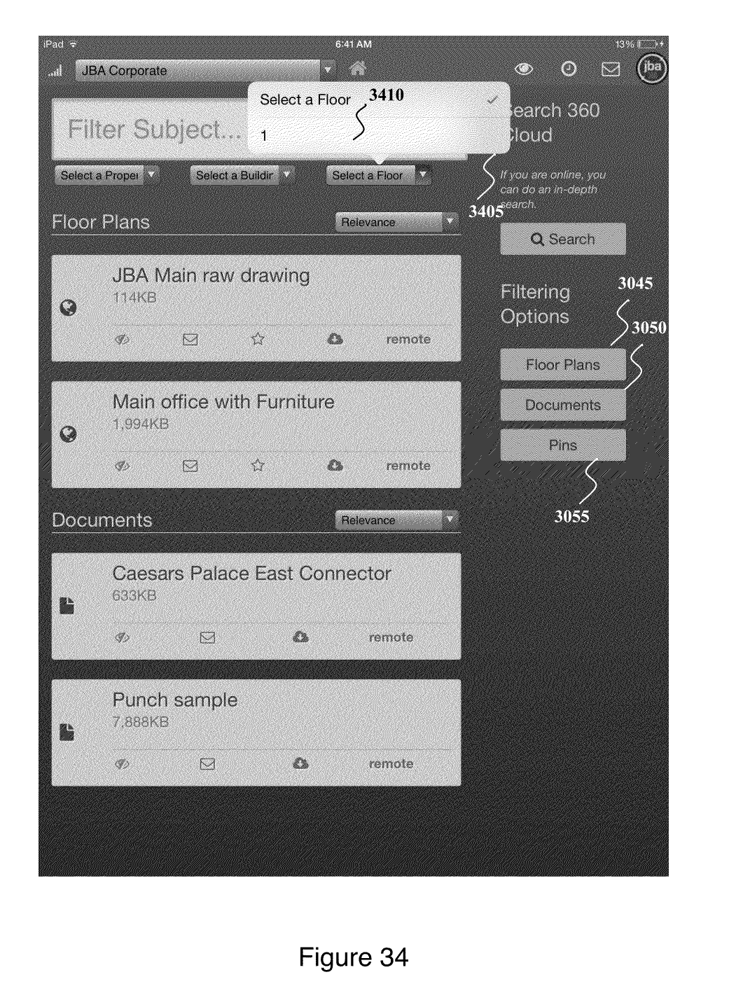

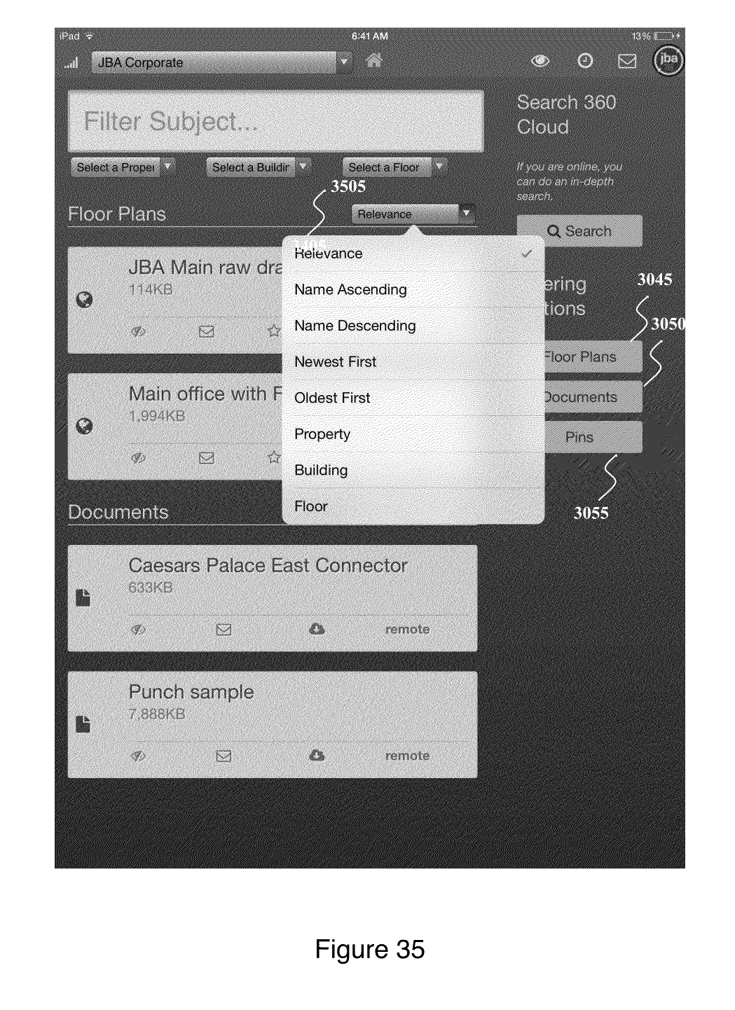

Referring now to FIG. 30 through FIG. 36, in this example, the JBA Corporate project is selected 3005. The project can be changed through the selection of a different project in the project selection menu 3105. In some embodiments, multiple users access the mobile information management system services 378 (see, e.g., FIG. 3), and each project can be protected, allowing access to only users authorized by a customer administrator, with such authorization provided as a function of the authentication process. Where visible and enabled, the detection of the selection event associated with the green home icon 3110 displays the main view 30.

In some instances, one or more project filter selection menu drop list controls and corresponding project filter selection menus can be accessed from the main view 30, such, in this example, a property filter 3015, 3205, a building filter 3020, 3305, and a floor filter 3025, 3405. Menus can be populated based, at least in part, on the uploaded floor plans and the project information provided.

In some implementations, these filter selection menus 3205, 3305, 3405 can be hierarchical. Once a property is selected, the buildings filter selection menu 3305 can be populated in part based on data stored in one or more data tables in the mobile information management system database 136. Further, once a building is selected, the floor filter selection menu 3405 can also be populated in part based on data stored in one or more data tables in the mobile information management system database 136.

For example, if the property and building assets in the Assets table 405 (see, e.g., FIG. 4A) corresponding to the selected property and building menu items include a value for the FloorName field, the FloorName fields can be ordered and displayed as floor filter selection menu 3410 items, thus filtering the number of applicable Asset table 4A records available. In some implementations, the filter results, such as floor plans 3035, documents 3040, and pins, can be sorted based at least in part on the selection of a sort option menu item available in a sort selection menu 3505. Selection can include, for example, relevance, alphabetical order, date modified, other such properties of the associated type of information, thus preferentially organizing the information for the user. When a document is uploaded to the system, information about the document can be submitted relating to the building, floor, property, and the like. The mobile device app 374 can then sort the file and information based on that entered information.

In some cases, the visibility of one or more filtered categories can be toggled by alternating selection of view toggle buttons, such as a floor plans view toggle button 3045, a documents view toggle button 3050, and a pins view toggle button 3055. In this example, all filtering options 3045, 3050, 3055 are green, which indicates that none of the filtering options are selected, resulting in the display of all floor plans and documents in the filtered set.

In certain embodiments where access to location services is enabled, floor plans within a defined range of the current device location are displayed in a nearby floor plans view 3600. For example, the view engine can display floor plans within 20 feet of given x,y map coordinates converted from a standard geospatial coordinate system, such as the world coordinate system, based on floor plan lists cached on the mobile device, floor plan lists received from the mobile information system servers 124, or both. This can reduce the amount of time a user invests accessing relevant information of interest by automatically retrieving documents, floor plans, and pins near the user's location.

In some implementations, dropped registration pins manually identify fixed points for use in determining the location of the mobile computing device 114, 116. By using multiple drop pins, the location engine can automatically determine the position of the mobile computing device 114, 116, for example, by triangulating multiple x,y coordinates. Alternatively, a GPS-only option can determine a location and associated with fixed geospatial coordinates associated with a map. Floor plans within a defined range of the mobile computing device can then be displayed 3600.

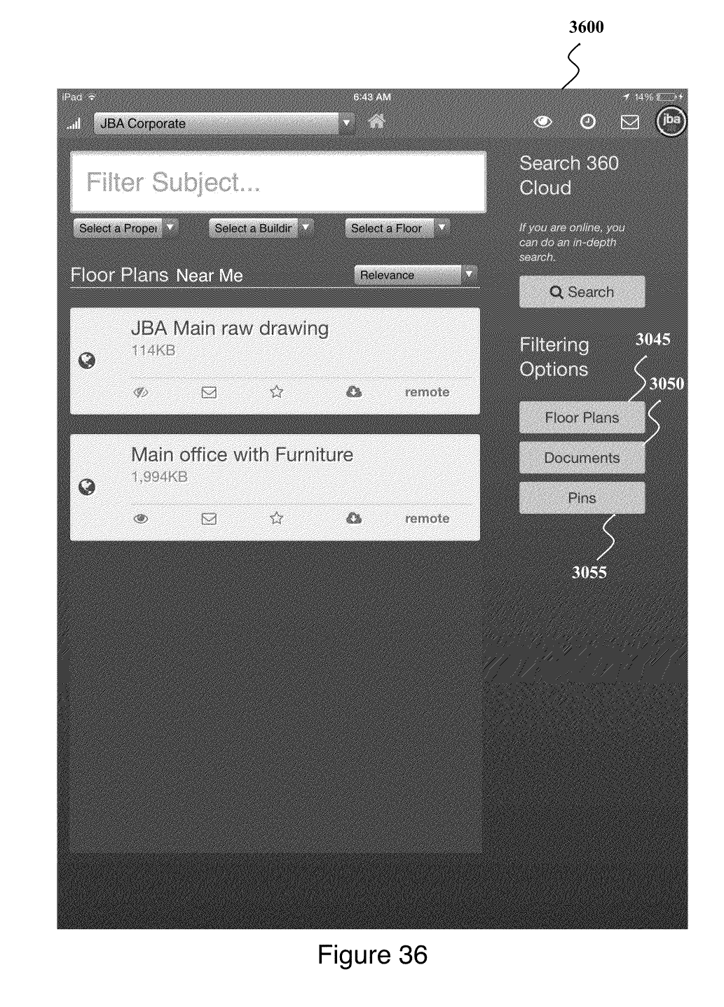

Referring now to FIG. 36, toggling of the documents view toggle button 3050, and the pins view toggle button 3055, results in both buttons 3050, 3055 changing color, in this case to the color white, and leaving only floor plans as viewable, thus reducing the number of items available and potentially limiting them to the items of most interest, facilitating faster identification, selection, and retrieval of items. Further, in certain implementations, toggling off of the floor plans view toggle button 3045, the documents view toggle button 3050, and the pins view toggle button 3055, directs the mobile device app 374 to display nearby floor plans view 3600.

Referring again to FIG. 30, a filter subject edit control 3060 can receive text string entry for use in limiting the viewable floor plans, documents, and pins to only those containing the string. This filter subject edit control 3060 can receive words, such as a floor plan name, document name, or pin name further narrowing the information displayed. In part, to facilitate the search and filtering capability, the OCR service 388 can automatically performs optical character recognition (“OCR”) on files added to the system, and stores the associated OCR information with the appropriate file. The indexing service 389, can then use the OCR content to index the files and provide full text search capability to the search service 384. For example, if a particular building is selected in the building filter 3020, the text string “air conditioning” could be entered in filter subject edit control 3060 which would then retrieve information for the building and project having an identification, text content, or markup content containing the text string “air conditioning.”

Yet another option for filtering display information is the executing a search through the search view (not shown) displayed in response to detection of the click event associated with the search control 3065. Similar to the filter subject edit control 3060, the search view receives words or identifier from edit controls, then conducts a search for information including the search string or strings entered by the user. For example, if the recently entered notes relating to a pool worked on by a user could be searched for by searching on the text string “pool,” narrowing the amount of information to be accessed and navigated in an effort obtain the desired notes, documents, pictures, etc., stored in the mobile information management system. Similar to the main view 3000, the search view may also include controls for narrowing selection items, including a property filter 3015, 3205, a building filter 3020, 3305, and a floor filter 3025, 3405. In some instances, an advanced search on parameterized search data such as the date the information or pin was created, the date it was modified, or other categorizations.

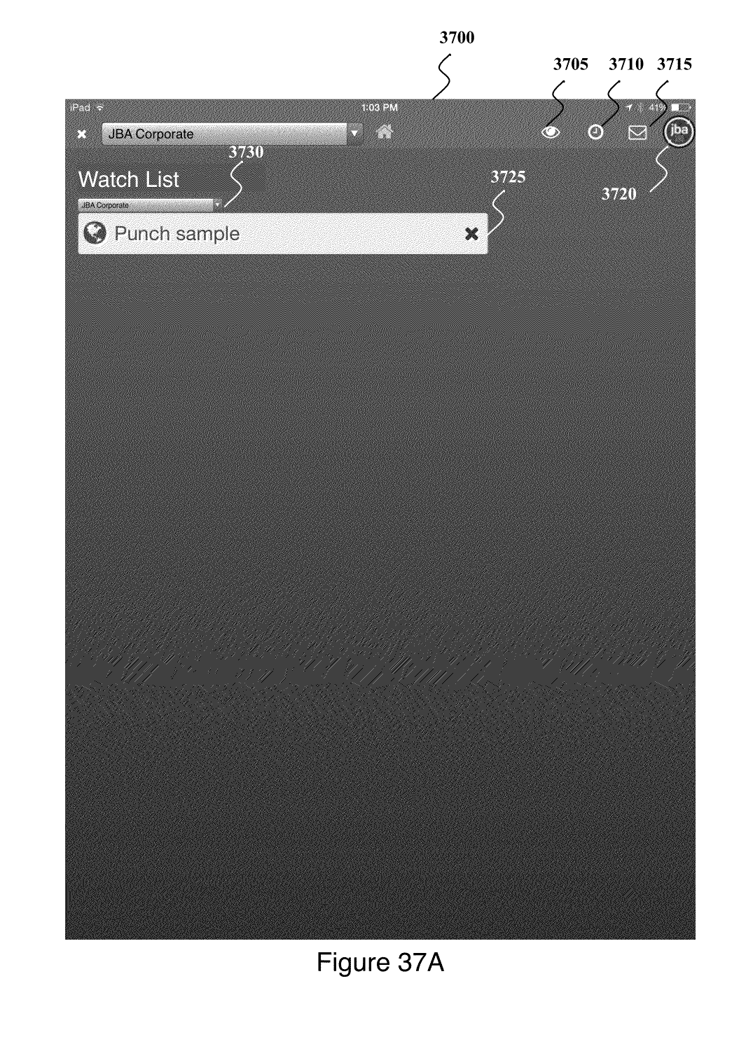

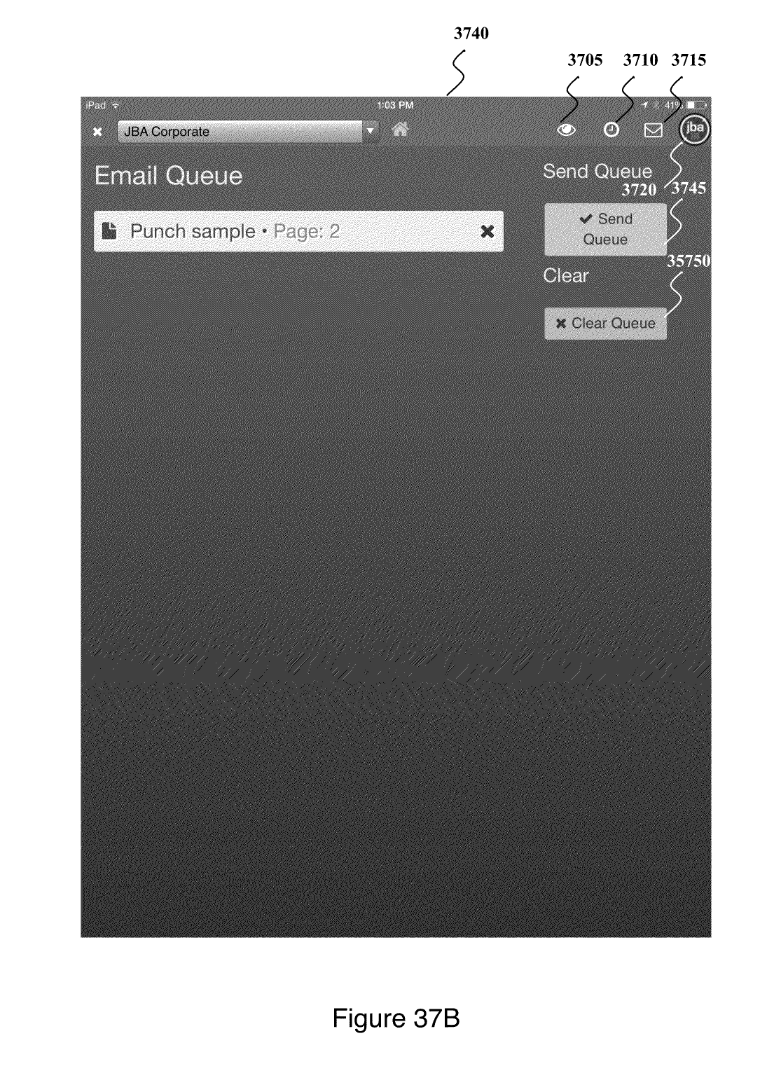

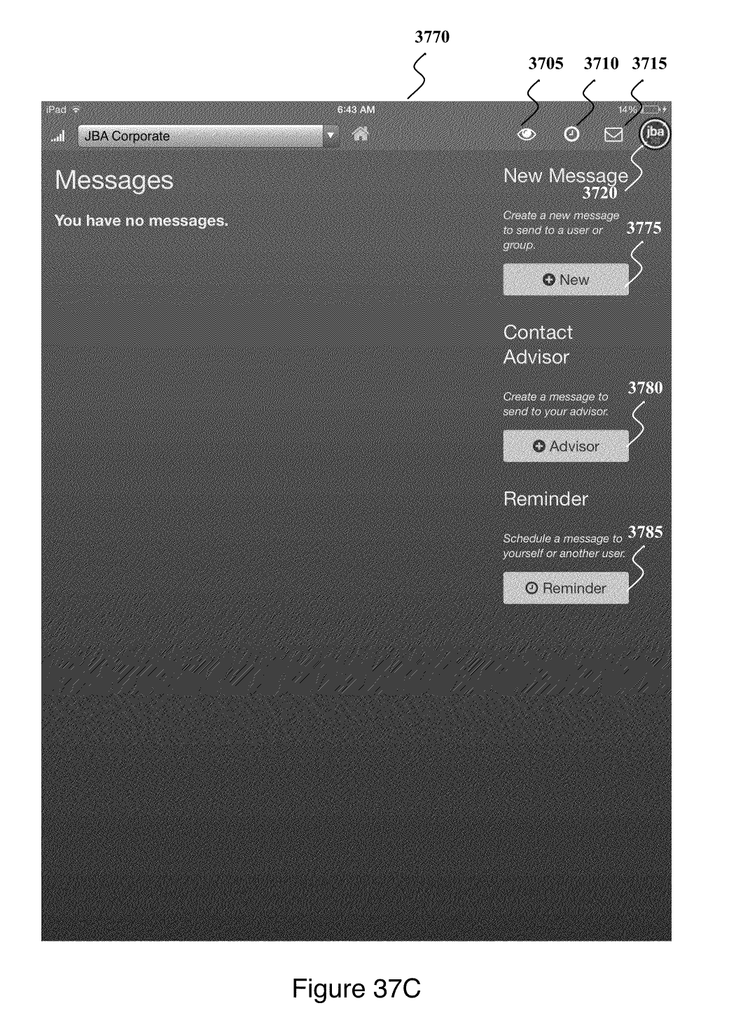

Referring now to FIG. 37A, various views displayed by the native mobile app in the app include four selectable button icons 3705, 3710, 3715, 3715. Detection of the selection event associated with the eye button icon 3705 displays a watch list view 3700. The watch list view 3700 displays a list of items 3725 previously identified as watch items. Selection of the corresponding eye button icon 3078 associated with an information item on a list view, such as the unfiltered main view 3000 of FIG. 30, automatically adds that associated information item to the user's watch list. A watch list item 3725 may be removed from a watch list by clicking the “x” next to the item 3725. In some embodiments, multiple watch lists can be accessed by selection a watch list selection item accessed from the “My WatchList” drop down button 3730. Upon detection of a change to an information item, the notification service 387 (see, e.g., FIG. 3) automatically broadcasts notifications to the native mobile app 374 on one or more mobile computing devices 114, 116, indicating there are changes to specific items 3725 of information in the watch list, or information items locally stored on the mobile computing devices 114, 116.

Referring now to FIG. 37B, detection of the selection event associated with the email button icon 3715 displays the email queue view 3740, which displays a list of emails composed by the user for transmission but have not yet been sent. This can occur, for example, due to the absence of an active network connection. This example email queue view 3740 indicates there is one unsent email in the queue. In some implementations, attempted resends can be initiated by selection of the send queue button 3745. In addition or alternatively, queued emails resends can be initiated automatically by the native mobile app 374 upon detection by the app 374 of an active network connection. The queue can be cleared by selection of the clear queue button 3750.

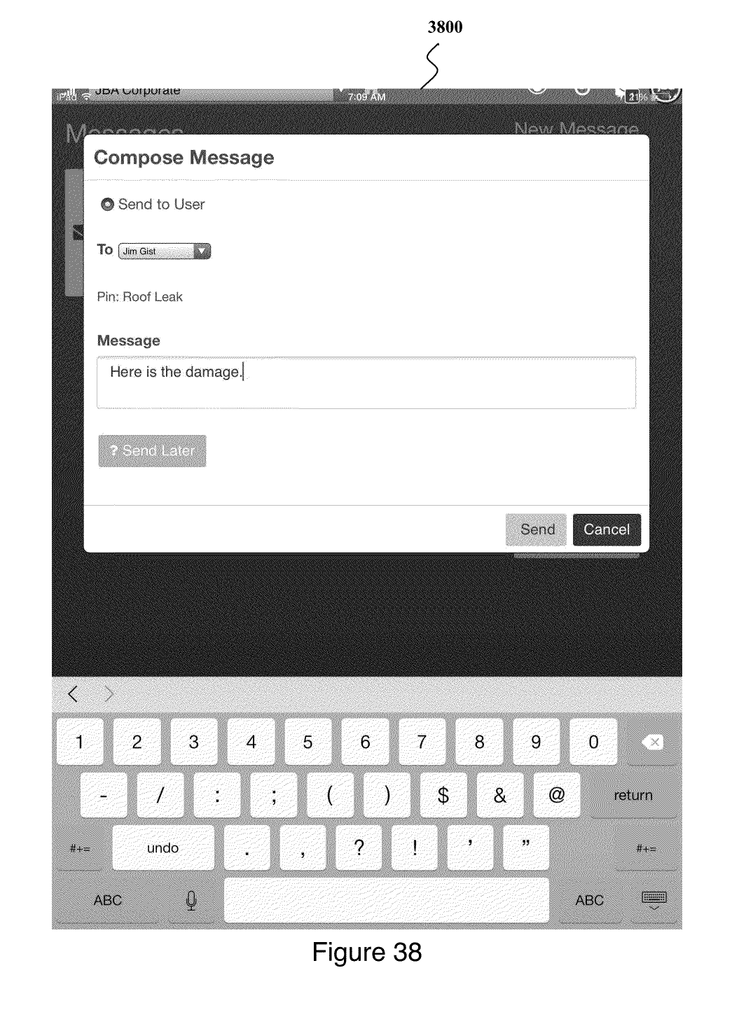

Referring now to FIG. 37C, detection of the selection event associated with the clock button icon 3710 displays the message view 3770, which displays messages received from one or both of users or administrators, or automatically generated by the mobile information management system, and transmitted by the notification service 387 (see, e.g., FIG. 3). Detection of the selection event associated with the new button 3775 displays the compose message view 3800 of FIG. 38 for the creation, queuing, and sending of messages. In some embodiments, a date control 3905 and a time control 3910 can be displayed in a compose message view 3900 for scheduling the sending of messages at a future time. Sent messages will appear in the recipient's message view 4000. In some instances, a message is stored in a messaging queue for transmission at the configured transmission time. In addition or alternatively, records can be created in the Events table 490 and EventDetails table 495 (see, e.g., FIGS. 4R and 4S) for the EventType corresponding to a message, and these records can be queried by the notification service on a scheduled basis and retrieved for sending when the associated configured transmission time has passed.

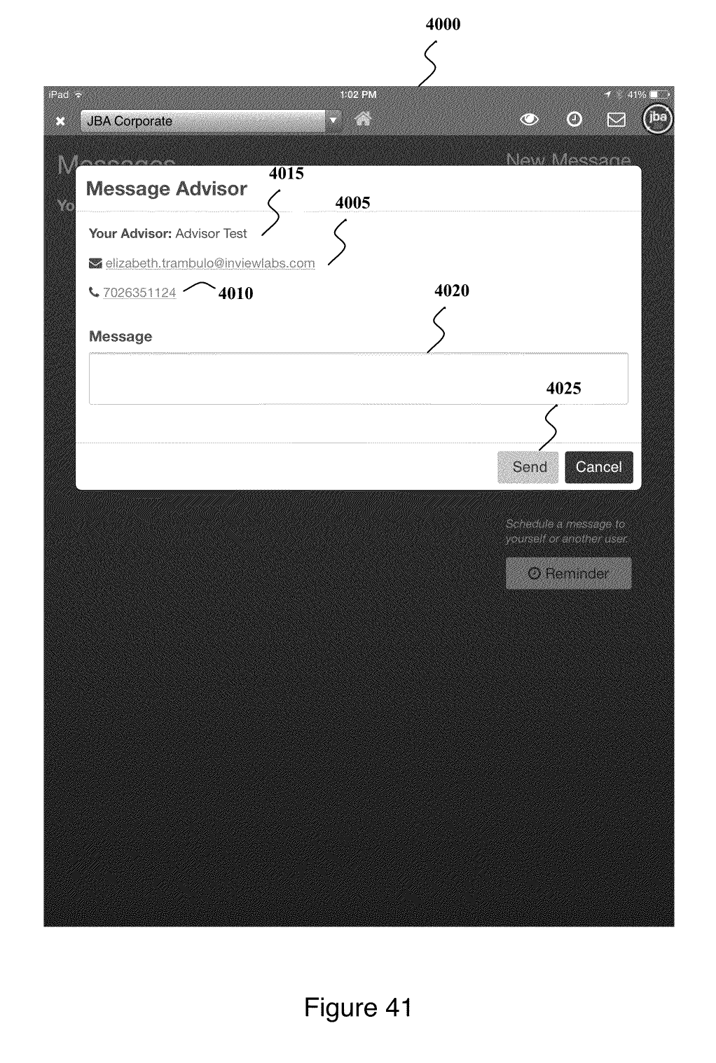

Referring again to FIG. 37C, detection of the selection event associated with the advisor button 3780 displays the message advisor view 4100 of FIG. 41 for in-system and out-of-system communication with an advisor. In some instances, the contact information for a pre-configured advisor 4015 for the login user system is displayed, including, for example, the advisor's mail address 4005 and phone number 4010. An in-system message can be sent to the advisor upon the entering of a message in the message edit control 4020 and clicking the send button 4025. In addition or alternatively, where the mobile device has cellular service, and is so enabled, the user can click on the phone number 4010 and a call to the advisor will be initialized automatically. Similarly, clicking on the email address may automatically initialize the native email interface for the mobile computing device 114, 116.

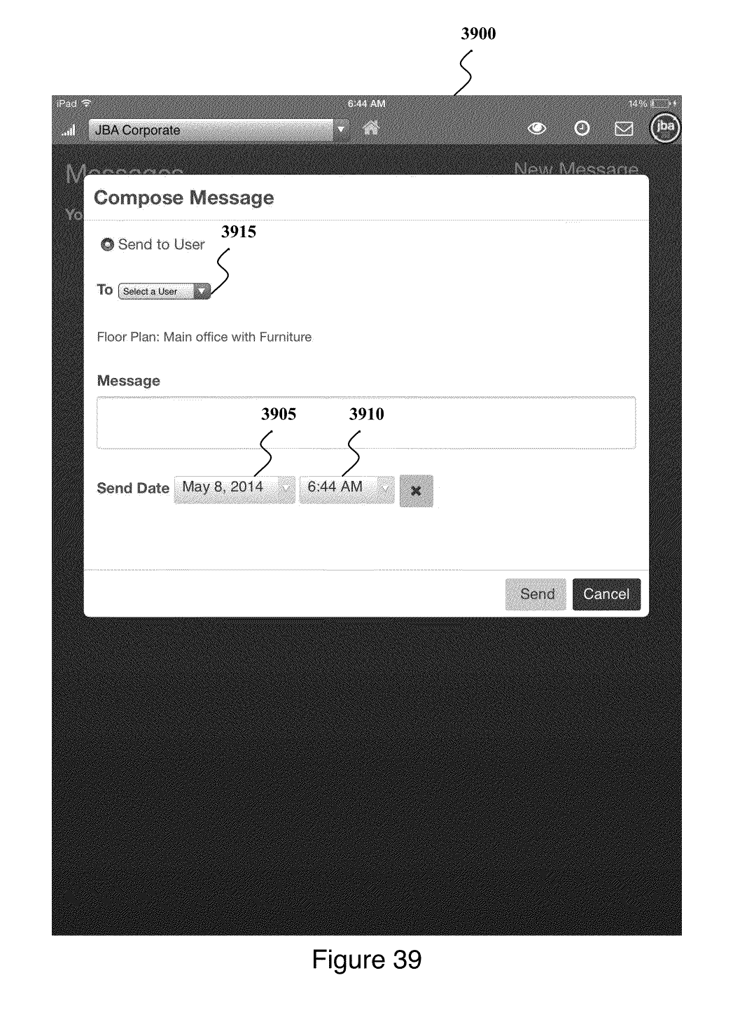

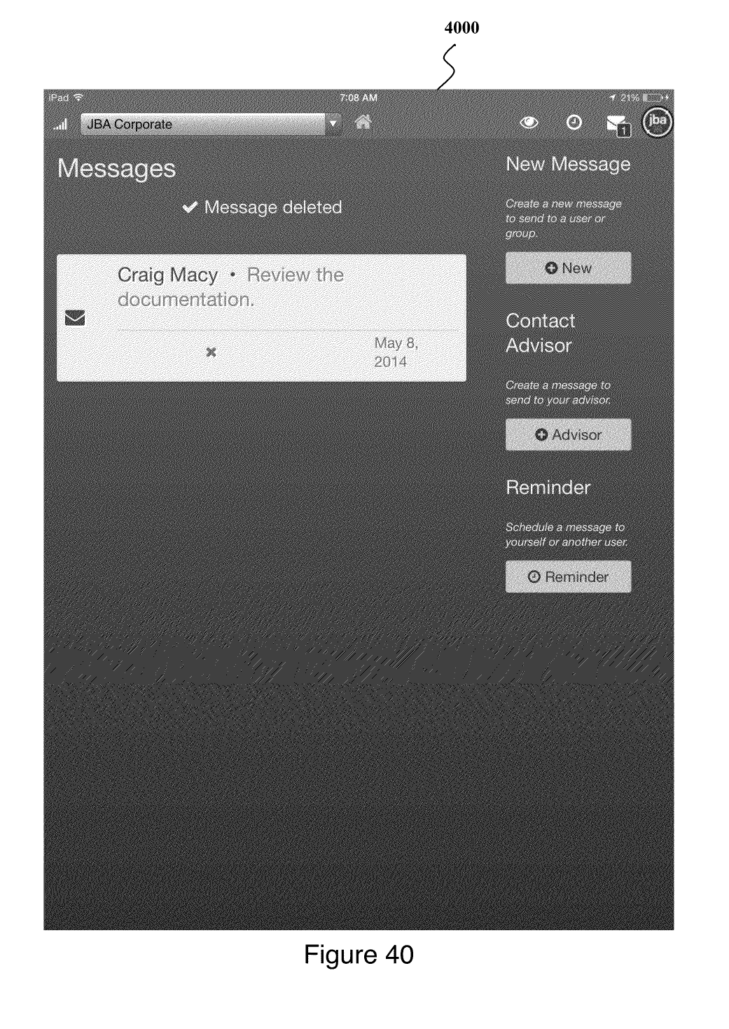

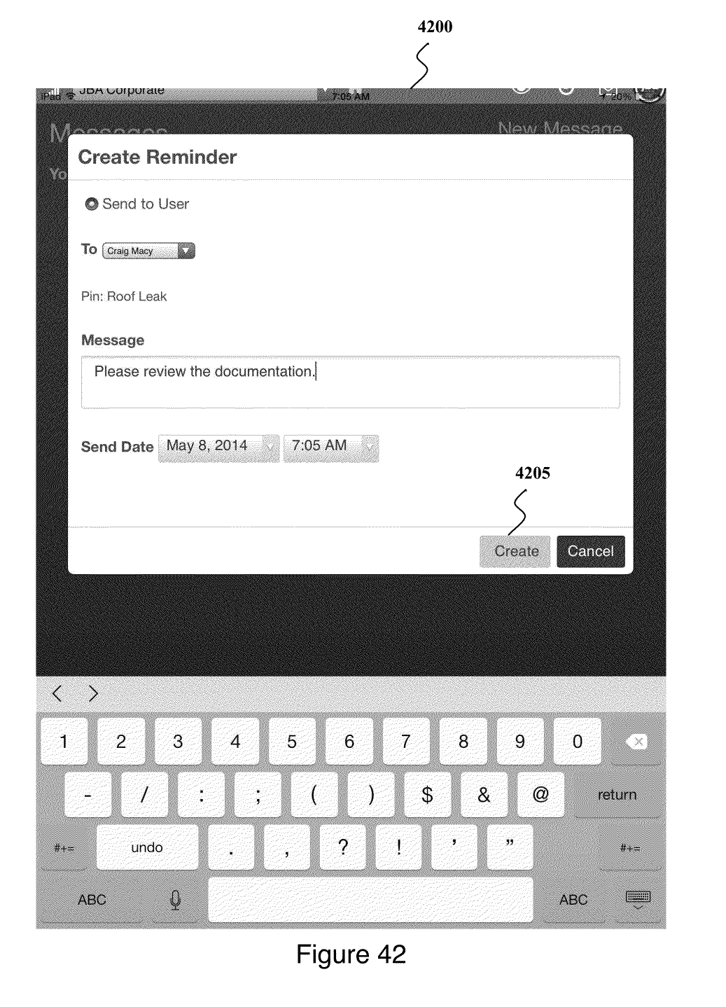

Referring now to FIG. 42, detection of the selection event associated with the reminder button 3785 (see, e.g., FIG. 37) displays the create reminder view 4200 for in-system creation of reminders. Reminders can be prepared, scheduled, and sent in a manner similar to the preparation of messages as described for the compose message view 3900 (see, e.g., FIG. 39). Upon detection of the selection event associated with the create button 4205, a reminder message is sent to the notification service 387 (see, e.g., FIG. 3), which schedules a message. In some instances, a message is stored in a messaging queue for transmission at the configured transmission time. In addition or alternatively, records can be created in the Events table 490 and EventDetails table 495 (see, e.g., FIGS. 4R and 4S) for the EventType corresponding to a reminder message, which can be queried by the notification service on a scheduled basis and retrieved for sending when the associated configured transmission time has passed.

Referring again to FIG. 30, information items such as documents and floor plans not yet stored locally on the mobile computing device 114, 116 include a remote indicator message 3075 indicating that the information item is stored remotely on the mobile information management system servers 124. Selection of a download button icon 3070 can initiate a request to the document management service 381 (see, e.g., FIG. 3) to transmit the associated information item to the mobile computing device 114, 116.

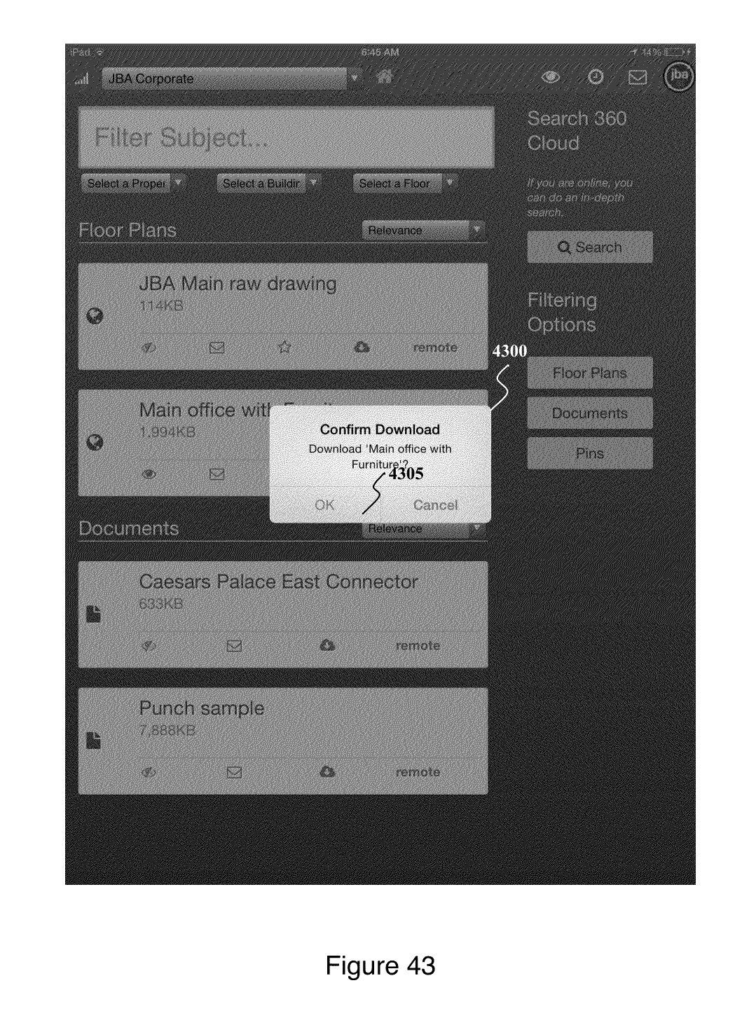

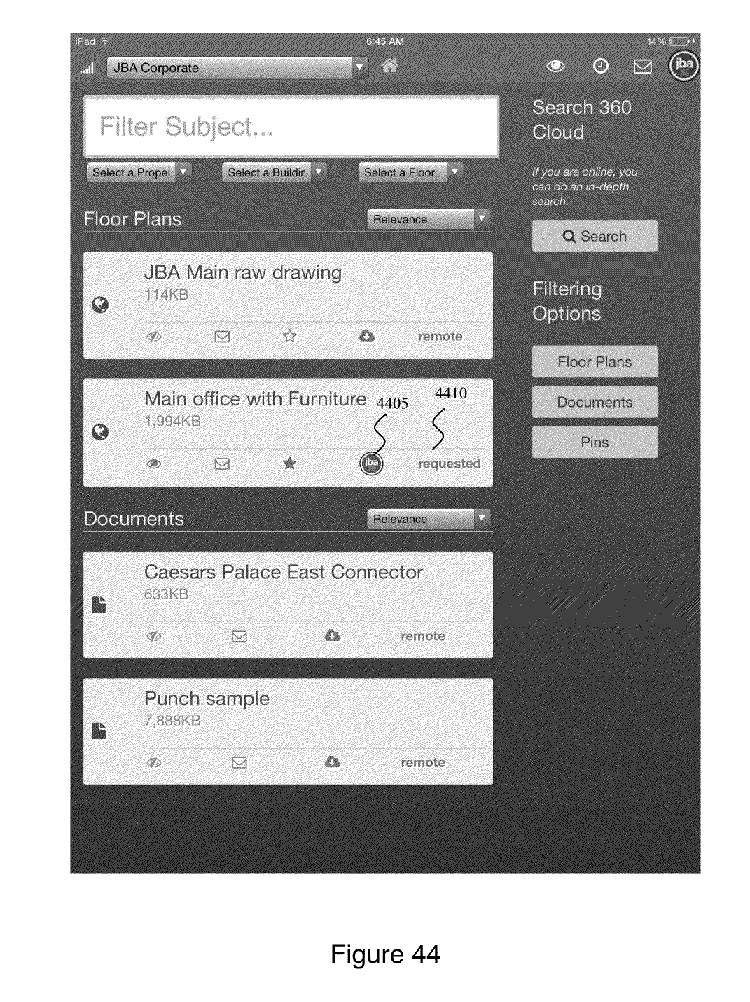

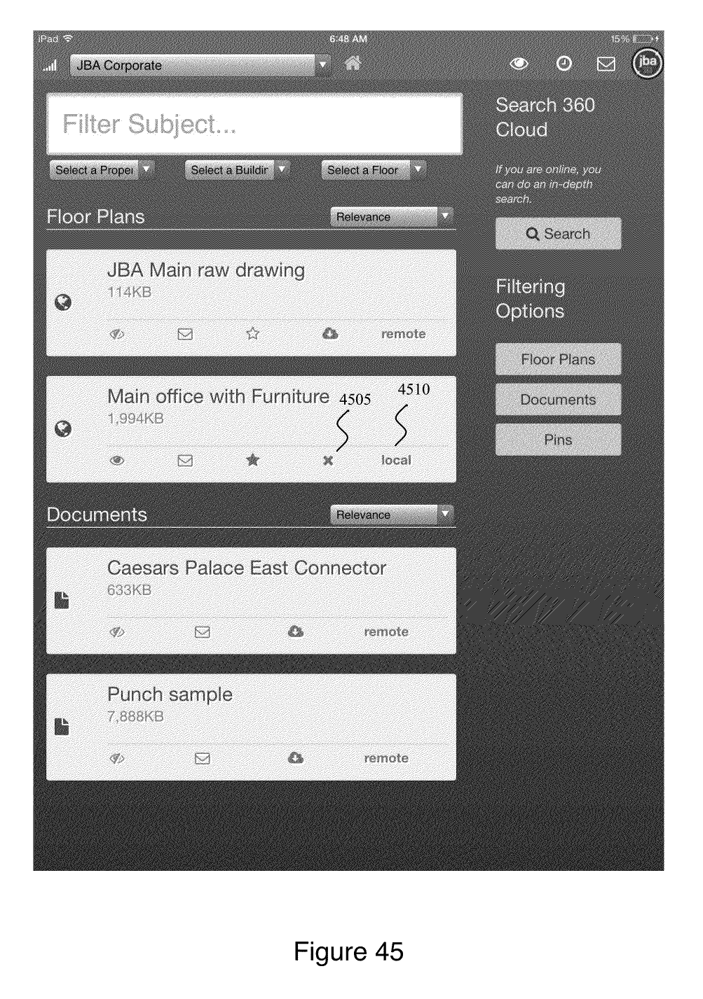

Referring now to FIGS. 43 through 45, before transmitting the request to the document management service 381, the native mobile app 374 can display a download confirmation prompt 4300 requesting confirmation. Upon detection of selection of the OK button 4305 associated with the download confirmation prompt 4300, a request is transmitted to the document management service 381, the download button icon is replaced with a non-interactive, in-process icon 4405, and the indicator message is changed to a requested indicator message 4410. Once the download is complete, the in-process icon 4405 is replaced with a delete icon 4405 and the indicator message is changed to a local indicator message 4510. In some embodiments, when the user is connected to the network, the native mobile app sends the locally revised and stored information items to the document management service, which stores the new version of the information item on the mobile information management server 124. The synchronization service 383 automatically detects the additional content, changed content, or both. The notification service 387 can transmit appropriate update notifications to mobile devices with local copies of the updated information item, and the document management service can automatically transmit the updated document to connected mobile devices with local copies of the updated information item, or both.

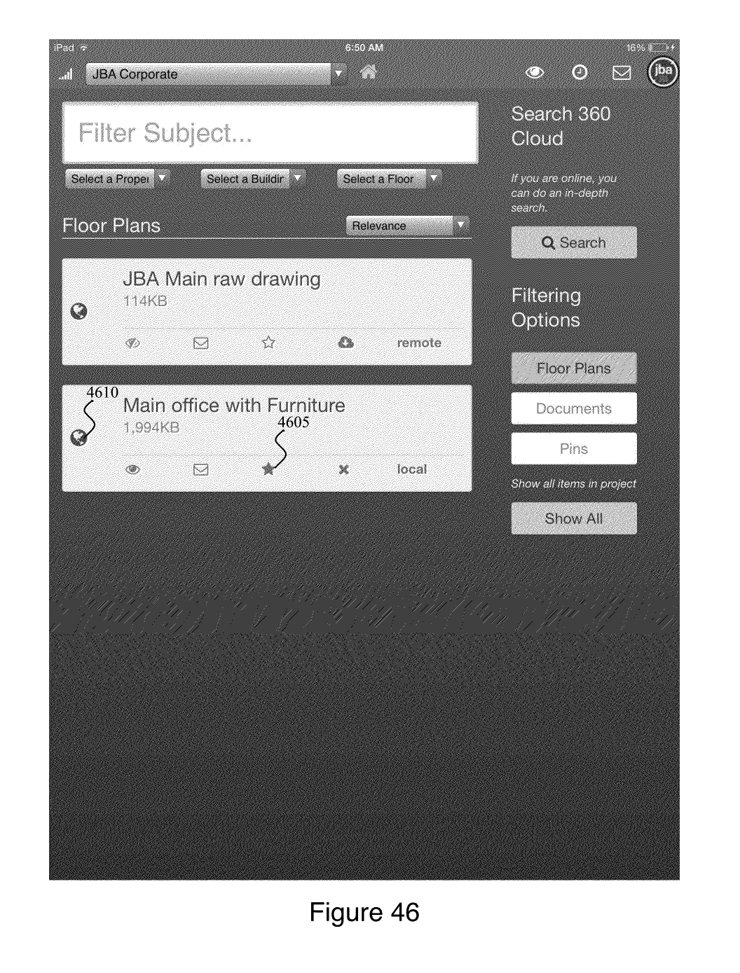

Referring now to FIG. 46, information items can further include a star button icon 4605, which can toggle the information item favorite designation, identifying the item for display automatically at login. This may be useful if, for example, the same item, such as a floor plan, is being used repeatedly. In some embodiments, only one information item for a particular type of information asset, such as a floor plan, can be toggled as a favorite at any one time. Selection of another information item for that type will then toggle the previously-selected favorite to a non-favorite designation.

Certain instances implement a versioning scheme for one or more of files, documents, maps, or pins. Versioning information, such as a numeric value indicative of a version ordering, can be stored in on or more data tables. For example, a version field can be included in the Assets table 405 for maintaining a version history for files, documents, images, and pin attachments. Similarly, the MobileDeviceAssets table 410 can maintain a version value for records representing assets stored locally on the mobile computing device 114, 116. In some instances, a new record is created for each version so that a version history is persistently maintained. In an alternative embodiment, existing table records are updated upon the occurrence of an upload of a new version by incrementing the version number and applicable date fields. In some embodiments, the version value is determined and set by the document management service 381 (see, e.g., FIG. 3). The synchronization service 383 can use version information as part of conflict detection services and related conflict resolution services.

In some embodiments, one or more types of information items are designated as types of maps, for example, floor plans. Maps, in some cases consisting of one or more files, may be treated differently than files designated as documents by the various components of the mobile information management system 100. Detection of the selection event associated with the open item button icon 4610 opens the associated information item.

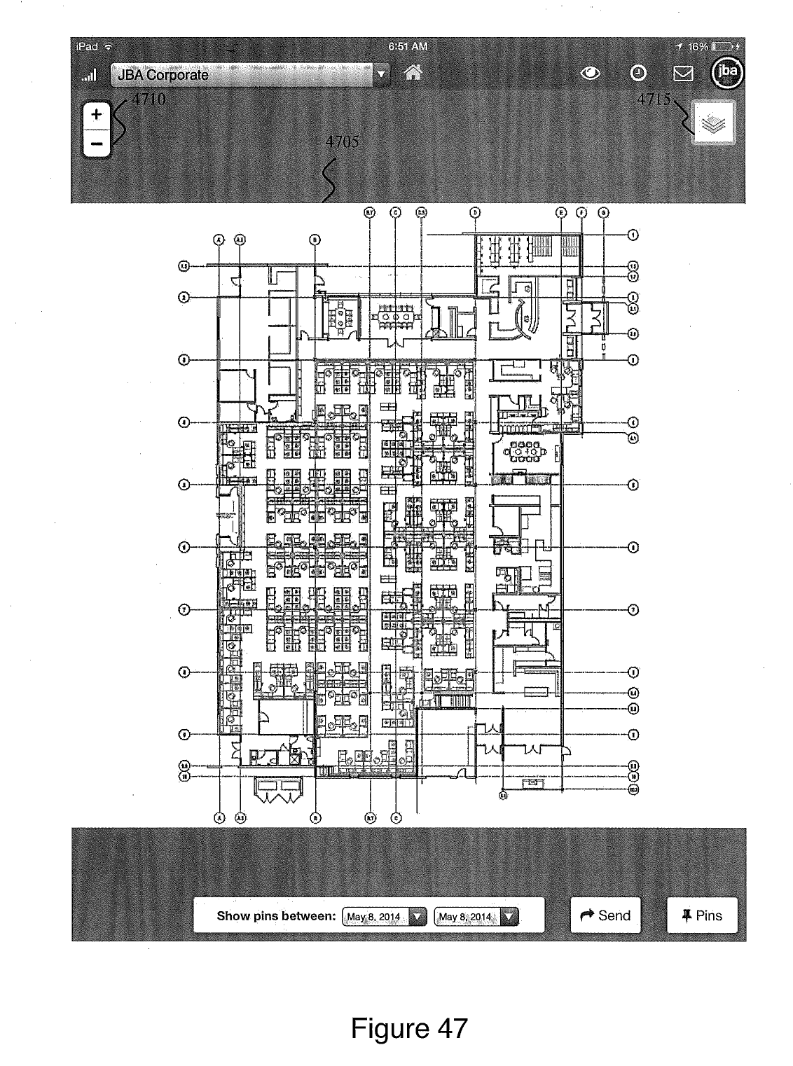

Referring now to FIG. 47, a floor plan display view displays the selected floor plan. The displayed floor plan 4705 can be zoomed in and out by, for example, pinch zooming (i.e., moving two fingers on the screen away or toward one-another), selection of the zoom control 4710, or both.

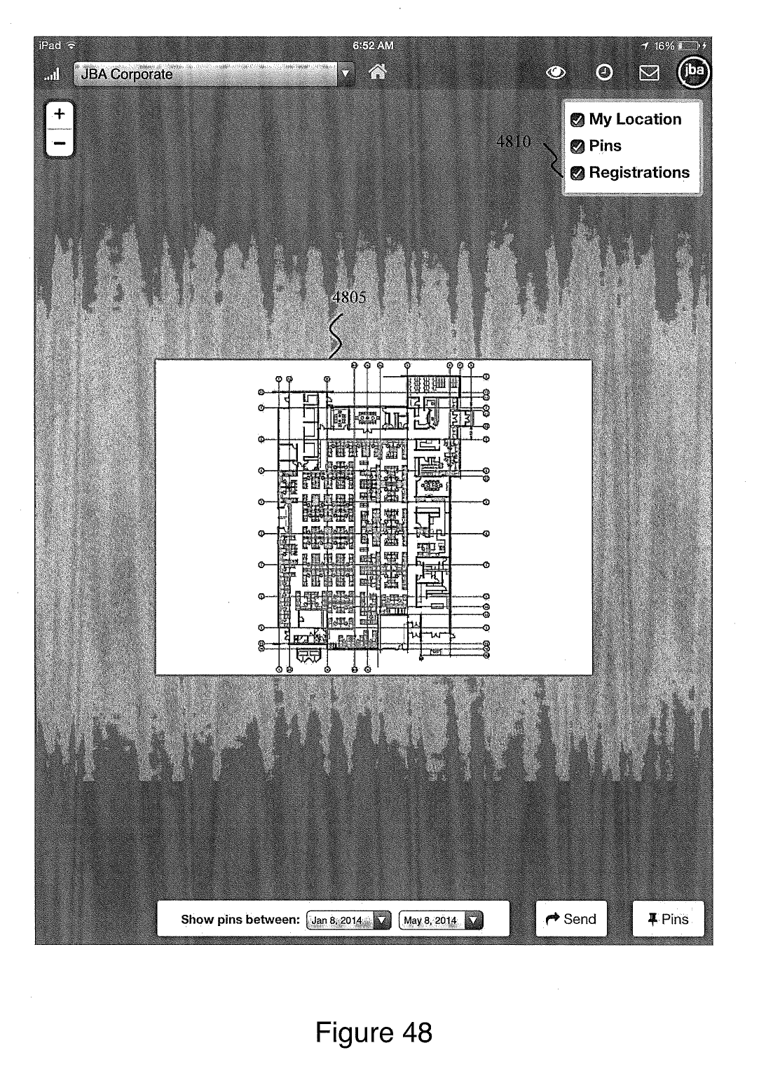

Referring now to FIG. 48, the displayed floor plan may be zoomed out. Detection of the selection event associated with the display options control 4715 displays the view options menu 4810, which includes checkbox selectable items that, when selected through the applicable checkbox, are selected for display on the displayed map 4805. These options can include, for example, the current location of the device, previously-placed information pins, and previously-placed registration pins.

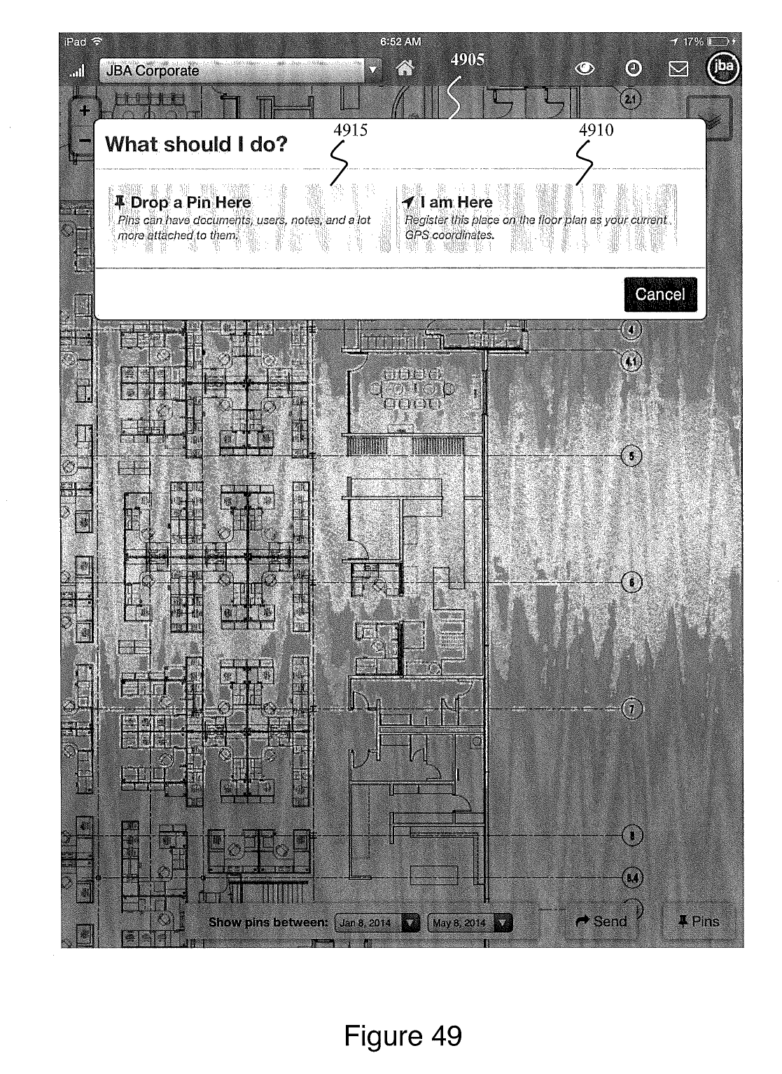

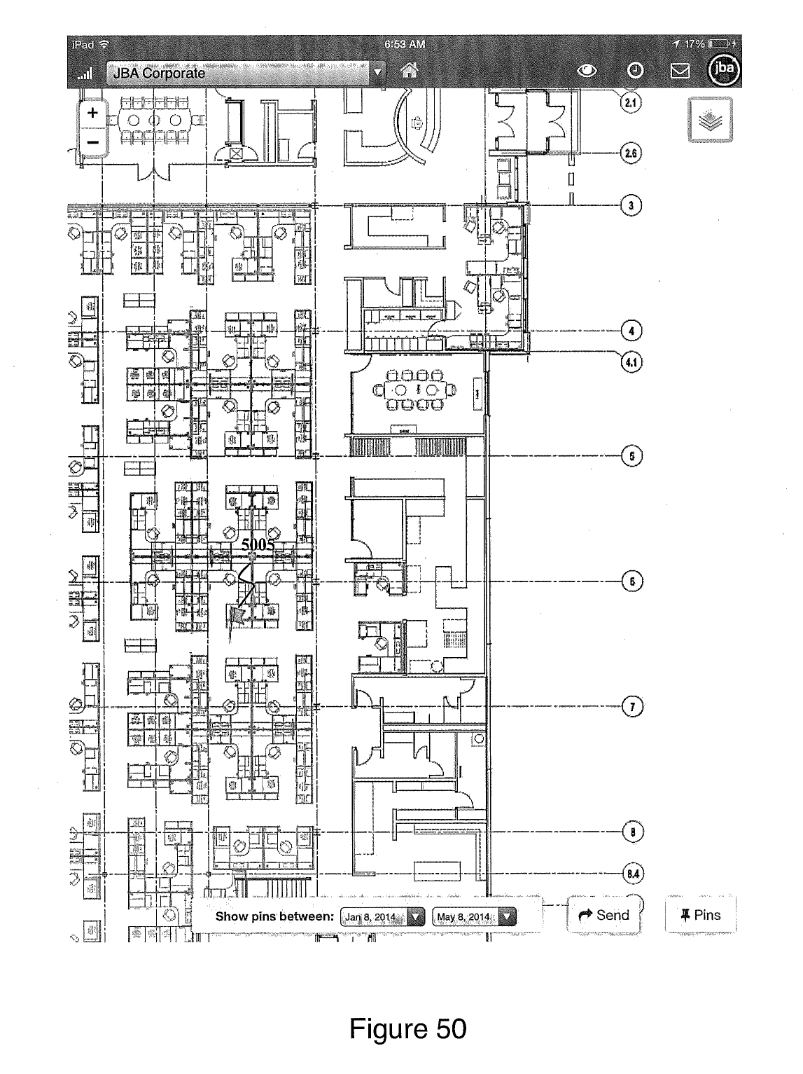

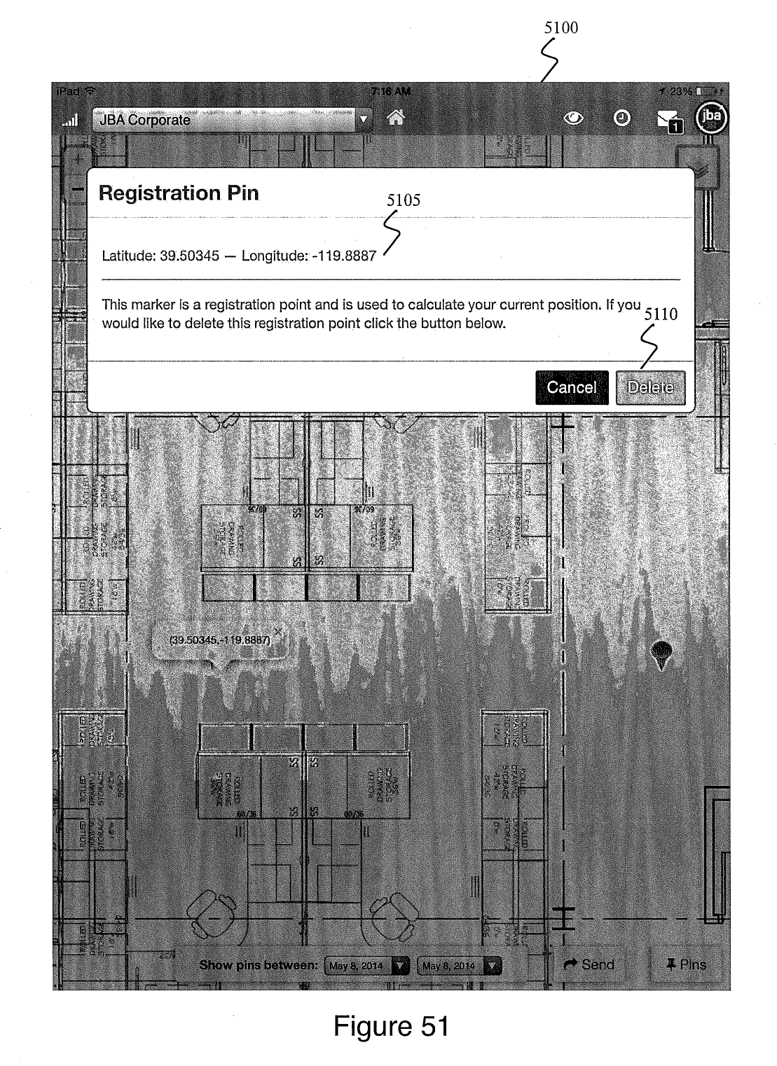

Referring now to FIGS. 49 and 50, detection of a selection event associated with a particular location on the map, such as an extended touch event, displays the pin selection floor plan display menu 4805. Selection of the “I am Here” button 4910 directs the pin engine display 520 (see, e.g., FIG. 5) to place a registration pin at the location of the touch event, which includes the current geospatial coordinates of the mobile computing device, such as GPS coordinates. The registration pin can be displayed on the map graphically, for example, as a flag 5005. Placement on the map can include converting the geospatial coordinates to map coordinates. These map coordinates can be stored with the registration pin. Detection of the selection event associated with the registration pin displays the registration pin information view 5100 that displays the geospatial coordinates of the pin 5105, and displays a control for deleting the pin 5110.

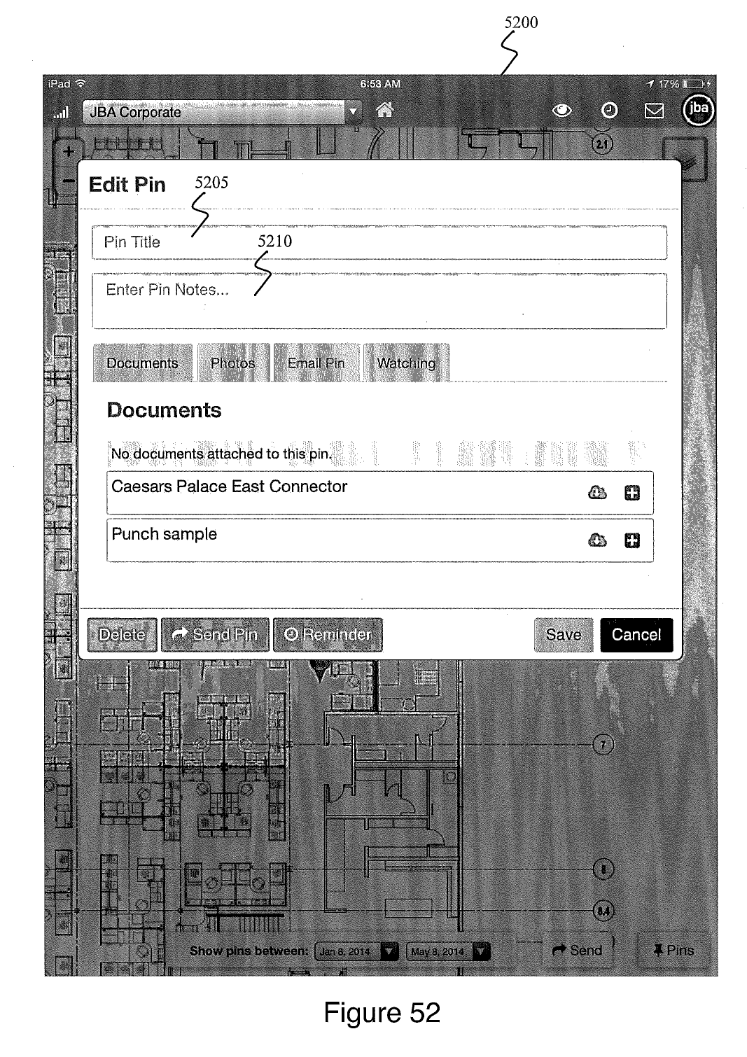

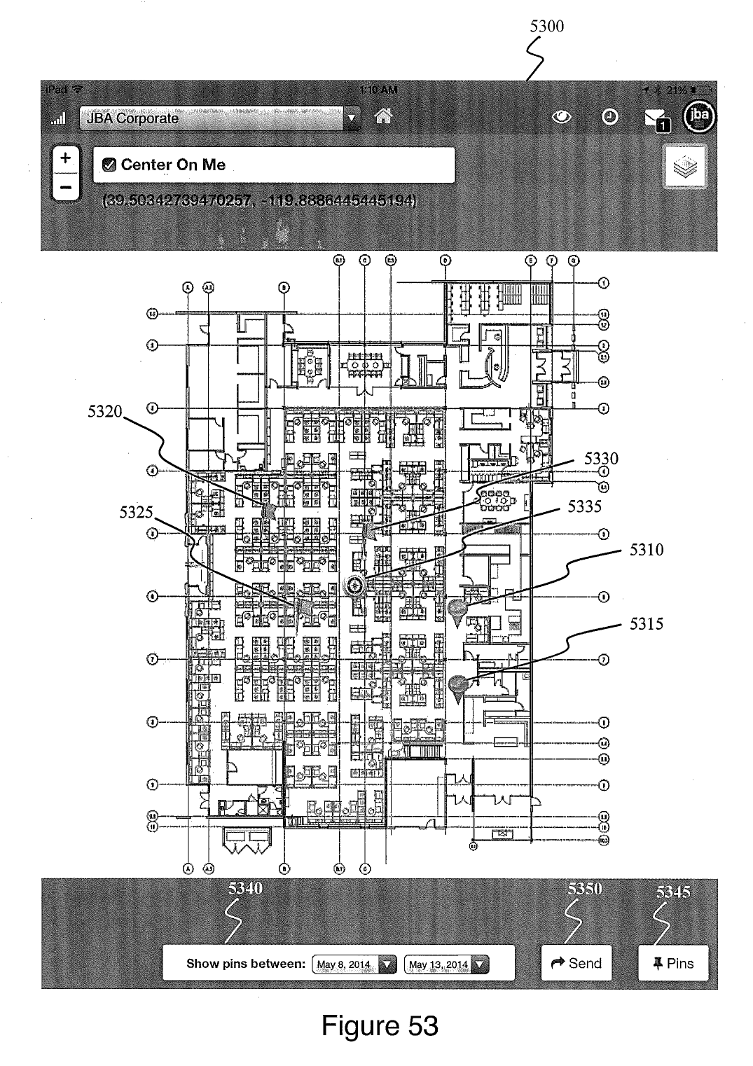

Referring now to FIG. 52, selection of the “Drop a Pin Here” button 4915 (e.g. see FIG. 49) directs the pin engine to display 520 (e.g., see FIG. 5) the edit pin view 5200. A pin title edit control 5205 and a pin notes edit control 5210 can receive meta data identifying and describing the pin. Detection of the selection event associated with the save button 5215 saves the pin and associated data, and places the pin at the location of the touch event. The information pin can be displayed on the map graphically, for example, as a traditional pin marker 5310 (see, e.g., FIG. 53).

Referring now to FIG. 53 as an example, a multi-pin floor plan and current location display view displays the map, registration pins, information pins, and current mobile computing device location based, at least in part, on selected display preferences. In this example, the three registration pins 5320, 5325, 5330, two information pins 5310, 5315, and the current mobile device location indicator 5335. Green pins 5310 indicate that at least one document, photograph, or note is associated with that pin. Red pins, e.g., 5315, indicate that no information is yet associated with that pin. Detection of the date range values of the date range pin display control 5340 displays only those pins with a CreateDate (see, e.g., FIG. 4A) between and including those date values. Detection of the selection event associated with the send button displays the compose message view 3800 (see, e.g., FIG. 38) for sending the pin to one or more users.

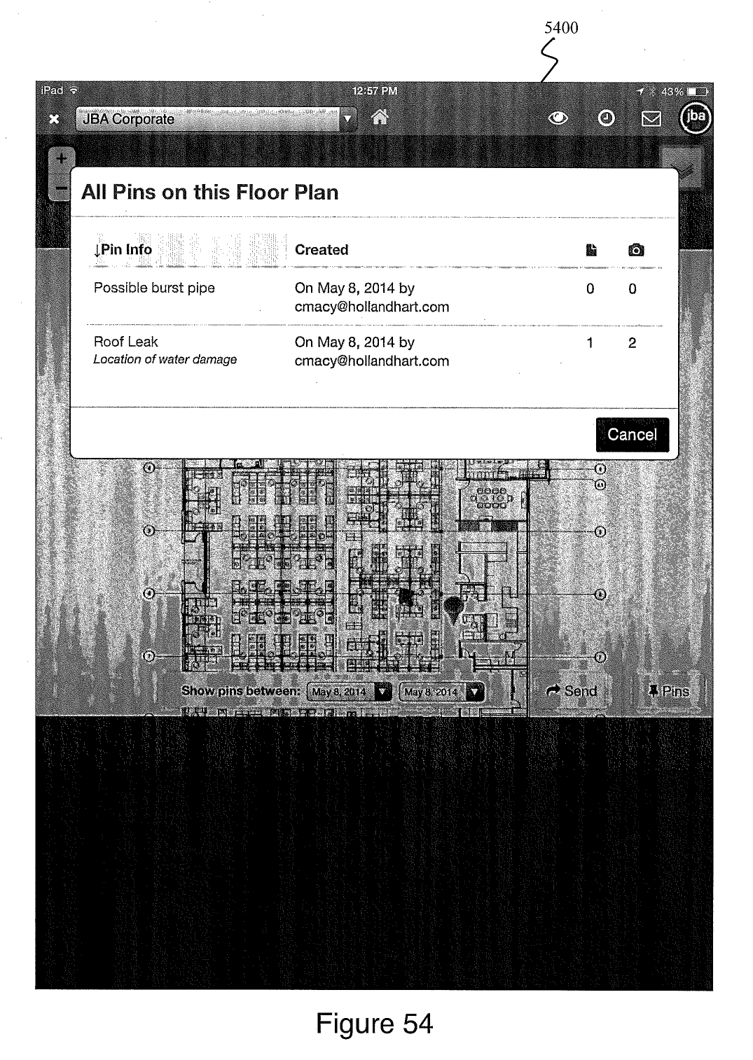

Referring now to FIG. 54, detection of the selection event associated with the pins button 5345 (see, e.g., FIG. 53) displays the all floor plan pins information view 5400, which lists all information pins associated with the selected map. This information can include, for example, the pin title, pin notes, pin creation date, pin creator name, the number of documents associated, the number of photos associated, and whether the pin is on the watch list. In some instances, the pin title may be represented as a link directed to the edit pin view for the pin.

In some embodiments, one or more types of information items are designated as types of documents. Documents may be treated differently than maps by the various components of the mobile information management system 100. For example, documents may be allow extensive markup and editing.

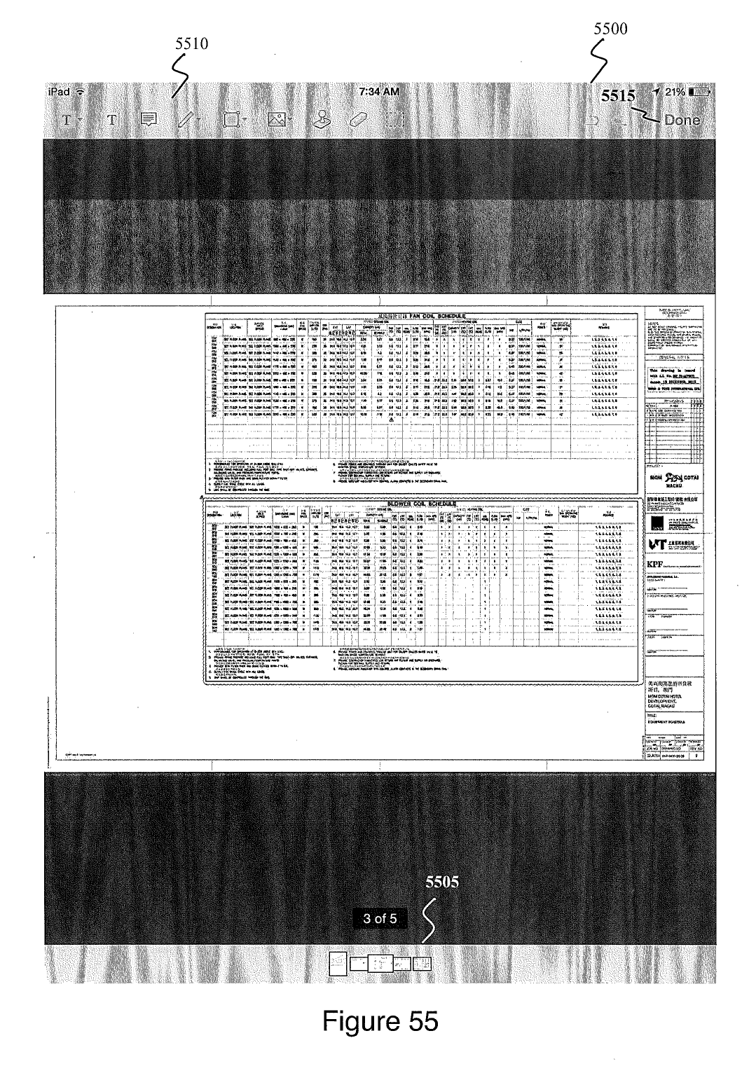

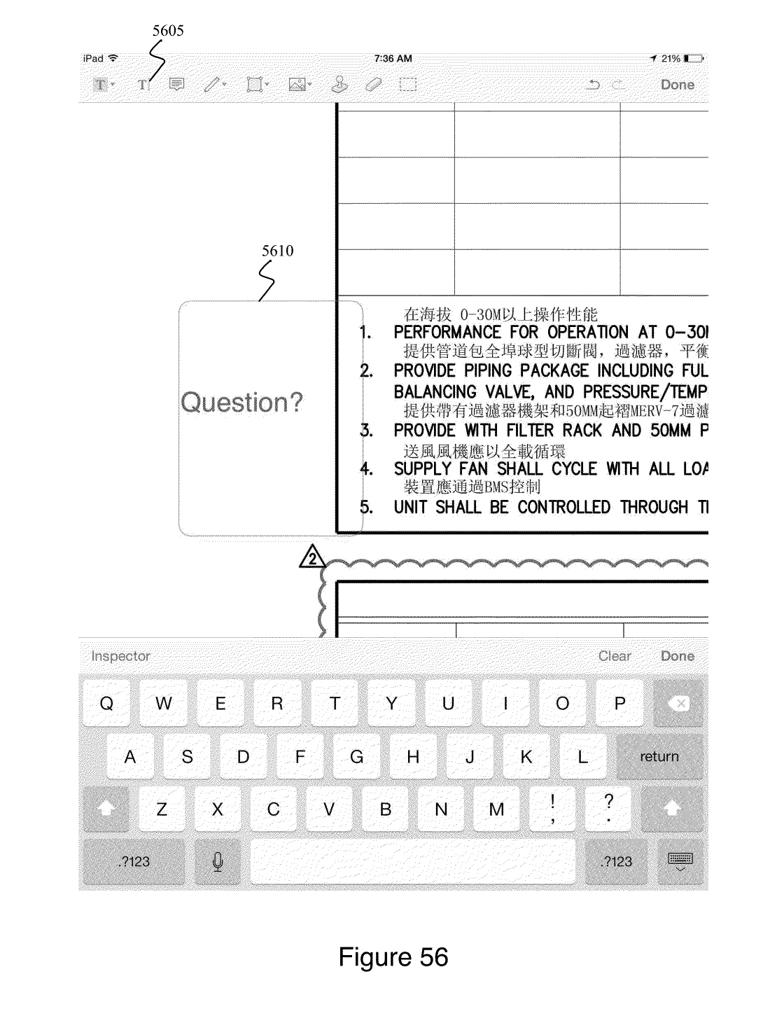

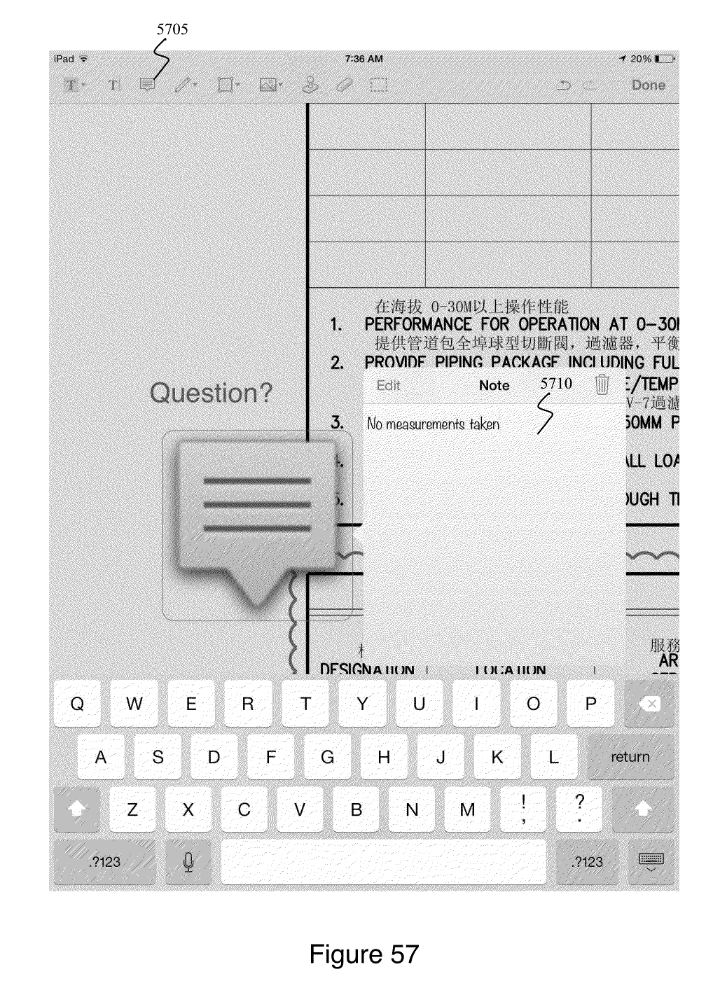

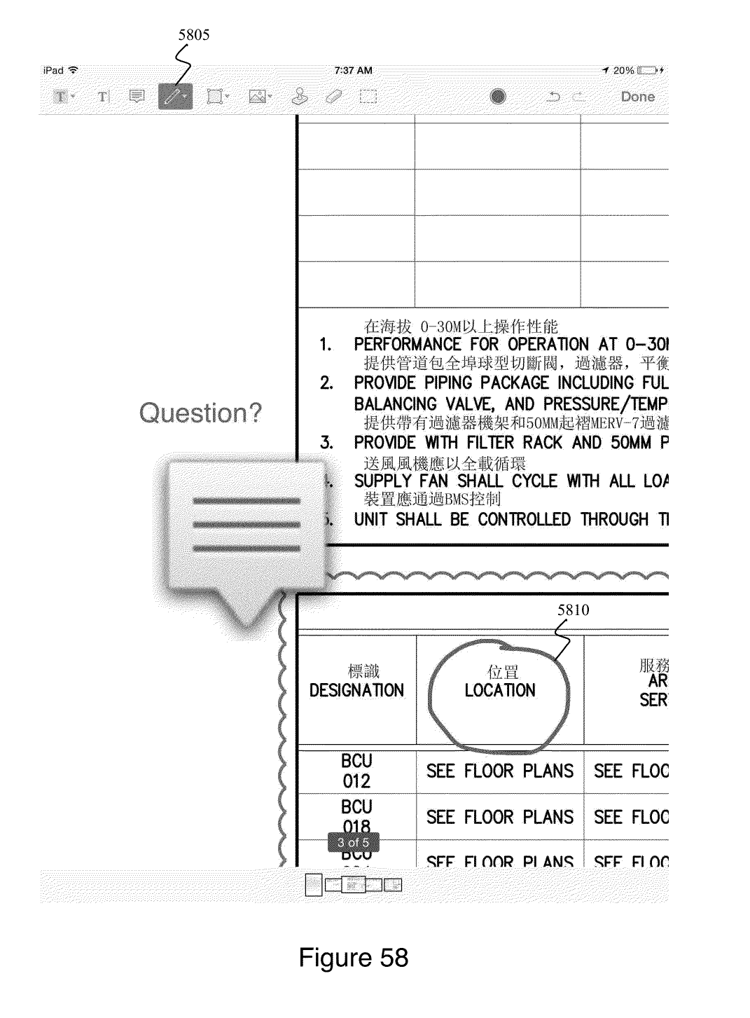

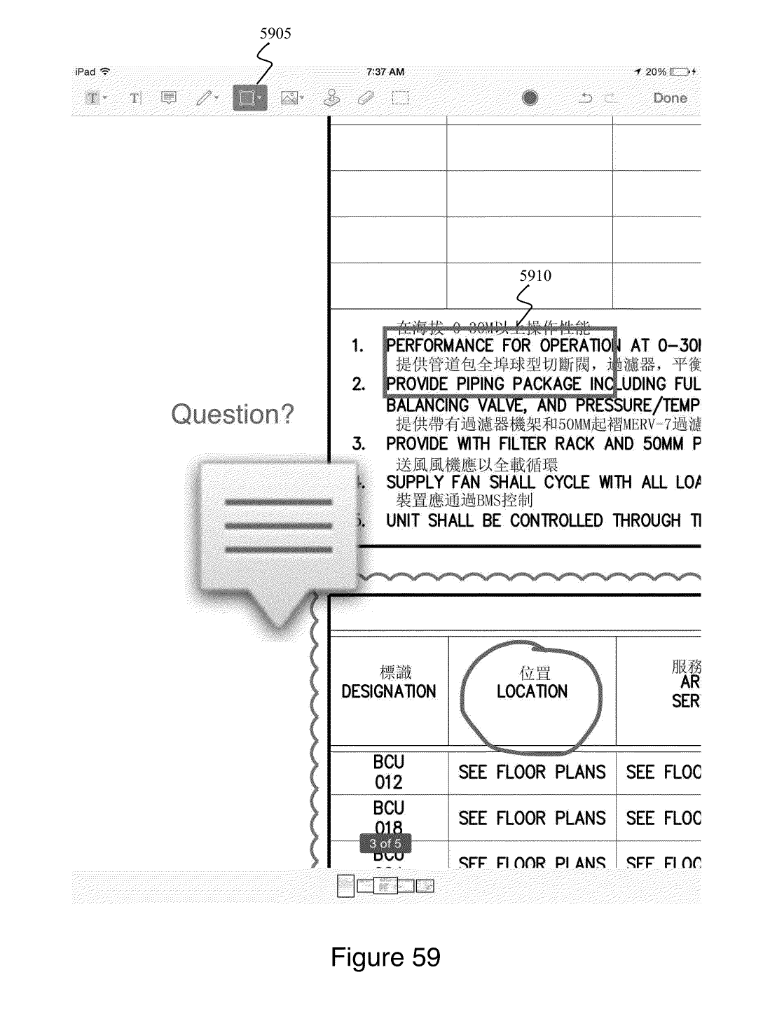

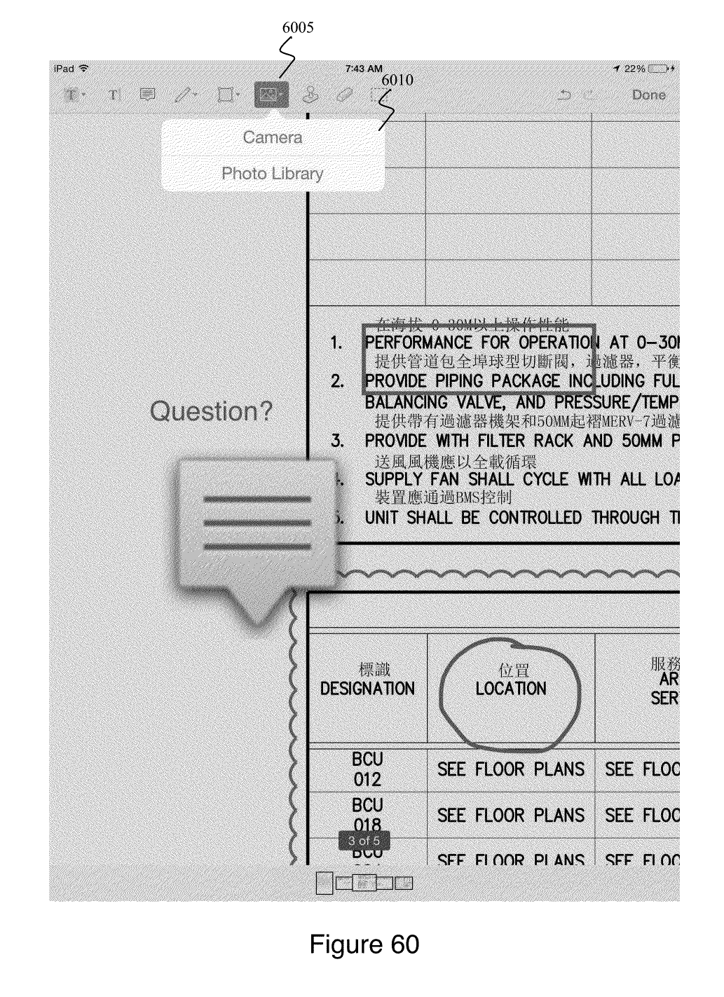

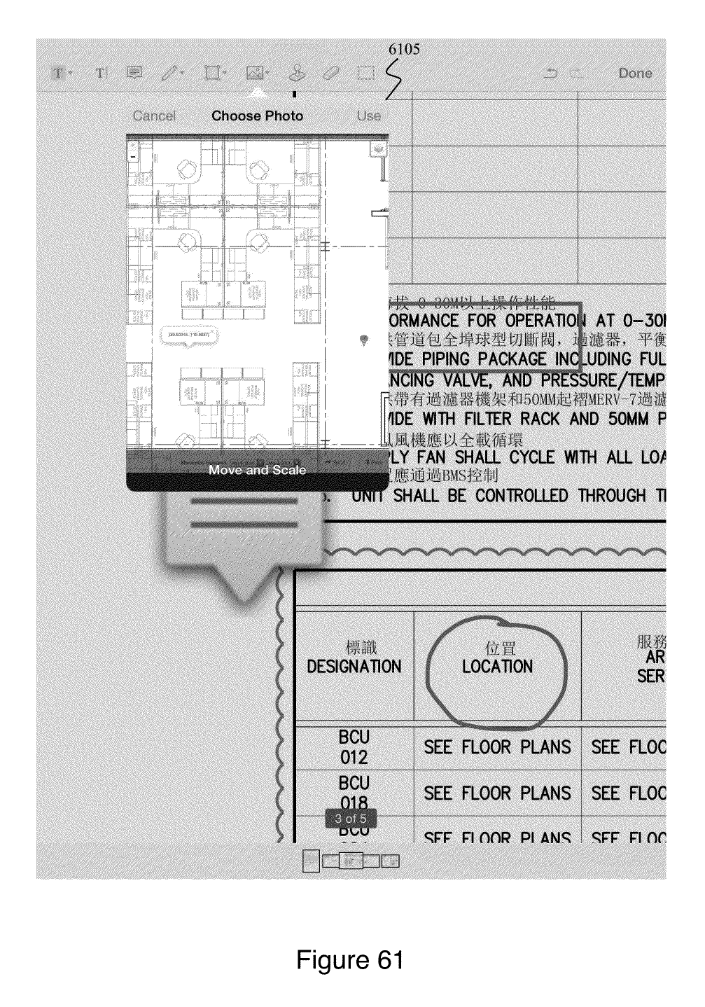

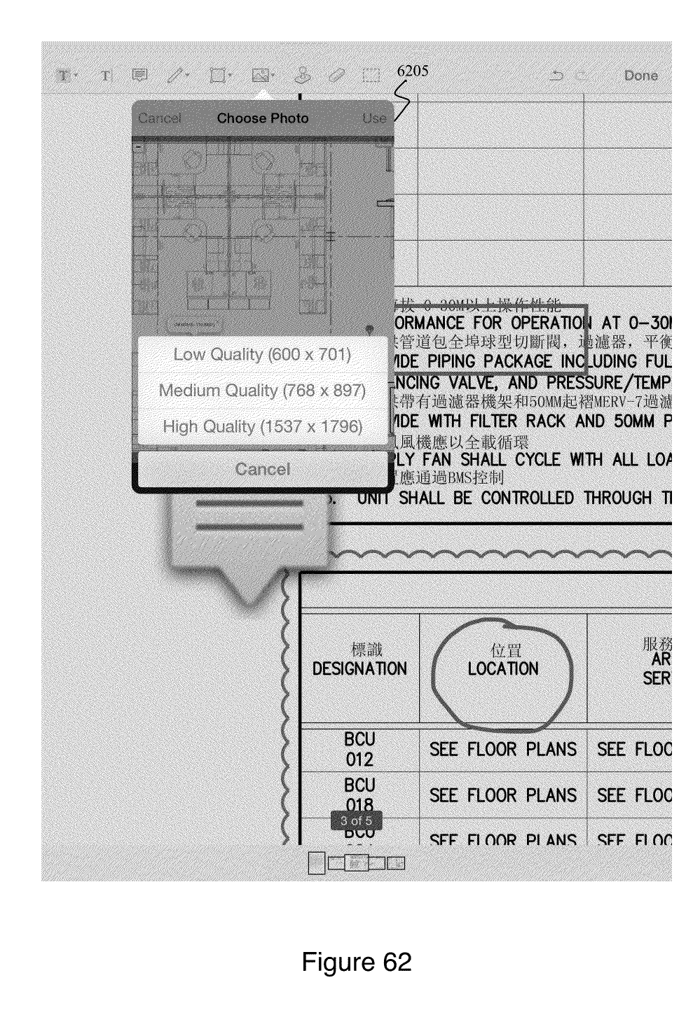

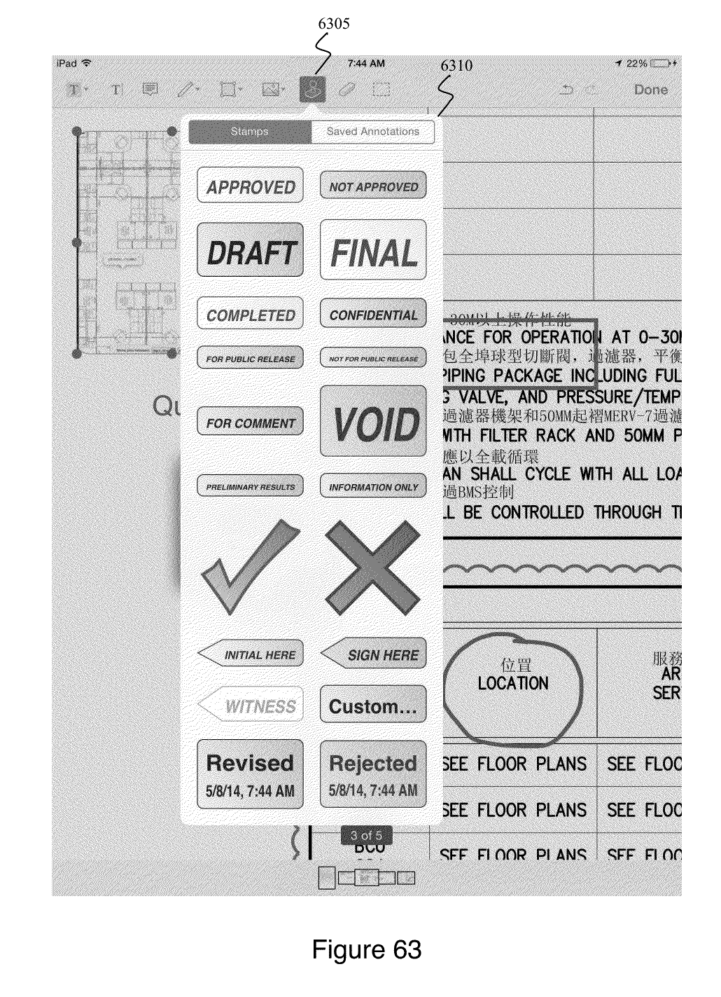

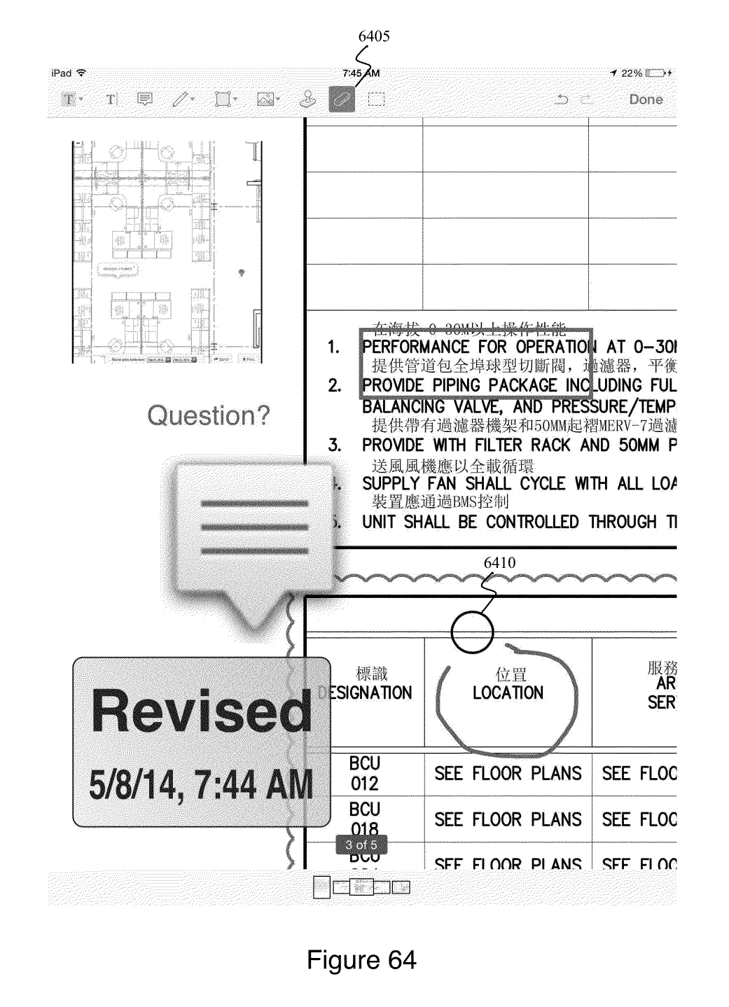

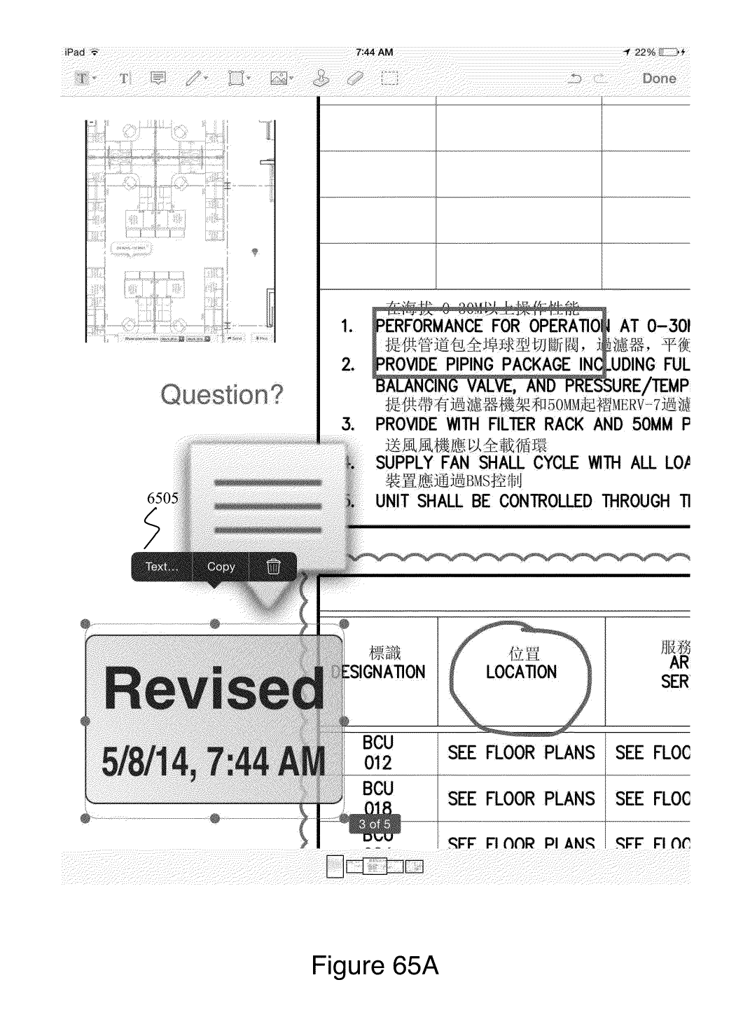

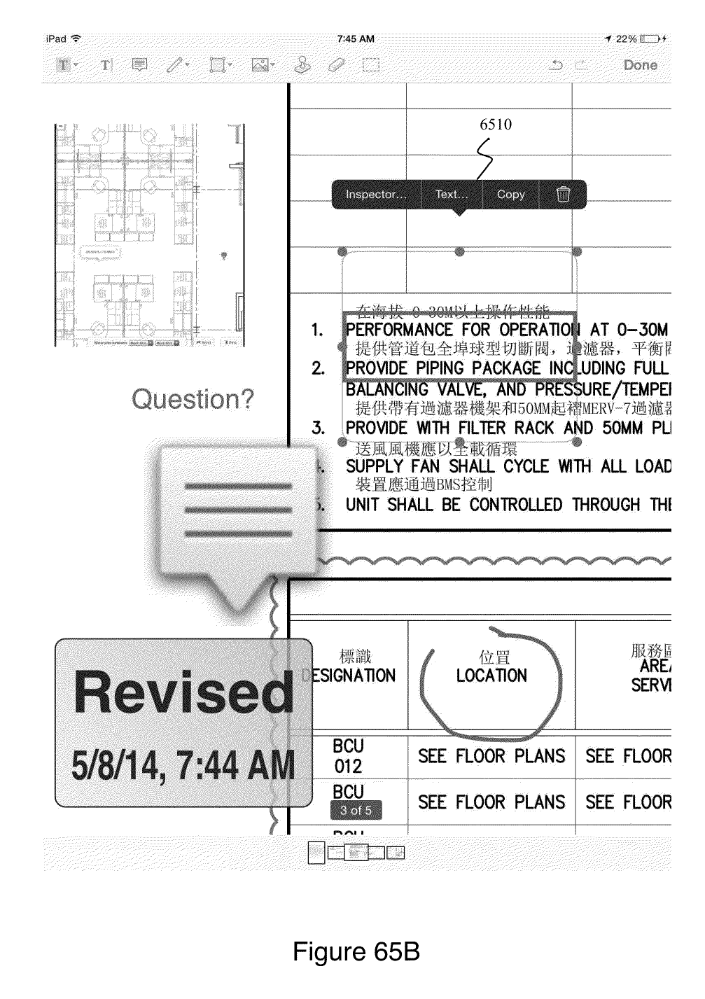

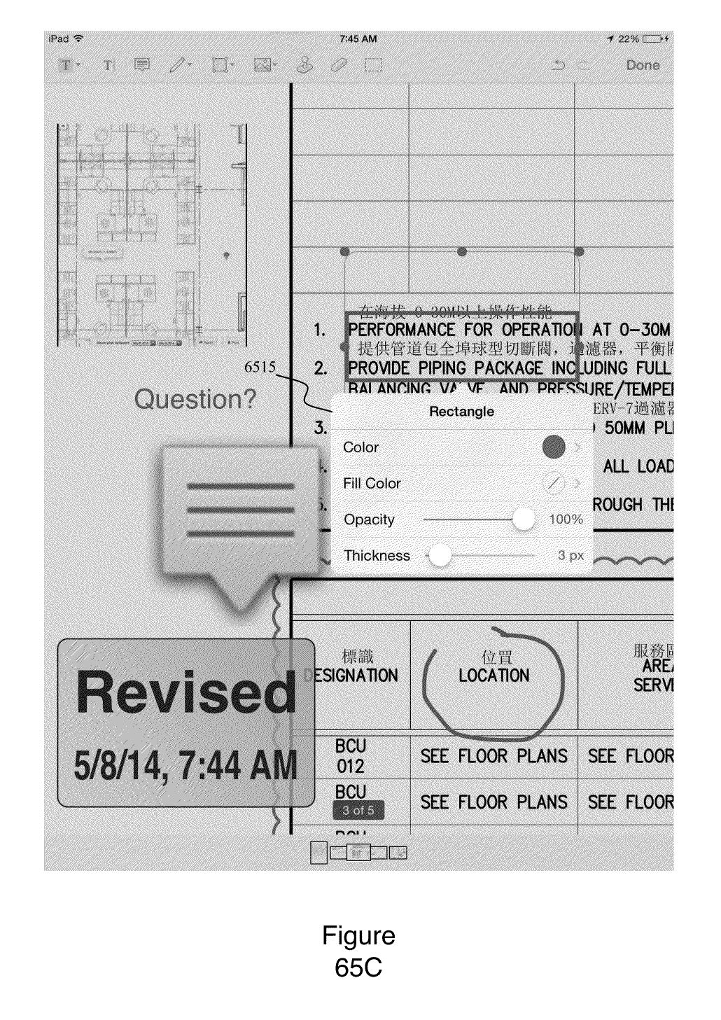

Referring now to FIGS. 55 through 65, a multi-page document opens in a multi-page document view 5500. Document navigation is available through various controls, such as a page navigation control 5505. Detection of the selection event associated with an edit control (not shown) can display the edit document toolbar 5510.

The edit document toolbar provides numerous types of editing capabilities. For example, selection of the text button icon 5605 displays a text markup control that adds text markup to the document 5610. Selection of the note button icon 5705 adds an editable, resizable note box 5710 to the document. Selection of the pencil button icon 5805 engages a freehand drawing interface on the document 5810. Selection of the shape button icon 5905 adds configurable, resizable shapes 5910 to the document. Selection of the picture button icon 6005 displays the image capture and selection menu 6010. Selection of the photo library selection item displays a photo library interface for photo selection. Once selected, the photo can be cropped and scaled, then selected for insertion as cropped and scaled 6105 into the document. The resolution of the inserted image can also be configured 6205. Selection of the stamp button icon 6305 displays the stamp selection menu 6310. The selected stamp from the stamp selection menu 6310 is added to the document. Selection of the eraser button icon 6405 displays the eraser control 6410 for erasing of certain types of markups, such as drawing markups. Selection of existing markups can display context sensitive menus 6505, 6510, 6515 specific to the type of markup selected. Selection of the done button 5515 saves the document with associated markups.

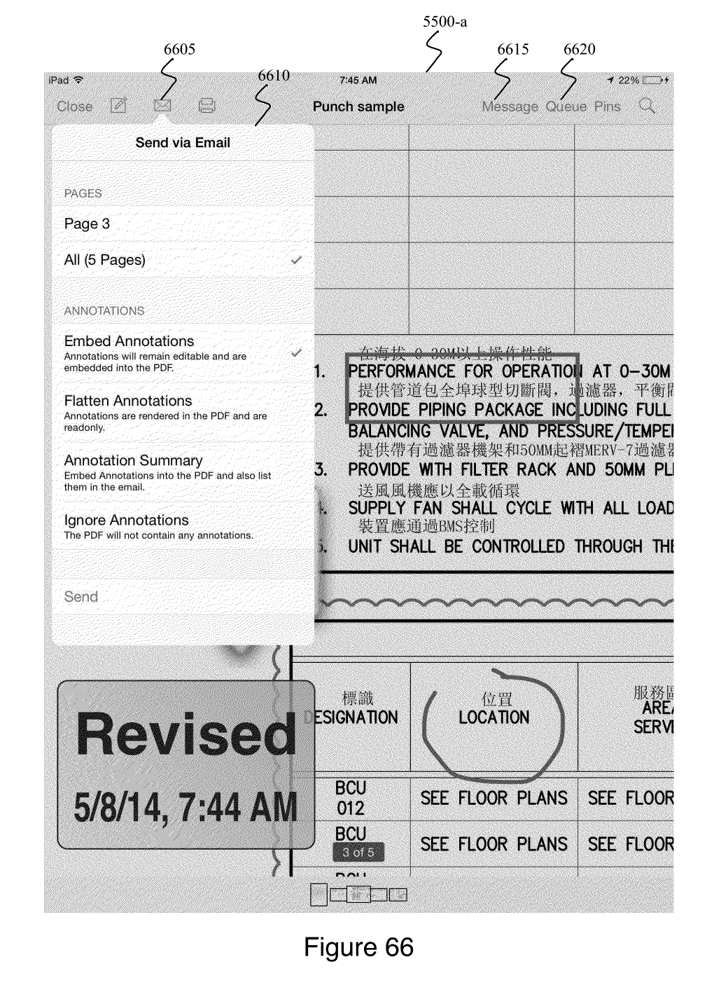

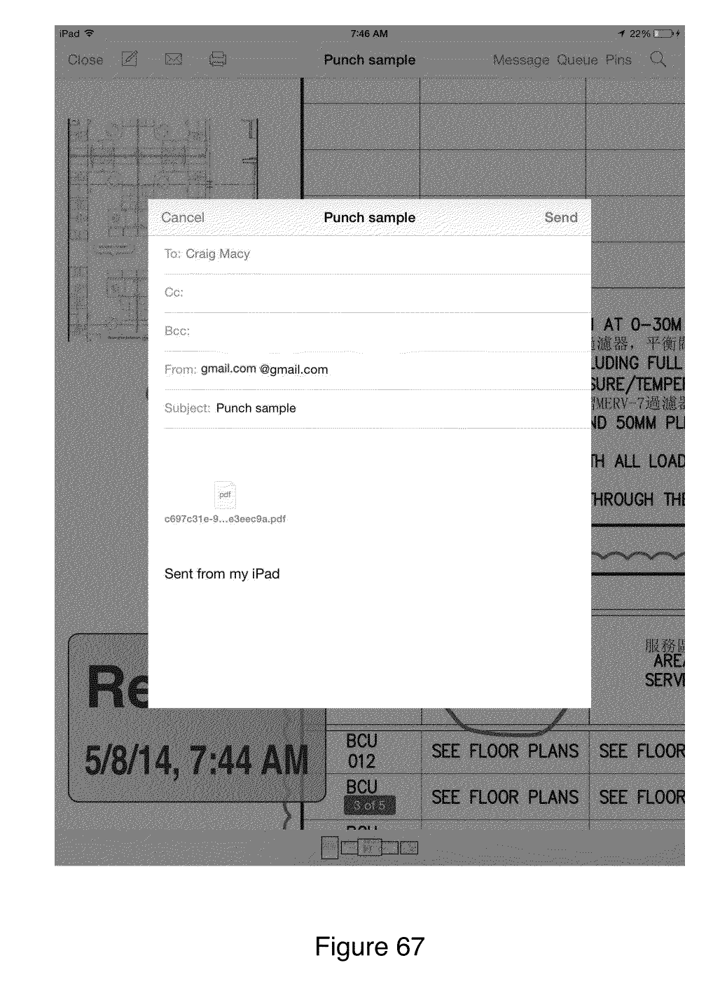

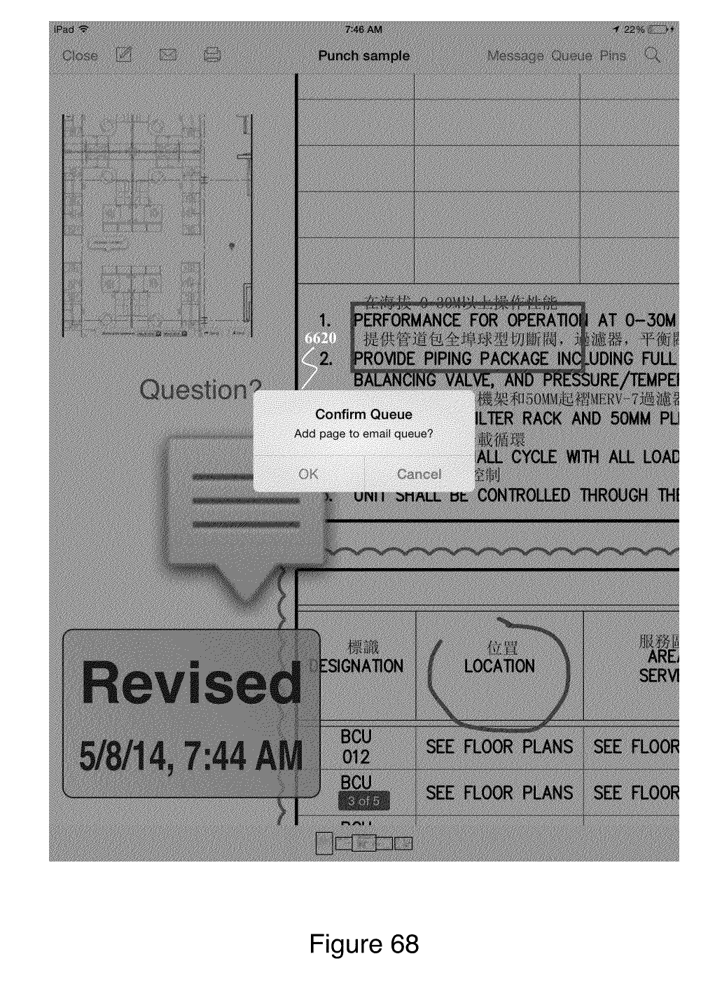

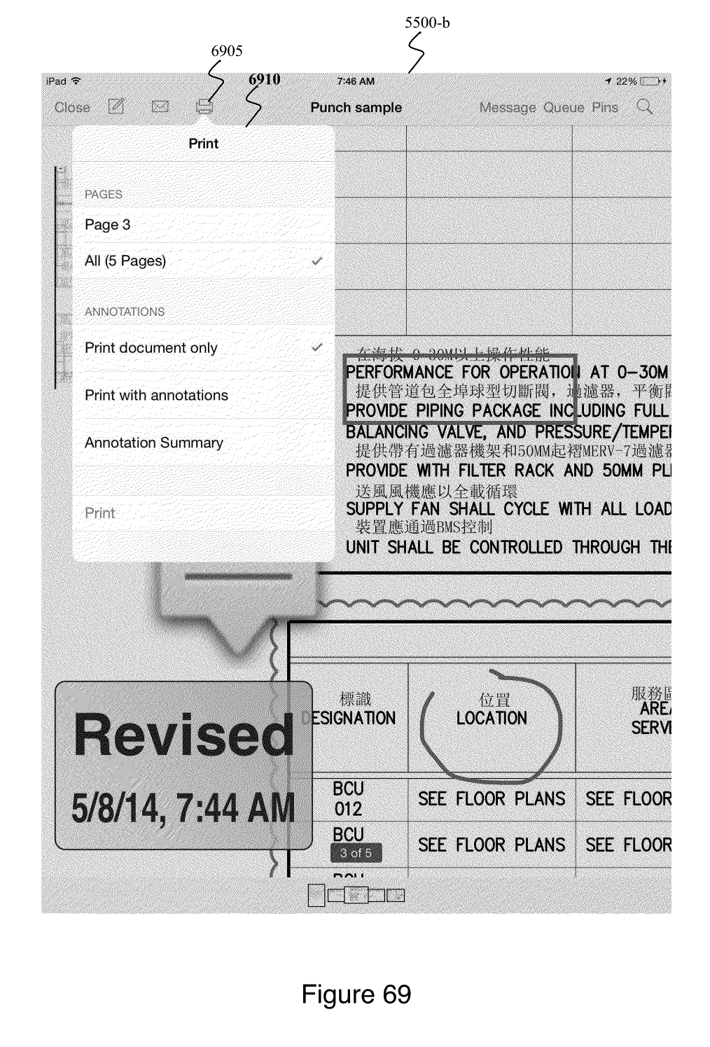

Referring now to FIGS. 66 through 68, selection of the send email button icon 6605 on the multi-page document view 5500-a displays send via email menu 6610 that includes email preparation options. Selection of the send button displays the email message interface of the default native mobile device email app with the prepared document attached. Selection of the message link 6615 sends the document in-system through the notification service. Selection of the queue link displays the email queue confirmation prompt and adds the document to the email queue upon detecting confirmation selection. Referring now to FIG. 68, selection of the printer button icon 6905 on the multi-page document view 5500-b displays print menu 6910 that includes print options, such as the pages to be printed, and whether or not annotations should be printed or summarized.

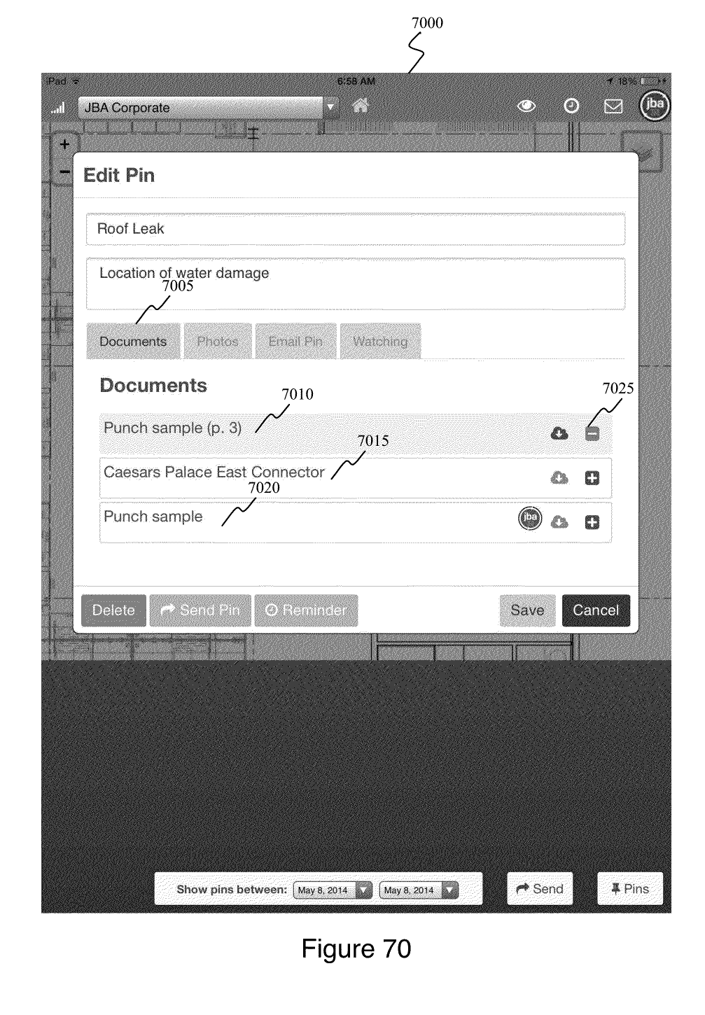

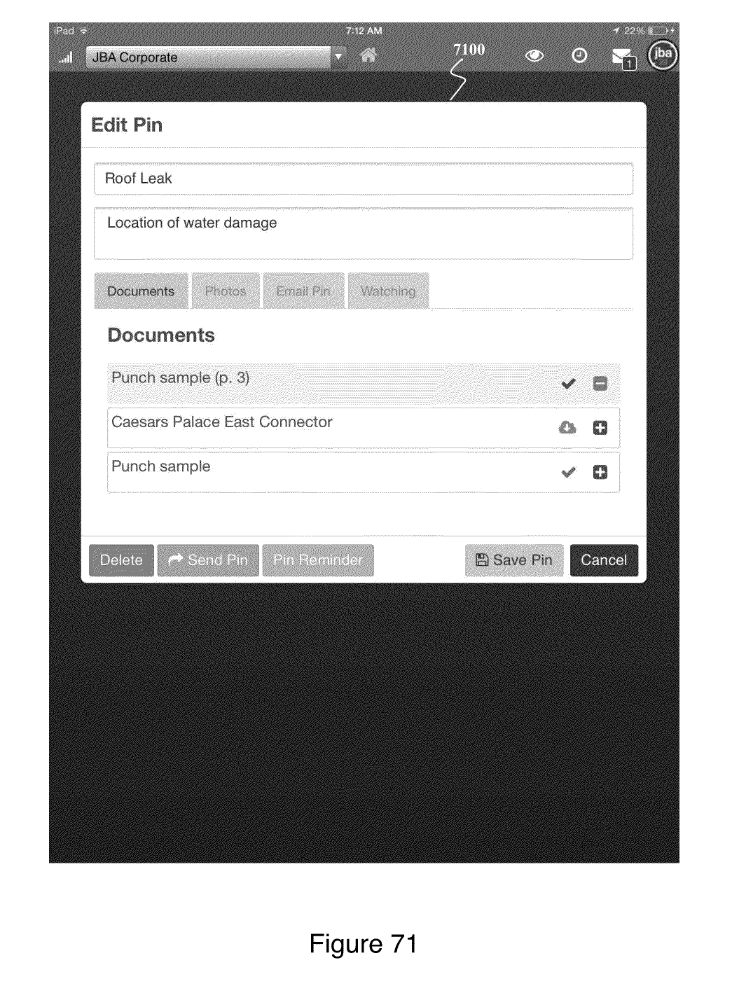

In some embodiments, informational pins can be created and edited, including associating the pins with documents and images. For example, the document edit described in the previous section can be associated with a new pin, an existing pin, or both. Referring now to FIGS. 70 and 71, selection of the documents tab 7005 on the edit pin view 7100 displays a list of documents, including pin-associated document references 7010 and available documents 7015, 7020. Selection of the removal button 7035 for the pin-associated document reference 7010 removes the association and transitions the document to an available document. In this example, page 3 of the punch sample document 7010 is associated with the pin, and the document is in the process of being synchronized with the mobile information management servers 124 (see, e.g., FIG. 1). The pin interface for editing existing pins and creating new pins can be substantially similar 7000, 7100.

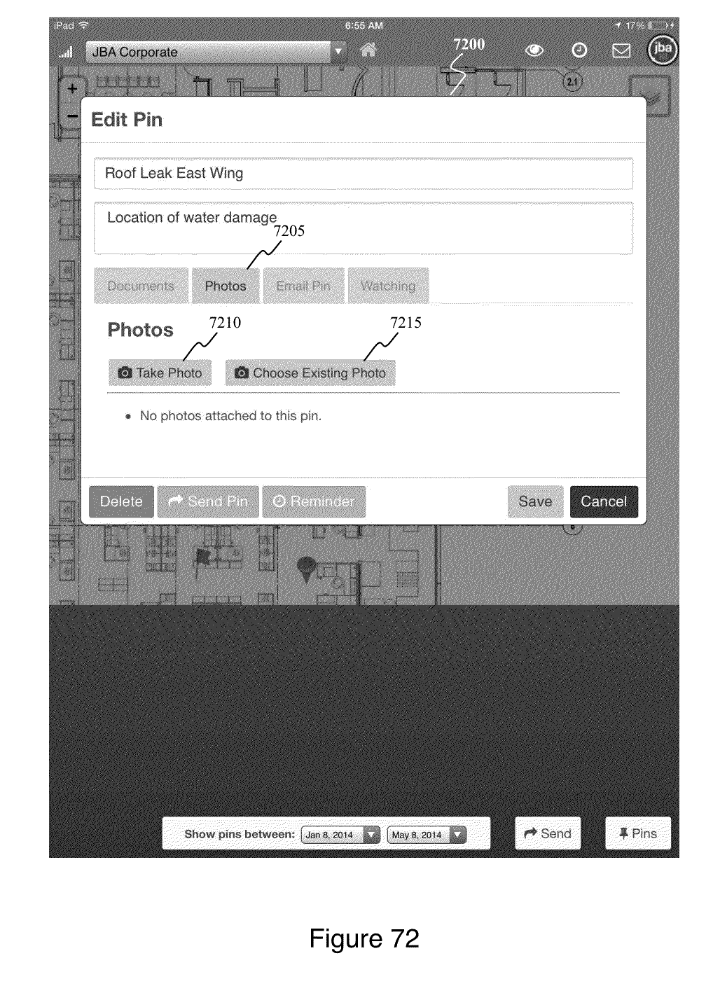

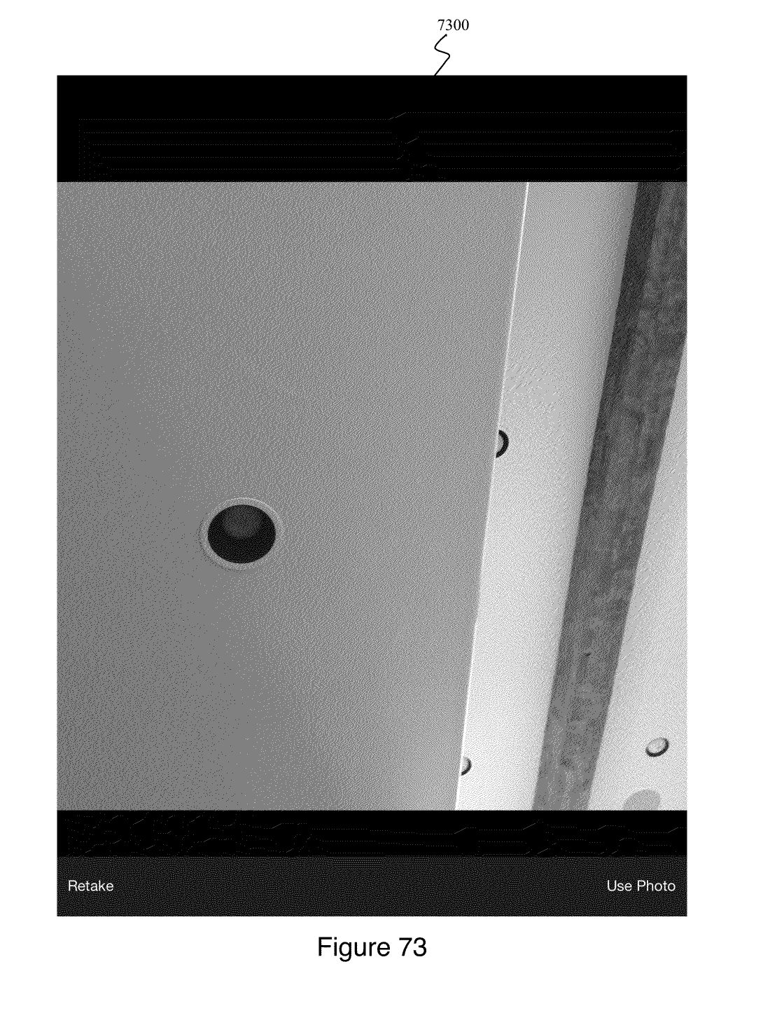

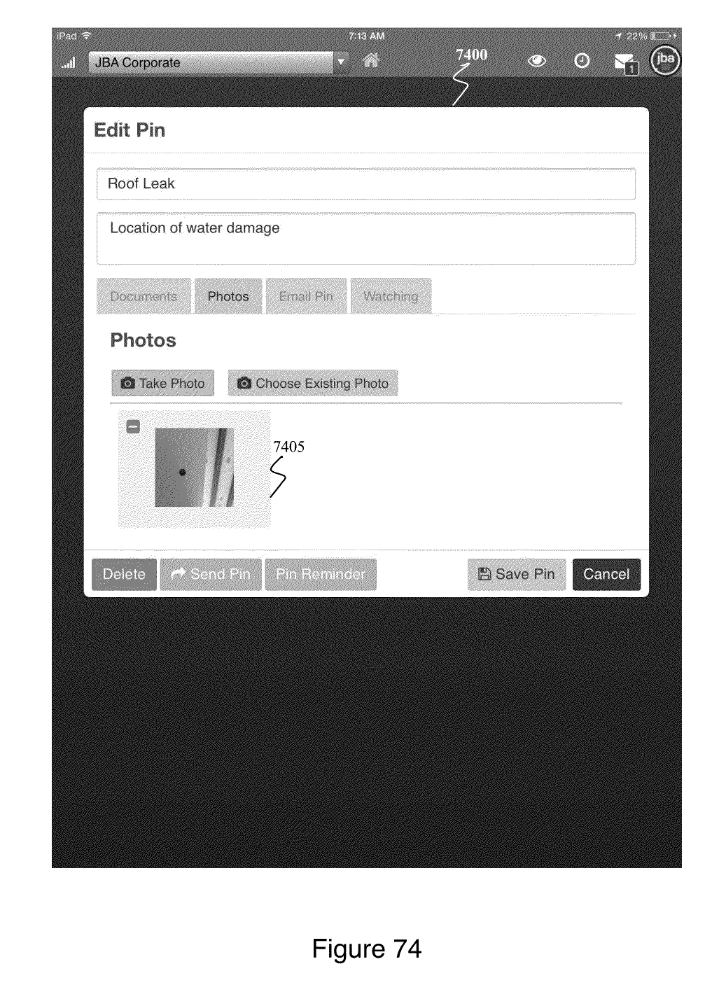

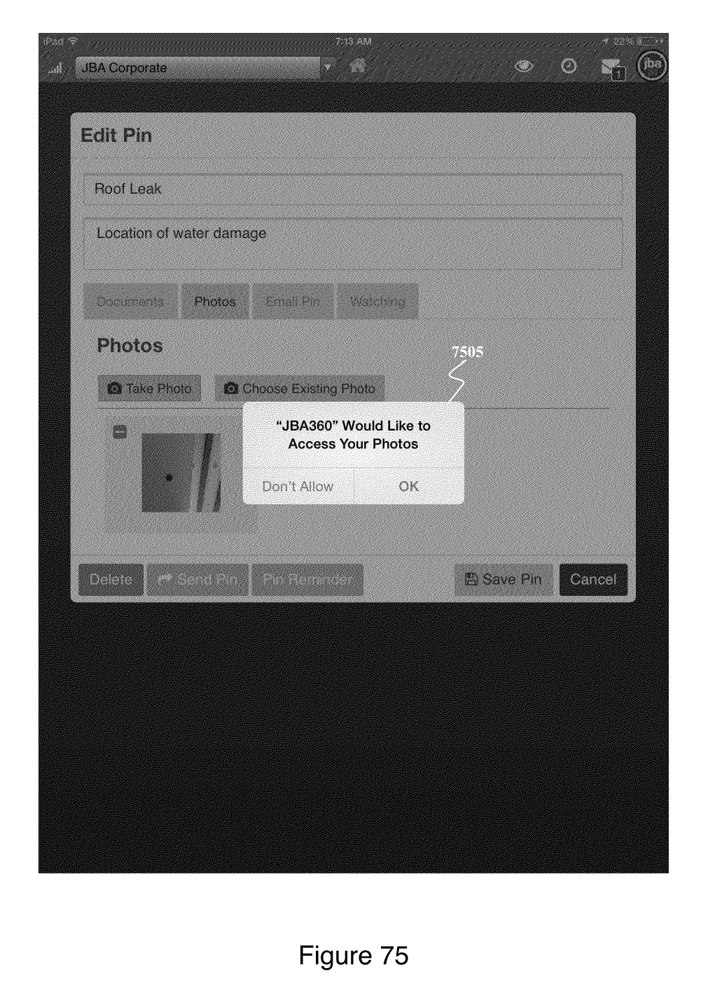

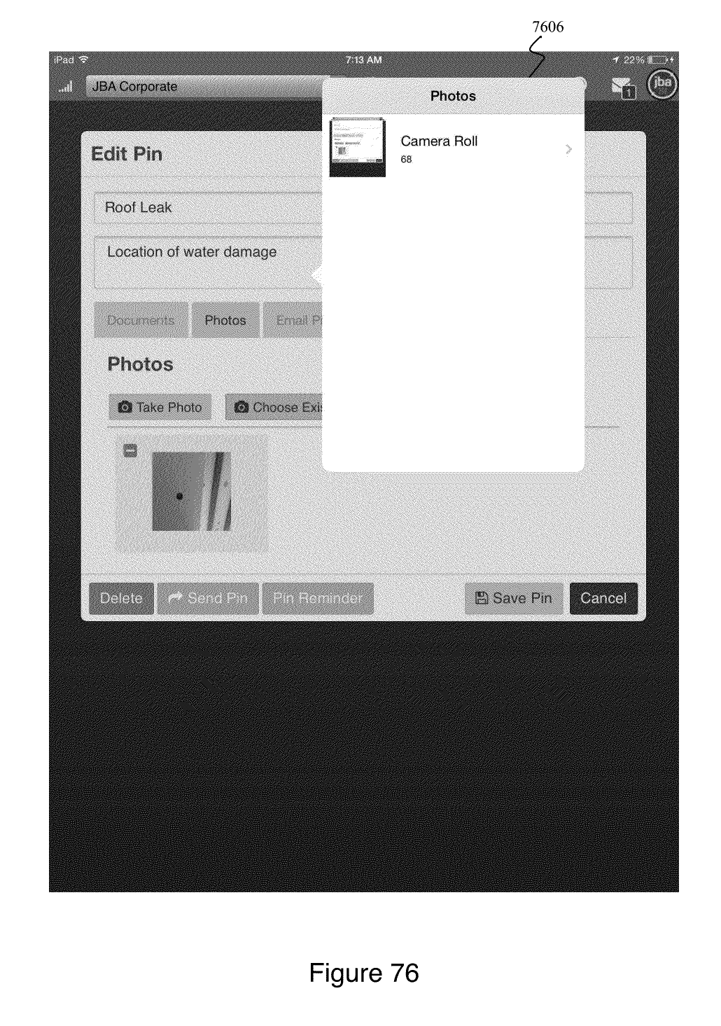

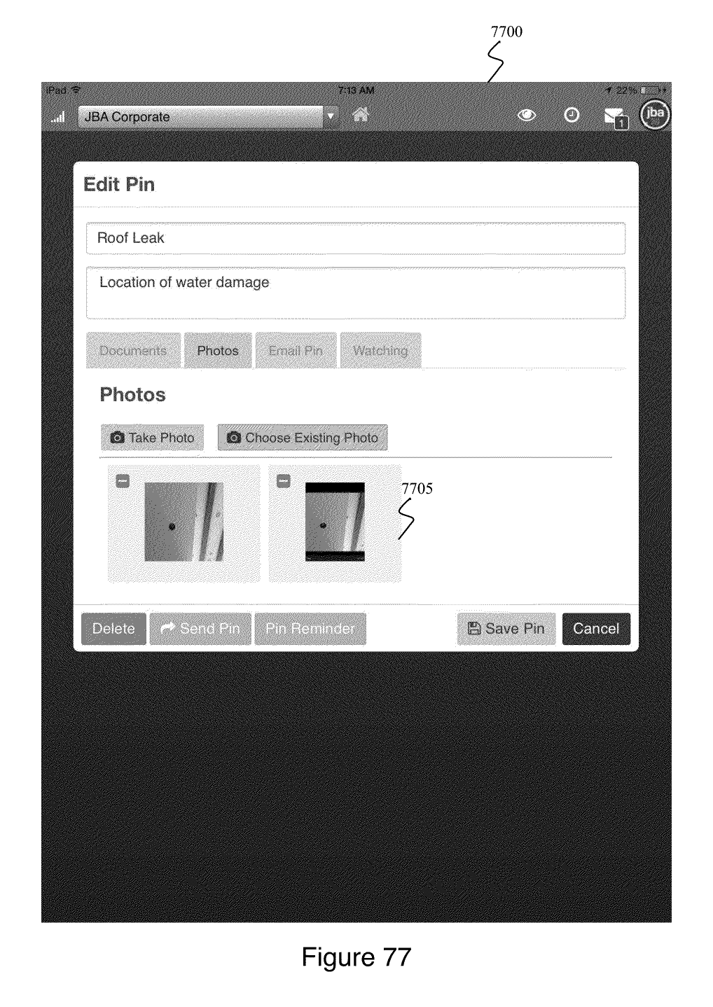

Referring now to FIGS. 72 through 77, selection of the photos tab 7205 on the edit pin view 7200 displays the take photo button 7210 and the choose existing photo button 7215. Selection of the take photo button 7210 engages the native image capture technology, displaying an image capture interface such as take photo view 7300. Selection of the choose existing photo button 7215 displays the allow access to photos confirmation prompt 7505. Upon receipt of confirmation, the mobile computing app 374 accesses images saved on the device for review 7605 and selective attachment to the pin. One associated, a thumbnail of the image 7705 appears on the edit pin view 7700.

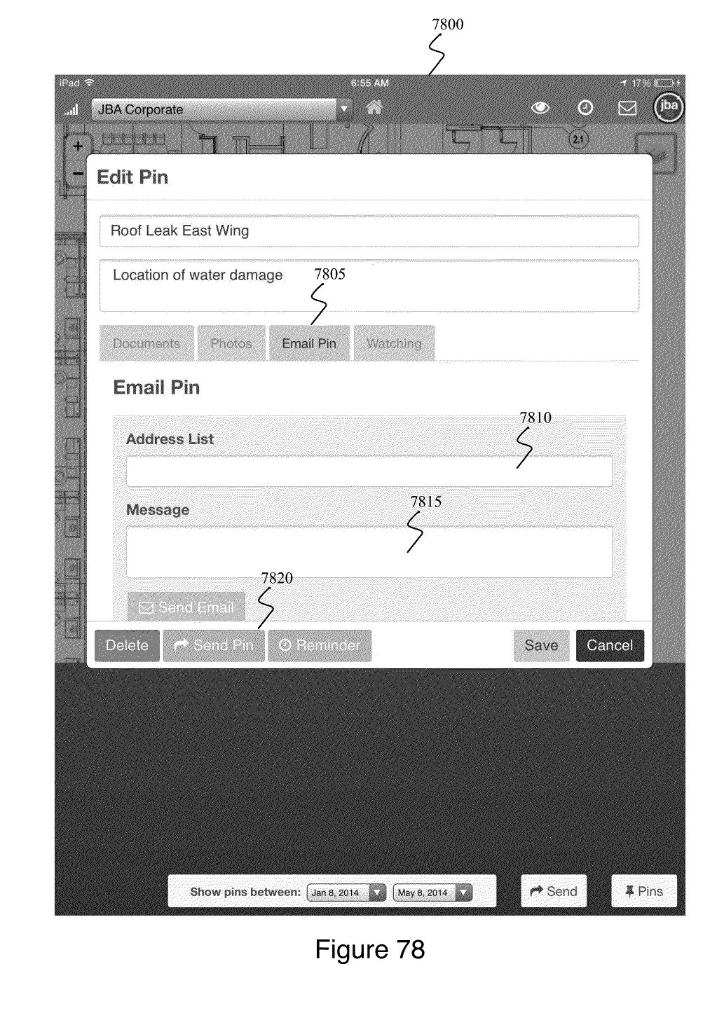

Referring now to FIG. 78, selection of the email pin tab 7805 on the edit pin view 7800 displays the an address list edit control 7810 and a message edit control 7815 for preparation of pin emails. This email function may be used, for example, where a technician enters new information thought to be of interest to another individual not associated with the group. Although the pin will be uploaded and associated with the project automatically, this other individual, not associated with the group, can immediately be notified of and access the new information.

In contrast, selecting the send pin button 7820, displays the compose message view 3900 of FIG. 39. The pin is automatically attached to the message. In some embodiments, this type of message can only be sent to other users in the particular project, by, for example, selecting a user from the select a user drop down menu 3915. This type of messaging function could be use, for example, to send new pin information to another facility manager that may work at the same property on a later shift. The message could, for example, indicate the work or other activity undertaken at the property that day, as well as those projects that are not yet finished.

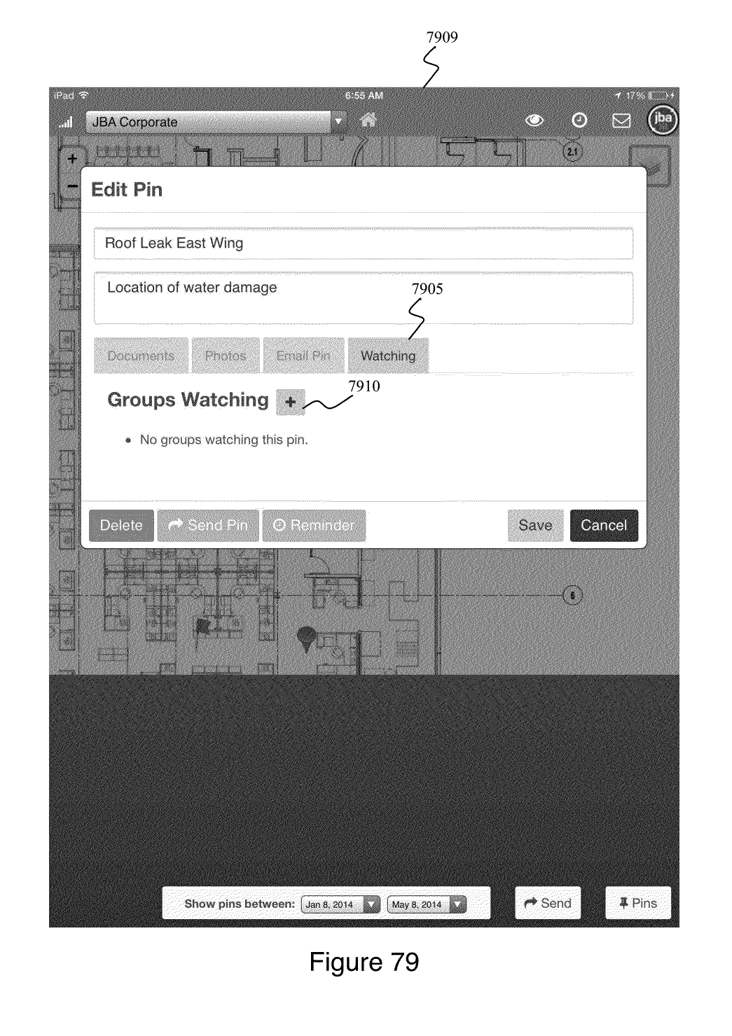

Referring now to FIG. 79, selection of the watching tab 7905 on the edit pin view 7800 displays a list of the groups watching the pin. Additional groups can be added to the watch list through the add groups control 7910.

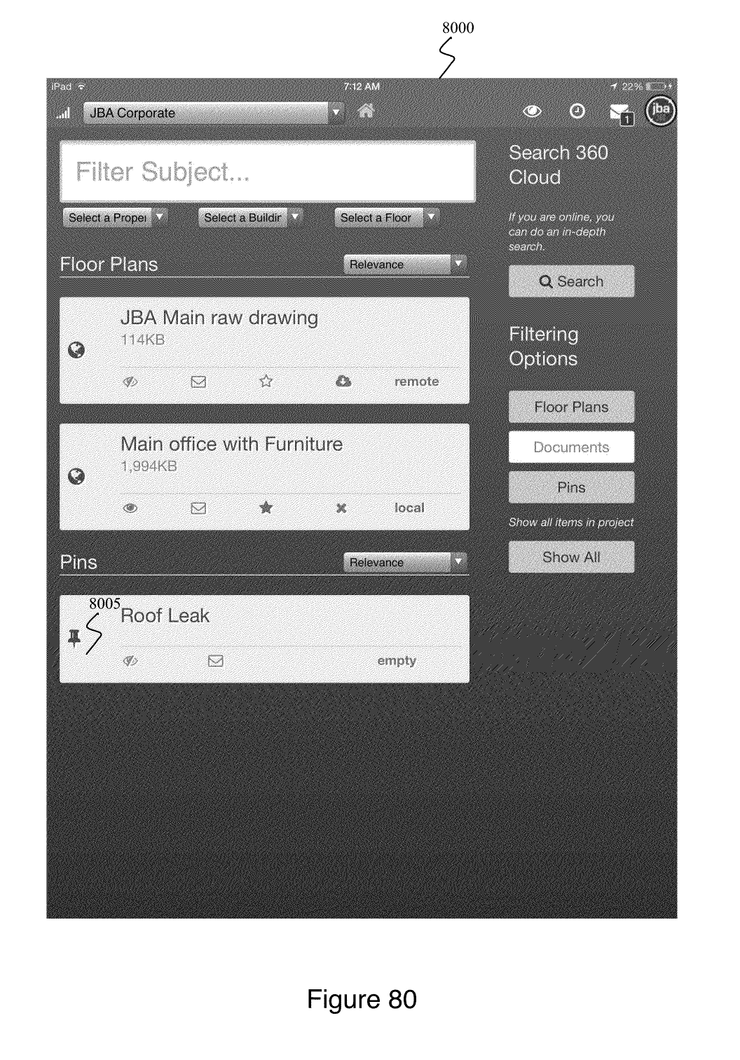

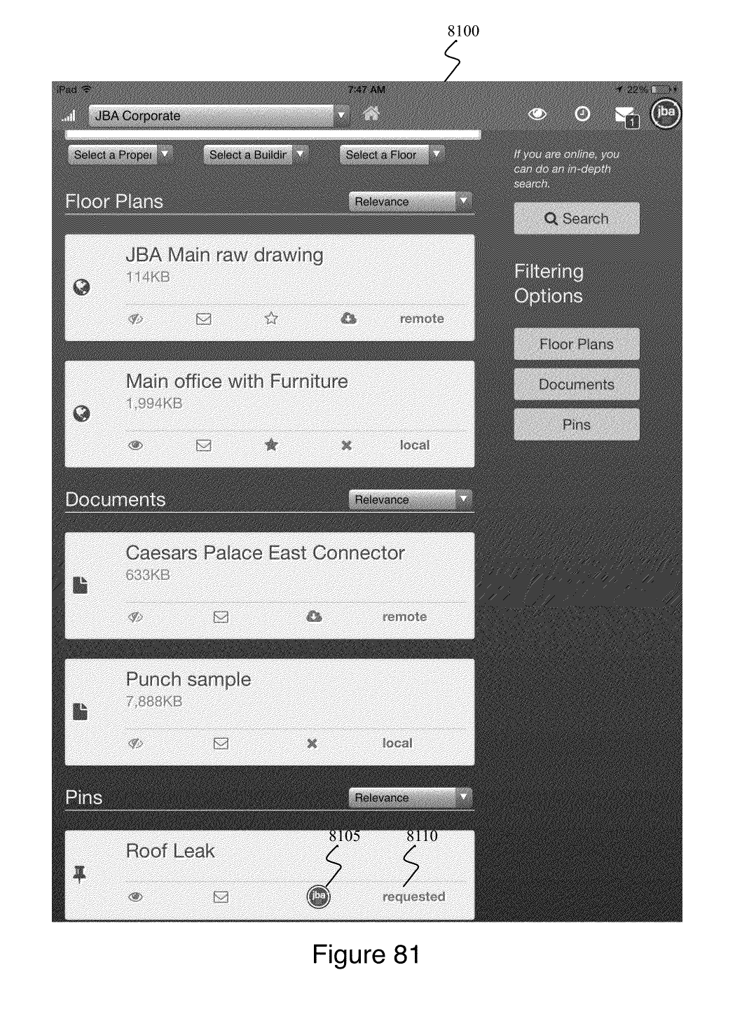

Referring now to FIGS. 80 and 81, once a pin is created, it appears in the main view 8000 and opens when the pin list item 8005 is selected. Similar to documents and maps, pin attachments can be downloaded and stored locally. A request is transmitted to the document management service 381, the download button icon is replaced with a non-interactive, in-process icon 8105, and the indicator message is changed to a requested indicator message 8110. Once the download is complete, the in-process icon 4405 is replaced with a delete icon and the indicator message is changed to a local indicator message.

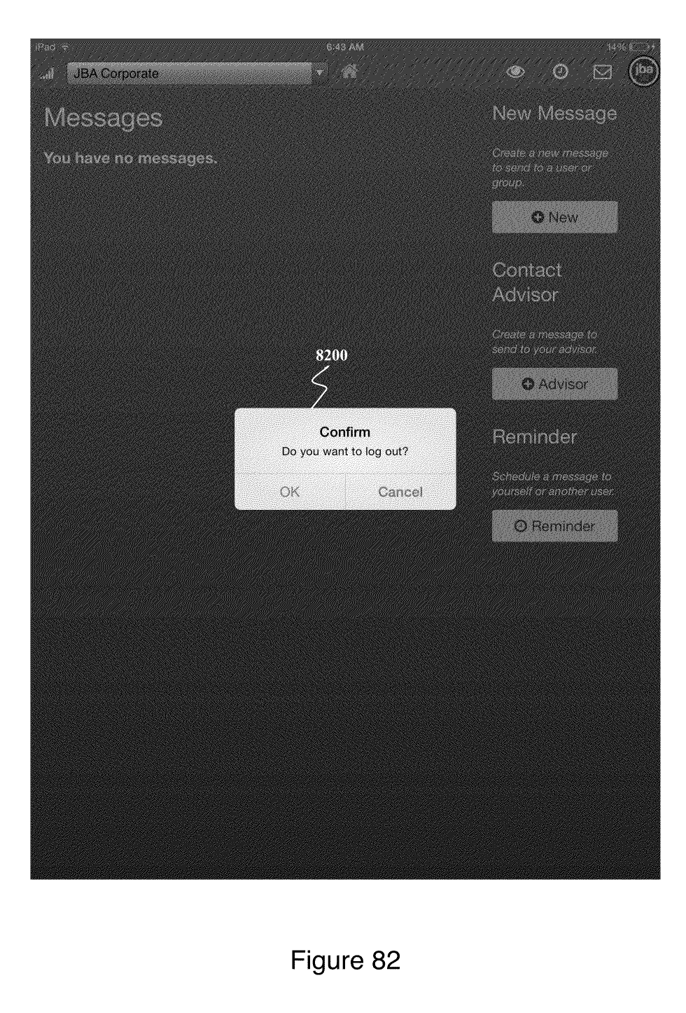

Detection of a logout request displays the logout confirmation prompt 8200 of FIG. 82. Upon receiving confirmation, the native mobile app will perform cleanup operations and shut down.

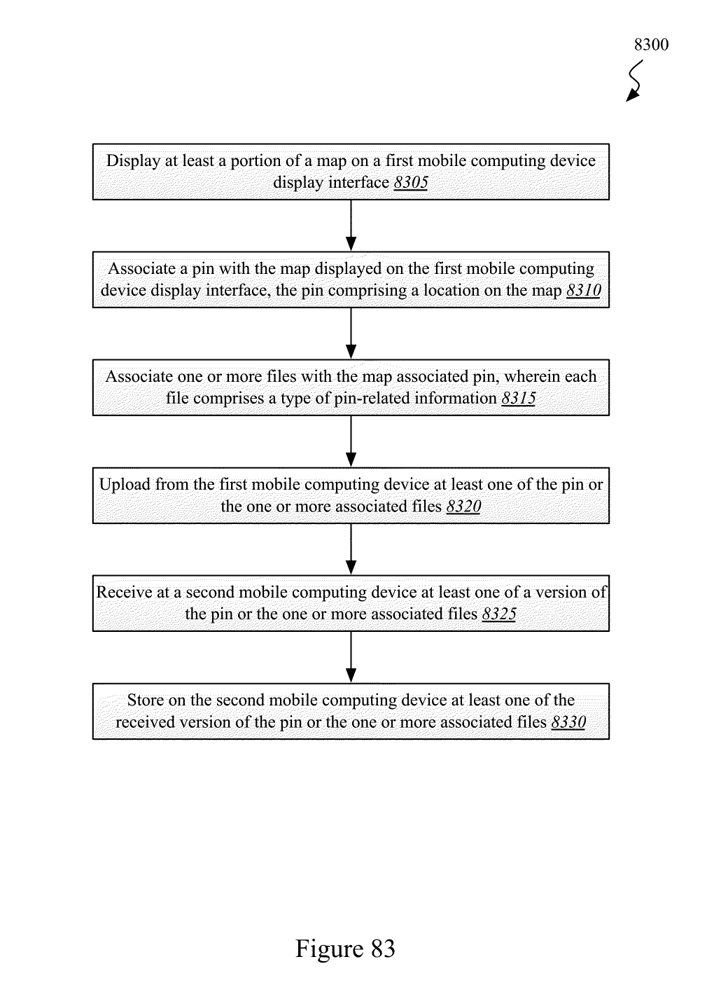

Referring now to FIG. 83, method 8300 may be carried out by a mobile information management system 100 according to various embodiments. The method 8300 may, for example, be performed by a mobile computing device of FIG. 1, 2, 3 or using any combination of the devices described for these figures.

Initially, at block 8305 a mobile computing device 114, 116 displays at least a portion of a map on a display interface. In some instances, the map can be a plan-view map, drawn to scale, of the relationships between at least one of walls, rooms, spaces or other physical features. In addition, in some cases, the map can include one floor of a structure. At block 8310, the pin engine 520 (see, e.g., FIG. 5) associates a pin with the displayed map. The pin includes a location on the map, which can be a coordinate location, such as geospatial coordinates, map coordinates, or both. At block 8315, the pin engine 520 associates one or more files with the map associated pin. Files can consist of a type of pin-related information, such as, for example, a document or an image. At block 8320, the messaging engine 560 uploads the pin, one or more of the associated files, or both. At block 8325, the messaging engine of another mobile computing device receives a version of the pin, one or more of the files, or both. In some instances, this version corresponds to the version uploaded at block 8320. At block 8330, the data engine 565 of the receiving mobile computing device stores the received version of the pin, the one or more files, or both.

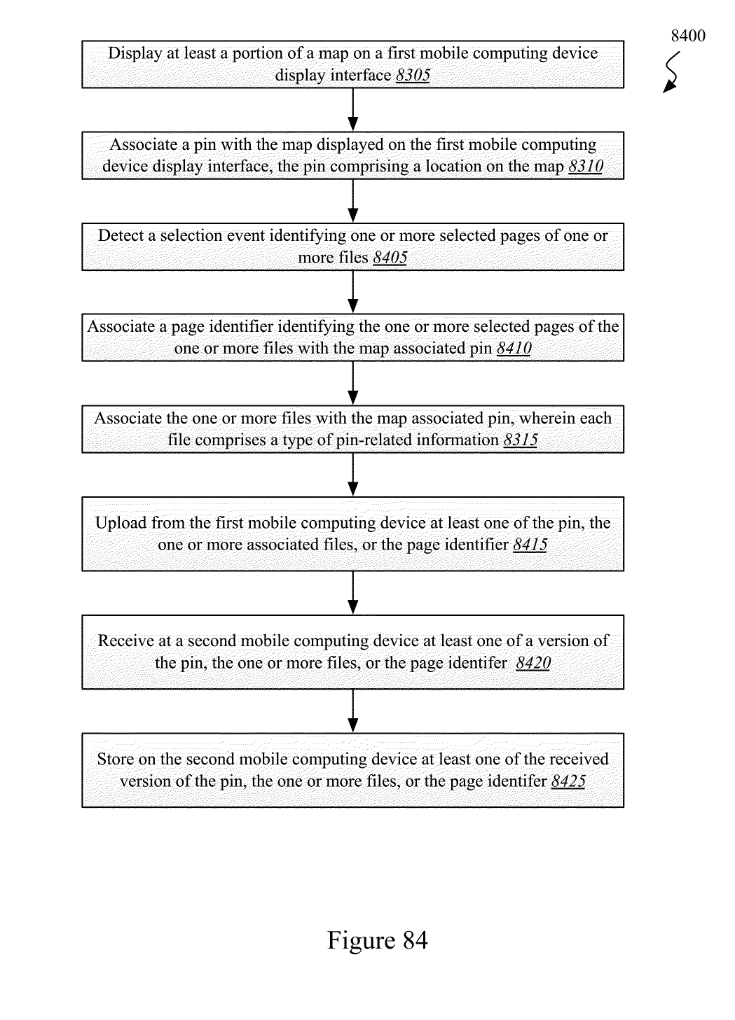

Referring now to FIG. 84, method 8400 may be carried out by a mobile information management system 100 according to various embodiments. The method 8400 may, for example, be performed by a mobile computing device of FIG. 1, 2, 3 or using any combination of the devices described for these FIGS. 1-3.

In certain implementations, one or more identified pages of a file can be associated with a pin. Initially, at block 8305 a mobile computing device 114, 116 displays at least a portion of a map on a display interface. At block 8310, the pin engine 520 (see, e.g., FIG. 5) associates a pin with the displayed map. The pin includes a map location, which can be a coordinate location, such as geospatial coordinates, map coordinates, or both. At block 8405, event detection engine 570 detects a selection event identifying one or more pages of one or more files, then at block 8410, associates a page identifier identifying the selected pages with the map associated pin. In addition, at block 8315, the pin engine 520 associates one or more of the files with the map associated pin. Files can consist of a type of pin-related information, such as, for example, a document or an image. At block 8415, the messaging engine 560 uploads one or more of the pin, the associated files, or the page identifier. At block 8420, the messaging engine of another mobile computing device receives a version of one or more of the pin, the associated files, or the page identifier. In some instances, this version corresponds to the version uploaded at block 8415. At block 8425, the data engine 565 of the receiving mobile computing device stores the received version of one or more of the pin, the associated files, or the page identifier.

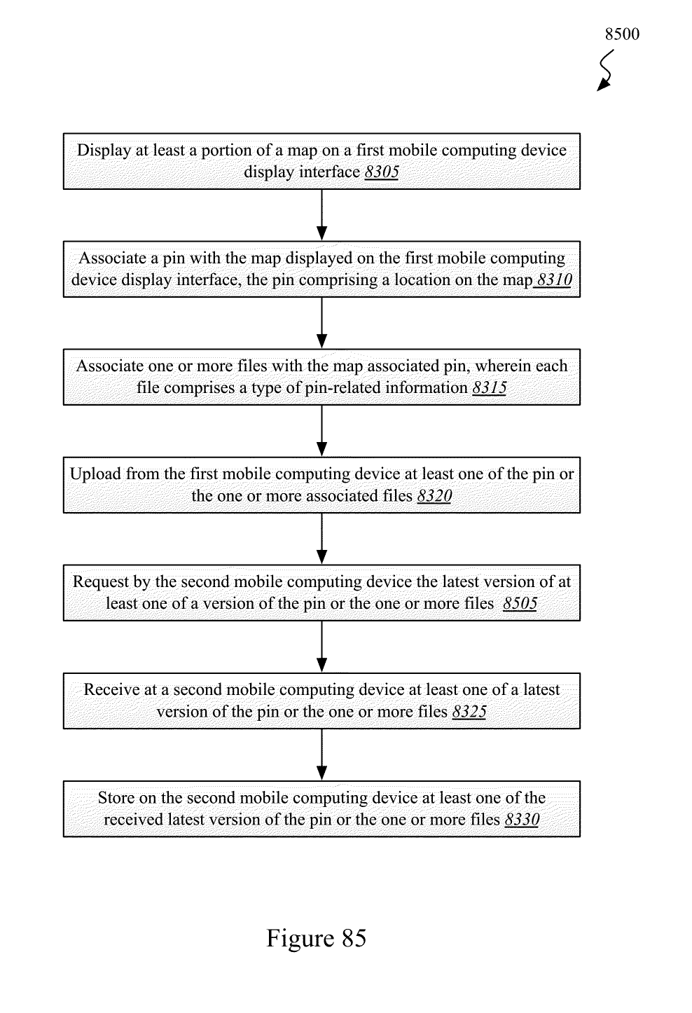

Referring now to FIG. 85, method 8500 may be carried out by a mobile information management system 100 according to various embodiments. The method 8500 may, for example, be performed by a mobile computing device of FIG. 1, 2, 3 or by using any combination of the devices described for these FIGS. 1-3. In some instances, pins and files are assigned a version. The native mobile app, the document management service, or both can assign the version to the pin, the file, or both. Initially, at block 8305 a mobile computing device 114, 116 displays at least a portion of a map on a display interface. At block 8310, the pin engine 520 (e.g., see FIG. 5) associates a pin with the displayed map. The pin includes a location on the map, which can be a coordinate location, such as geospatial coordinates, map coordinates, or both. At block 8315, the pin engine 520 associates one or more files with the map associated pin. Files can consist of a type of pin-related information, such as, for example, a document or an image. At block 8320, the messaging engine 560 uploads the pin, one or more of the associated files, or both. At block 8505, the messaging engine of another mobile computing device requests the latest version of at least one of a version of the pin, the one or more files, or both. At block 8325, the messaging engine of the second mobile computing device receives a version of the pin, one or more of the files, or both. In some instances, this version corresponds to the latest version uploaded at block 8320. At block 8330, the data engine 565 of the receiving mobile computing device stores the received version of the pin, the one or more files, or both.

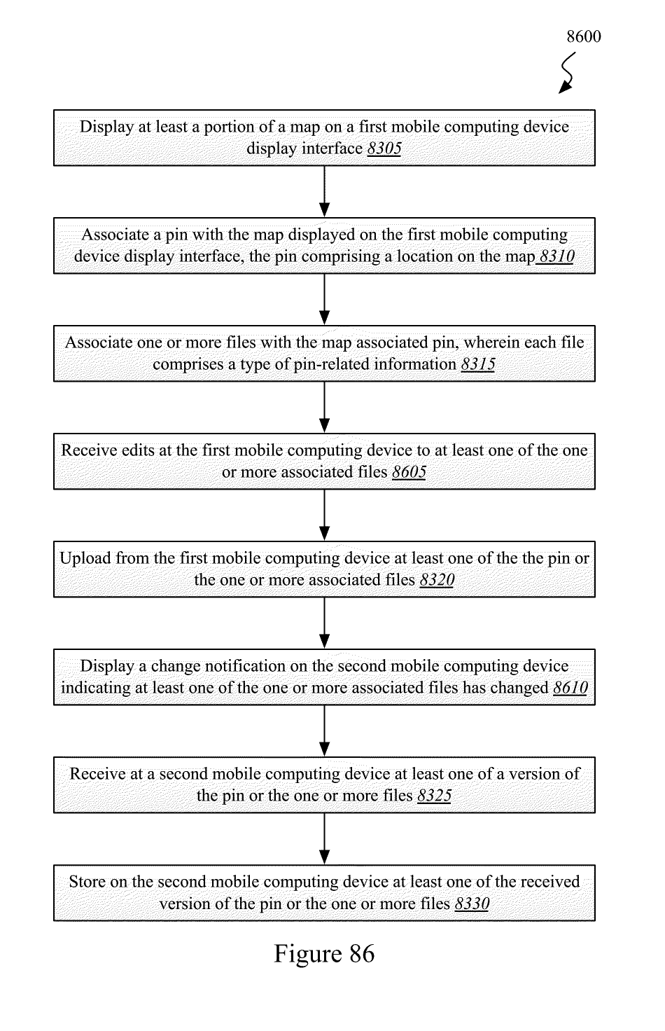

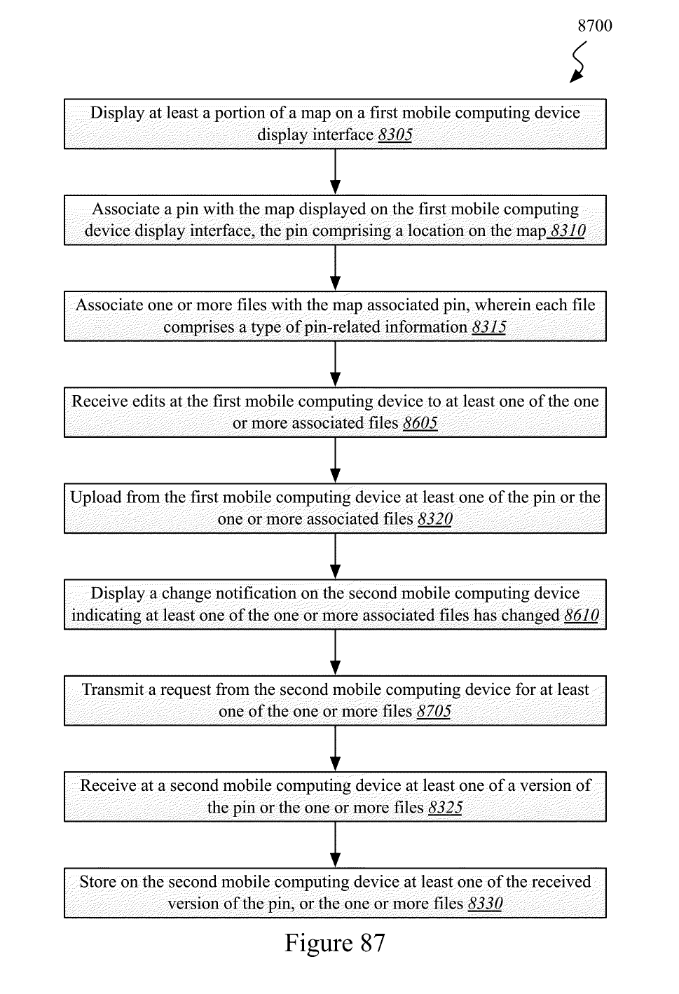

Referring now to FIGS. 86 and 87, method 8600 and 8700 may be carried out by a mobile information management system 100 according to various embodiments. The methods 8600 and 8700 may, for example, be performed by a mobile computing device of FIG. 1, 2, 3 or using any combination of the devices described for these FIGS. 1 through 3. In some instances, notifications are displayed when a file is edited by another user, on another device, or both. The notification service 387 can broadcast change notifications to one or more of the mobile computing devices. Initially, at block 8305 a mobile computing device 114, 116 displays at least a portion of a map on a display interface. At block 8310, the pin engine 520 (see, e.g., FIG. 5) associates a pin with the displayed map. The pin includes a location on the map, which can be a coordinate location, such as a geospatial coordinate location, map coordinate location, or both. At block 8315, the pin engine 520 associates one or more files with the map associated pin. Files can consist of a type of pin-related information, such as, for example, a document or an image. At block 8605, edits are received to the one or more of the associated files, which are then stored in the local persistence layer 517. Edits can include, for example, direct edits of file content, markup of file content, or both. At block 8320, the messaging engine 560 uploads the pin, one or more of the associated files, or both. At block 8610, another mobile computing device displays a change notification indicating at least one of the one or more associated files has changed. At block 8325, the messaging engine of the second mobile computing device receives a version of the pin, one or more of the files, or both. In some instances, this version corresponds to the latest version uploaded at block 8320, and can be received automatically. At block 8330, the data engine 565 of the receiving mobile computing device stores the received version of the pin, the one or more files, or both. In some instances, the receiving mobile computing device will transmit a request for at least one of the one or more files 8705.

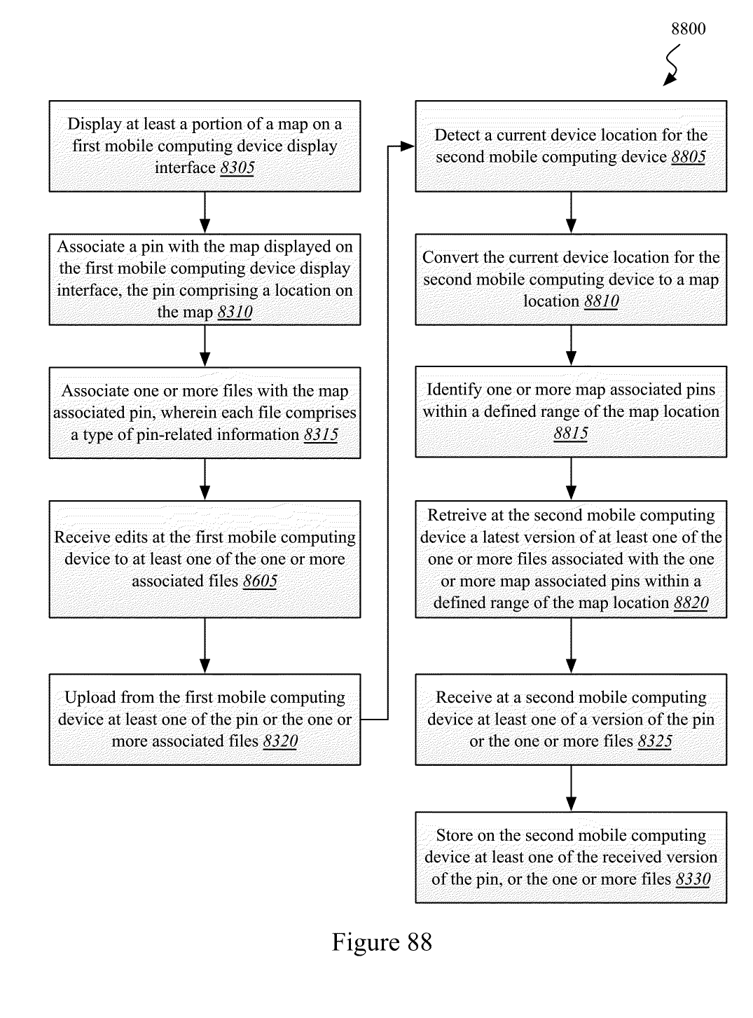

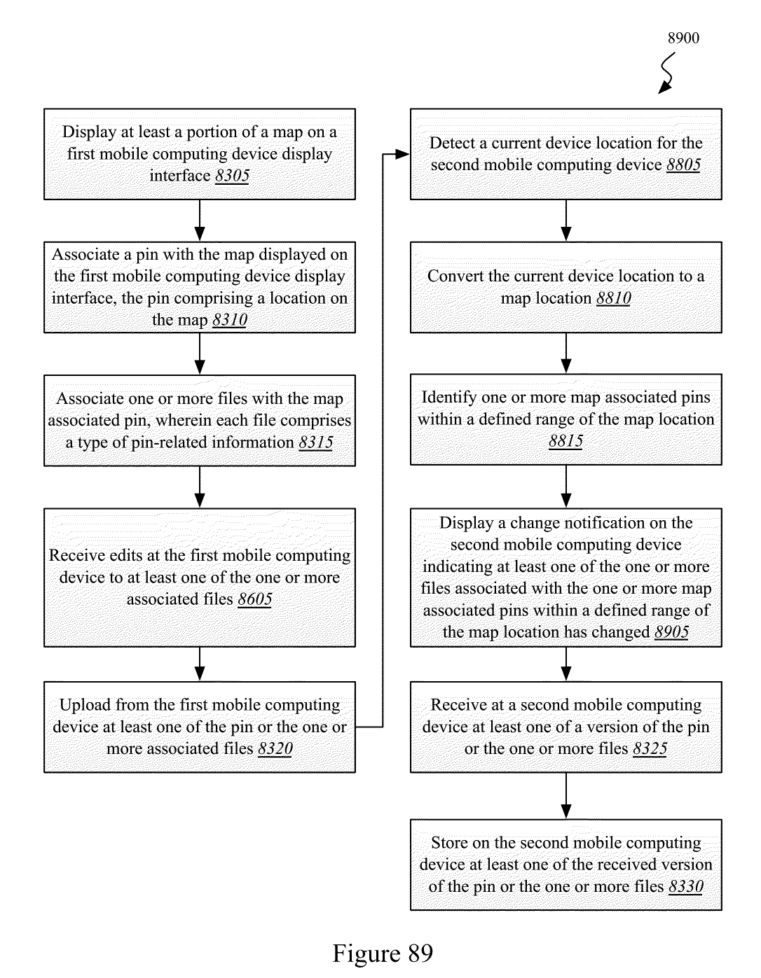

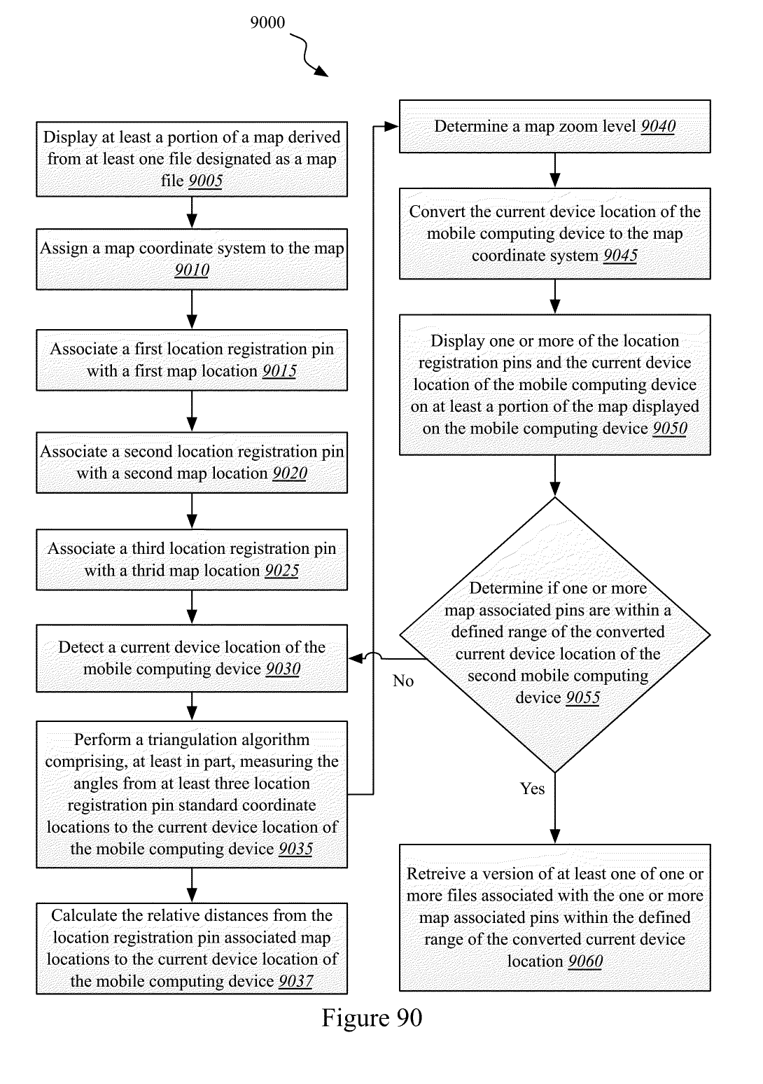

Referring now to FIGS. 88 and 89, method 8800 and 8900 may be carried out by a mobile information management system 100 according to various embodiments. The methods 8800 and 8900 may, for example, be performed by a mobile computing device of FIG. 1, 2, 3 or using any combination of the devices described for these FIGS. 1 through 3. In some instances, notifications are displayed when a file is edited by another user, on another device, or both. The notification service 387 can broadcast change notifications to one or more of the mobile computing devices. Initially, at block 8305 a mobile computing device 114, 116 displays at least a portion of a map on a display interface. At block 8310, the pin engine 520 (see, e.g., FIG. 5) associates a pin with the displayed map. The pin includes a location on the map, which can be a coordinate location, such as a geospatial coordinate location, map coordinate location, or both. At block 8315, the pin engine 520 associates one or more files with the map associated pin. Files can consist of a type of pin-related information, such as, for example, a document or an image. At block 8605, edits are received to the one or more of the associated files, which are then stored in the local persistence layer 517. Edits can include, for example, direct edits of file content, markup of file content, or both. At block 8320, the messaging engine 560 uploads the pin, one or more of the associated files, or both.

At block 8805, on a different mobile computing device, the location engine 535 detects a current device location. In some instances, the location engine receives geospatial coordinates the native location services for the mobile computing device. At block 8810, the map engine 540 on this second device converts the current device location to a map location. At block 8810, the location engine identifies one or more map associated pins within a defined range of the map location. Based on this identification, the messaging engine retrieves the latest version of at least one of the one or more files associated with the one or more map associated pins within a defined range of the map location. In addition, or alternatively, the view engine 550 displays a change notification on the second mobile computing device indicating at least one of the one or more files associated with the one or more map associated pins that are within a defined range of the map location has changed 8905. At block 8325, the messaging engine of the second mobile computing device receives a version of the pin, one or more of the files, or both. In some instances, this version corresponds to the latest version uploaded at block 8320, and can be received automatically. At block 8330, the data engine 565 of the receiving mobile computing device stores the received version of the pin, the one or more files, or both.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures may be implemented to achieve the same functionality.

The process parameters, functions, system features, and sequence of steps described and/or illustrated herein are given by way of example only and may be varied and mixed and matched as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

This specification refers to the appearance and utilization of one or more “pins.” It is to be understood that the a “pin” as used herein is an indicia. Other types of indicia may be used in substitution for, or in conjunction with, one or more “pins” and still adequately provide the functionality and fall within the scope of this specification.

Furthermore, while various embodiments have been described and/or illustrated herein in the context of fully functional computing systems, the functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). In addition, unless otherwise noted, the terms “a” or “an,” as used in the specification and claims, are to be construed as meaning “at least one of” Similarly, the words “including” and “having,” as used in the specification and claims, are interchangeable with and have the same meaning as the word “comprising.” Finally, the term “based on” as used in the specification and the claims is to be construed as meaning “based at least upon.”

The foregoing description has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems, their components, and methods and various embodiments with various modifications as may be suited to the particular use contemplated.

What is claimed is:

1. A mobile information management method provided by mobile computing devices, the mobile information management method comprising:
displaying at least a portion of a map on a first mobile computing device display interface;
associating a pin with the map displayed on the first mobile computing device display interface, the pin comprising a location on the map;
associating one or more files with the map associated pin, wherein each file comprises a type of pin-related information;
uploading from the first mobile computing device at least one of the pin or the one or more associated files;
receiving at a second mobile computing device at least one of a version of the pin or the one or more associated files; and
storing on the second mobile computing device at least one of the received version of the pin or the one or more associated files.

2. The mobile information management method of claim 1 wherein, the map is a plan-view map, drawn to scale, of the relationships between at least one of walls, rooms, spaces, or other physical features.

3. The mobile information management method of claim 1 wherein, the map comprises one level of a physical structure.

4. The mobile information management method of claim 1 further comprising:
detecting a selection event indicative of one or more selected pages of one or more files; and
associating a page identifier identifying the one or more selected pages of the one or more files with the map associated pin;
and wherein:
the uploading step includes uploading the page identifier from the first mobile computing device;
the receiving step includes receiving the page identifier at the second mobile computing device; and
the storing step includes storing the page selection identification information at the second mobile computing device.

5. The mobile information management method of claim 1 further comprising;
receiving edits at the first mobile computing device to at least one of the one or more associated files, wherein edits comprise direct editing of file content, markup of file content, or both; and
displaying a change notification on the second mobile computing device indicating at least one of the one or more associated files has changed.

6. The mobile information management method of claim 5 wherein receiving at least one of the one or more files at the second mobile computing device comprises automatically receiving the latest version of at least one of the one or more files.

7. The mobile information management method of claim 5 further comprising transmitting a request from the second mobile computing device for at least one of the one or more files.

8. The mobile information management method of claim 1 further comprising;
receiving edits at the first mobile computing device to at least one of the one or more associated files, wherein edits comprise direct editing of file content, markup of file content, or both;
detecting a current device location for the second mobile computing device;
converting the current device location for the second mobile computing device to a map location;
identifying one or more map associated pins within a defined range of the map location; and
retrieving at the second mobile computing device a latest version of at least one of the one or more files associated with the one or more map associated pins within a defined range of the map location.

9. The mobile information management method of claim 1 further comprising;
receiving edits at the first mobile computing device to at least one of the one or more associated files, wherein edits comprise direct editing of file content, markup of file content, or both;
detecting a current device location for the second mobile computing device;
converting the current device location for the second mobile computing device to a map location;
identifying one or more map associated pins within a defined range of the map location; and
retrieving a selected version at the second mobile computing device of at least one of the one or more files associated with the one or more map associated pins within a defined range of the map location.

10. The mobile information management method of claim 1 further comprising;
receiving edits at the first mobile computing device to at least one of the one or more associated files, wherein edits comprise direct editing of file content, markup of file content, or both;
detecting a current device location for the second mobile computing device;
converting the current device location for the second mobile computing device to a map location;
identifying one or more map associated pins within a defined range of the map location; and
displaying a change notification on the second mobile computing device indicating at least one of the one or more files associated with the one or more map associated pins within a defined range of the map location has changed.

11. A mobile information management method comprising:
displaying at least a portion of a map derived from at least one file designated as a map file on a mobile computing device display interface;
assigning a map coordinate system to the map;
associating a first location registration pin with a first map location;
associating a second location registration pin with a second map location;
associating a third location registration pin with a third map;
detecting a current device location of the mobile computing device;
performing a triangulation algorithm comprising, at least in part, measuring the angles from at least three location registration pin standard coordinate locations to the current device location of the mobile computing device;
calculating the relative distances from the location registration pin associated map locations to the current device location of the mobile computing device;
determining a map zoom level;
converting the current device location of the mobile computing device to the map coordinate system;
displaying one or more of the location registration pins and the current device location of the mobile computing device on at least a portion of the map displayed on the display interface of the mobile computing device;
identifying one or more map associated pins within a defined range of the converted current device location of the mobile computing device; and
retrieving a selected version of at least one of the one or more files associated with the one or more map associated pins within a defined range of the converted current device location.

12. A mobile information management device, comprising:
a computer-readable memory configured to store information to be displayed on a map, the stored information comprising pins;
a display; and
at least one processor configured to:
display at least a portion of a map on a mobile computing device display interface;
associate a pin with the map displayed on the mobile computing device display interface, the pin comprising a location on map;
associate one or more files with the map associated pin, wherein each file comprises a type of information;
upload from the mobile computing device at least one of the map, the map associated pin, or the one or more associated files;
receive at the mobile computing device at least one of a version of the map, the pin, or the one or more files; and
store on the mobile computing device at least one of the received version of the map, the pin, or the one or more files.

13. The mobile information management device of claim 12 wherein, the map is a plan-view map drawn to scale, of the relationships between at least one of walls, rooms, spaces or other physical features.

14. The mobile information management device of claim 12 wherein, the map comprises one level of a structure.

15. The mobile information management device of claim 12 further comprising, requesting by the mobile computing device the latest version of at least one of a version of the map, the pin, or the one or more files.

16. A non-transitory computer-readable medium having stored thereon program instructions which, when executed by a computing device, cause the computing device to perform the following operations:
display at least a portion of a map on a mobile computing device display interface;
associate a pin with the map displayed on the mobile computing device display, the pin comprising a location on map;
associate one or more files with the map associated pin, wherein each file comprises a type of information;
upload from the mobile computing device at least one of the map, the pin, or the one or more associated files;
receive from the mobile computing device at least one of a version of the map, the pin, or the one or more files; and
store on the mobile computing device at least one of the received version of the map, the pin, or the one or more files.

17. The computer-readable medium of claim 16 wherein, the map is a plan-view map drawn to scale, of the relationships between at least one of walls, rooms, spaces or other physical features.

18. The computer-readable medium of claim 16 wherein, the map comprises one level of a structure.

19. The computer-readable medium of claim 16 wherein the instructions cause the computing device to display a change notification on the display interface indicating at least one of the one or more associated files has changed.

20. A mobile information management system comprising:
means for displaying at least a portion of a map on a mobile computing device display;
means for associating a pin with the map displayed on the mobile computing device display, the pin comprising a location on map;
means for associating one or more files with the map associated pin, wherein each file comprises a type of information;
means for uploading at least one of the map, the pin, or the one or more associated files;
means for receiving at the mobile computing device at least one of a version of the map, the pin, or the one or more files; and
means for storing at the mobile computing device at least one of the received version of the map, the pin, or the one or more files.

21. The mobile information management method of claim 1 further comprising, requesting by the second mobile computing device the latest version of at least one of a version of the pin or the one or more files.
